(19) United States
(12) Patent Application Publication
(10) Pub. No.: US 2023/0259185 A1
(43) Pub. Date: Aug. 17, 2023

(54) METHODS, SYSTEMS, APPARATUS, AND ARTICLES OF MANUFACTURE TO CONTROL COOLING IN AN EDGE ENVIRONMENT

(71) Applicant: Intel Corporation, Santa Clara, CA (US)

(72) Inventors: Francesc Guim Bernat, Barcelona (ES); Amruta Misra, Bangalore (IN); Arun Hodigere, Bangalore (IN); John J. Browne, Limerick (IE); Kshitij Arun Doshi, Tempe, AZ (US)

(21) Appl. No.: 18/303,415

(22) Filed: Apr. 19, 2023

(30) Foreign Application Priority Data
Dec. 30, 2022 (IN) 202241077228

(51) Int. Cl. G06F 1/20

(52) U.S. Cl. CPC G06F 1/206

(57) ABSTRACT

Methods, systems, apparatus, and articles of manufacture to control cooling in an edge environment are disclosed. An example apparatus disclosed herein includes programmable circuitry to determine whether a first cooling parameter for a first edge node is satisfied based on first cooling availability information for the first edge node, when the first cooling parameter is satisfied, cause a first distribution unit to maintain an amount of cooling fluid to the first edge node, and when the first cooling parameter is not satisfied, cause at least one of the first distribution unit or a second distribution unit to adjust the amount of cooling fluid to at least one of the first edge node or a second edge node based on the first cooling availability information and second cooling availability information, the second cooling availability information for the second edge node.

### RELATED APPLICATION

This patent claims priority to Indian Provisional Patent Application No. 202241077228, which was filed on Dec. 30, 2022. Indian Provisional Patent Application No. 202241077228 is hereby incorporated herein by reference in its entirety.

### FIELD OF THE DISCLOSURE

This disclosure relates generally to liquid cooling systems for electronic components and, more particularly, to methods, systems, apparatus, and articles of manufacture to control cooling in an edge environment.

### BACKGROUND

The use of liquids to cool electronic components is being explored for its benefits over more traditional air cooling systems, as there is an increasing need to address thermal management risks resulting from increased thermal design power in high performance systems (e.g., CPU and/or GPU servers in data centers, cloud computing, edge computing, etc.). More particularly, relative to air, liquid has inherent advantages of higher specific heat (when no boiling is involved) and higher latent heat of vaporization (when boiling is involved).

### BRIEF DESCRIPTION OF THE DRAWINGS

FIG. 1 illustrates one or more example environments in which teachings of this disclosure may be implemented.

FIG. 2 illustrates at least one example of a data center for executing workloads with disaggregated resources.

FIG. 3 illustrates at least one example of a pod that may be included in the data center of FIG. 2.

FIG. 4 is a perspective view of at least one example of a rack that may be included in the pod of FIG. 3.

FIG. 5 is a side elevation view of the rack of FIG. 4.

FIG. 6 is a perspective view of the rack of FIG. 4 having a sled mounted therein.

FIG. 7 is a is a block diagram of at least one example of a top side of the sled of FIG. 6.

FIG. 8 is a block diagram of at least one example of a bottom side of the sled of FIG. 7.

FIG. 9 is a block diagram of at least one example of a compute sled usable in the data center of FIG. 2.

FIG. 10 is a top perspective view of at least one example of the compute sled of FIG. 9.

FIG. 11 is a block diagram of at least one example of an accelerator sled usable in the data center of FIG. 2.

FIG. 12 is a top perspective view of at least one example of the accelerator sled of FIG. 10.

FIG. 13 is a block diagram of at least one example of a storage sled usable in the data center of FIG. 2.

FIG. 14 is a top perspective view of at least one example of the storage sled of FIG. 13.

FIG. 15 is a block diagram of at least one example of a memory sled usable in the data center of FIG. 2.

FIG. 16 is a block diagram of a system that may be established within the data center of FIG. 2 to execute workloads with managed nodes of disaggregated resources.

FIG. 17 illustrates an example edge environment in which example infrastructure control circuitry and example appliance control circuitry operate to control distribution of cooling fluid.

FIG. 18 illustrates an example edge appliance of the example edge environment of FIG. 17.

FIG. 19 is a block diagram of an example implementation of the example infrastructure control circuitry of FIG. 17.

FIG. 20 is a block diagram of an example implementation of the example appliance control circuitry of FIG. 17.

FIG. 21 illustrates an example node for which intra-tenant and/or inter-tenant brokering of cooling fluid can be performed.

FIG. 22 is a flowchart representative of example machine readable instructions and/or example operations that may be executed, instantiated, and/or performed by example programmable circuitry to implement the example infrastructure control circuitry of FIG. 19.

FIG. 23 is a flowchart representative of example machine readable instructions and/or example operations that may be executed, instantiated, and/or performed by example programmable circuitry to implement the example appliance control circuitry of FIG. 20 to control distribution of cooling fluid to and/or between one or more components of the example edge appliance of FIG. 18.

FIG. 24 is a flowchart representative of example machine readable instructions and/or example operations that may be executed, instantiated, and/or performed by example programmable circuitry to implement the example appliance control circuitry of FIG. 20 to determine one or more cooling parameters of a node.

FIG. 25 is a block diagram of an example processing platform including programmable circuitry structured to execute, instantiate, and/or perform the example machine readable instructions and/or perform the example operations of FIG. 22 to implement the example infrastructure control circuitry of FIG. 19.

FIG. 26 is a block diagram of an example processing platform including programmable circuitry structured to execute, instantiate, and/or perform the example machine readable instructions and/or perform the example operations of FIGS. 23 and/or 24 to implement the example appliance control circuitry of FIG. 20.

FIG. 27 is a block diagram of an example implementation of the processor circuitry of FIGS. 25 and/or 26.

FIG. 28 is a block diagram of another example implementation of the processor circuitry of FIGS. 25 and/or 26.

FIG. 29 is a block diagram of an example software/firmware/instructions distribution platform (e.g., one or more servers) to distribute software, instructions, and/or firmware (e.g., corresponding to the example machine readable instructions of FIGS. 22, 23, and/or 24) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

As noted above, the use of liquids to cool electronic components is being explored for its benefits over more traditional air cooling systems, as there are increasing needs to address thermal management risks resulting from increased thermal design power in high performance systems (e.g., CPU and/or GPU servers in data centers, accelerators, artificial intelligence computing, machine learning computing, cloud computing, edge computing, and the like). More particularly, relative to air, liquid has inherent advantages of higher specific heat (when no boiling is involved) and higher latent heat of vaporization (when boiling is involved). In some instances, liquid can be used to indirectly cool electronic components by cooling a cold plate that is thermally coupled to the electronic component(s). An alternative approach is to directly immerse electronic components in the cooling liquid. In direct immersion cooling, the liquid can be in direct contact with the electronic components to directly draw away heat from the electronic components. To enable the cooling liquid to be in direct contact with electronic components, the cooling liquid is electrically insulative (e.g., a dielectric liquid).

A liquid cooling system can involve at least one of single-phase cooling or two-phase cooling. As used herein, single-phase cooling (e.g., single-phase immersion cooling) means the cooling fluid (sometimes also referred to herein as cooling liquid or coolant) used to cool electronic components draws heat away from heat sources (e.g., electronic components) without changing phase (e.g., without boiling and becoming vapor). Such cooling fluids are referred to herein as single-phase cooling fluids, liquids, or coolants. By contrast, as used herein, two-phase cooling (e.g., two-phase immersion cooling) means the cooling fluid (in this case, a cooling liquid) vaporizes or boils from the heat generated by the electronic components to be cooled, thereby changing from the liquid phase to the vapor phase. The gaseous vapor may subsequently be condensed back into a liquid (e.g., via a condenser) to again be used in the cooling process. Such cooling fluids are referred to herein as two-phase cooling fluids, liquids, or coolants. Notably, gases (e.g., air) can also be used to cool components and, therefore, may also be referred to as a cooling fluid and/or a coolant. However, indirect cooling and immersion cooling typically involves at least one cooling liquid (which may or may not change to the vapor phase when in use). Example systems, apparatus, and associated methods to improve cooling systems and/or associated cooling processes are disclosed herein.

In some edge environments, compute resources of an edge device can be purchased and/or accessed by one or more tenants (e.g., parties, clients, etc.). For instance, the tenants can purchase usage of and/or access to the compute resources to perform workloads for the corresponding tenants. In some cases, an amount, duration, and/or price of the compute resources purchased by a corresponding tenant are controlled based on a service-level agreement (SLA) of the tenant. The SLA can further indicate a temperature at which the compute resources are to be maintained to facilitate performance of the workloads. In some cases, the compute resources generate heat while performing workloads for the tenants. As such, cooling systems are implemented in the edge environments to cool the compute resources to and/or maintain the compute resources at the temperature indicated in the SLA (e.g., to prevent overheating). In some instances, workloads may differ across the compute resources at a given time, such that cooling needs may vary across the compute resources. Further, the cooling needs for respective ones of compute resources may vary over time, such that tenants may wish to purchase fewer or greater cooling resources for the respective compute resources.

In some instances, a cooling system of an edge environment includes one or more cooling distribution units (CDUs) to distribute cooling resources to and/or between edge locations (e.g., edge nodes and/or devices) in the edge environment. The CDU(s) distribute the fluid based on amounts of cooling fluid purchased and/or expected by corresponding tenants operating at the edge locations. In some cases, the cooling resources expected and/or to be provided (e.g., to sufficiently cool a component, to meet SLA criteria) at a particular edge location may vary based on changing conditions. For instance, an amount of cooling fluid to cool a given node can vary as a result of a change in ambient temperature, a change in workload at the node, a change in a number of processor cores implemented at the node, etc. In some such cases, additional cooling fluid may be expected and/or excess cooling fluid may be available for the node.

Examples disclosed herein enable brokering and/or redistribution of cooling resources between edge locations (e.g., nodes and/or devices) of an edge environment. In examples disclosed herein, example control circuitry monitors, based on data from one or more sensors, actual cooling parameters at the edge locations. In example disclosed herein, actual cooling parameters refers to current or substantially real-time cooling parameters. As used herein “substantially real time” refers to occurrence in a near instantaneous manner recognizing there may be real world delays for computing time, transmission, etc. Thus, unless otherwise specified, “substantially real time” refers to real time +1-1 second. The actual cooling parameters can include an actual temperature at the edge locations, an actual temperature of cooling fluid provided to the corresponding edge locations, etc. In some examples, the control circuitry determines expected cooling parameters (e.g., cooling requirements or thresholds, properties of the cooling resources such as coolant temperature and/or flow rate, etc.) of the corresponding edge locations based on service-level agreements (SLAs) of tenants operating at the edge locations. In some examples, the control circuitry compares the actual cooling parameters to the expected cooling parameters to determine whether cooling fluid is available and/or expected at the corresponding edge locations.

In some examples, when additional cooling fluid is expected at a first edge location, the control circuitry can request and/or obtain additional cooling fluid from one or more second edge locations by sending one or more cooling requests thereto. Additionally or alternatively, when excess cooling fluid is available at the first edge location, the control circuitry can provide one or more cooling availability notifications to the second edge location(s) to allow tenants to request and/or purchase cooling fluid from the first edge location. In some examples, the control circuitry causes one or more CDUs of the edge environment to redistribute the cooling fluid between ones of the edge locations based on the exchange of cooling requests and/or cooling availability notifications. Advantageously, by enabling brokering and/or exchange of cooling resources between edge locations, examples disclosed herein can improve efficiency of cooling across the edge locations and/or prevent overheating at the edge locations.

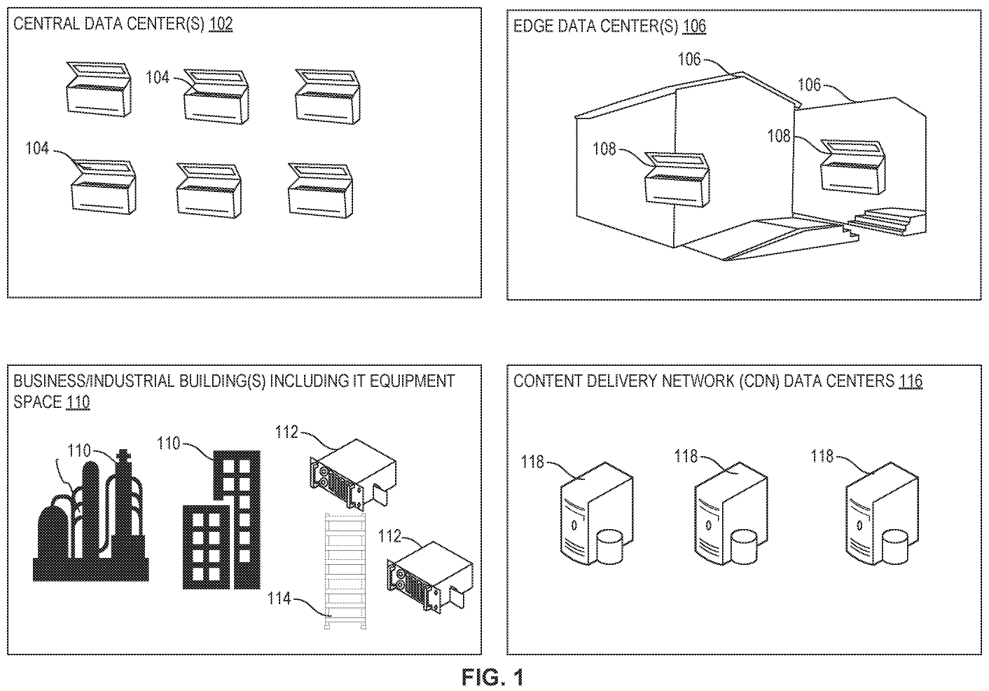

FIG. 1 illustrates one or more example environments in which teachings of this disclosure may be implemented. The example environment(s) of FIG. 1 can include one or more central data centers 102. The central data center(s) 102 can store a large number of servers used by, for instance, one or more organizations for data processing, storage, etc. As illustrated in FIG. 1, the central data center(s) 102 include a plurality of immersion tank(s) 104 to facilitate cooling of the servers and/or other electronic components stored at the central data center(s) 102. The immersion tank(s) 104 can provide for single-phase cooling or two-phase cooling.

The example environments of FIG. 1 can be part of an edge computing system. For instance, the example environments of FIG. 1 can include edge data centers or micro-data centers 106. The edge data center(s) 106 can include, for example, data centers located at a base of a cell tower. In some examples, the edge data center(s) 106 are located at or near a top of a cell tower and/or other utility pole. The edge data center(s) 106 include respective housings that store server(s), where the server(s) can be in communication with, for instance, the server(s) stored at the central data center(s) 102, client devices, and/or other compute devices in the edge network. Example housings of the edge data center(s) 106 may include materials that form one or more exterior surfaces that partially or fully protect contents therein, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. As illustrated in FIG. 1, the edge data center(s) 106 can include immersion tank(s) 108 to store server(s) and/or other electronic component(s) located at the edge data center(s) 106.

The example environment(s) of FIG. 1 can include buildings 110 for purposes of business and/or industry that store information technology (IT) equipment in, for example, one or more rooms of the building(s) 110. For example, as represented in FIG. 1, server(s) 112 can be stored with server rack(s) 114 that support the server(s) 112 (e.g., in an opening of slot of the rack 114). In some examples, the server(s) 112 located at the buildings 110 include on-premise server(s) of an edge computing network, where the on-premise server(s) are in communication with remote server(s) (e.g., the server(s) at the edge data center(s) 106) and/or other computing device(s) within an edge network.

The example environment(s) of FIG. 1 include content delivery network (CDN) data center(s) 116. The CDN data center(s) 116 of this example include server(s) 118 that cache content such as images, webpages, videos, etc. accessed via user devices. The server(s) 118 of the CDN data centers 116 can be disposed in immersion cooling tank(s) such as the immersion tanks 104, 108 shown in connection with the data centers 102, 106.

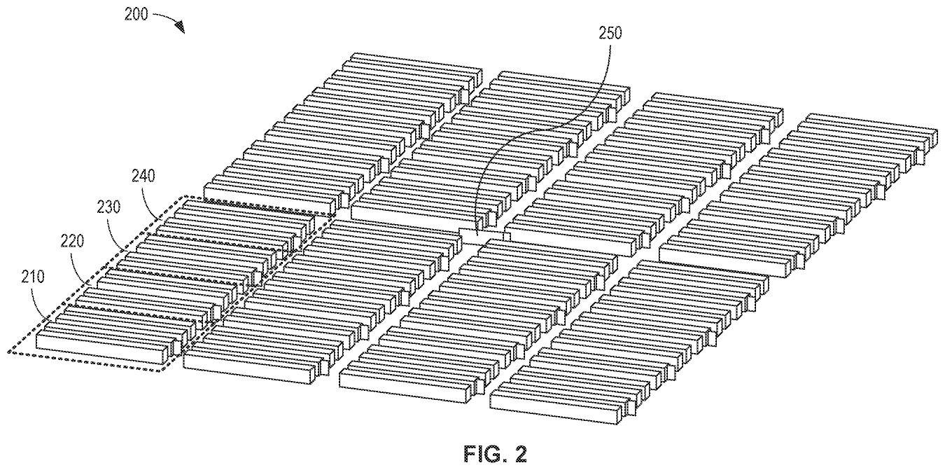

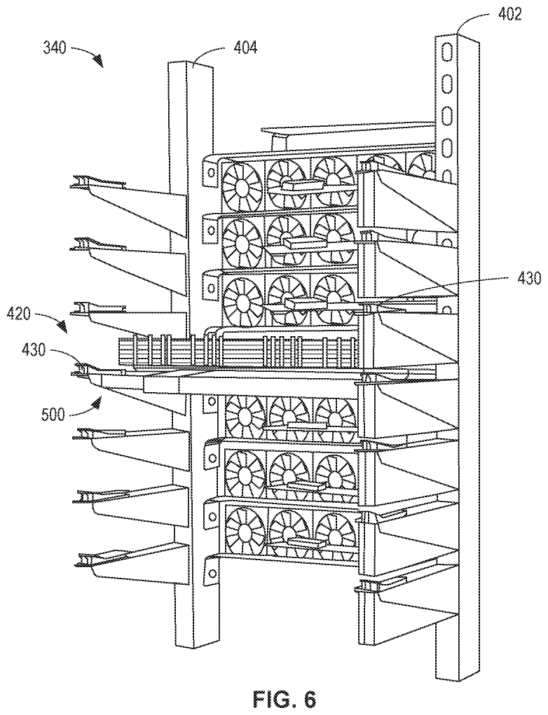

In some instances, the example data centers 102, 106, 116 and/or building(s) 110 of FIG. 1 include servers and/or other electronic components that are cooled independent of immersion tanks (e.g., the immersion tanks 104, 108) and/or an associated immersion cooling system. That is, in some examples, some or all of the servers and/or other electronic components in the data centers 102, 106, 116 and/or building(s) 110 can be cooled by air and/or liquid coolants without immersing the servers and/or other electronic components therein. Thus, in some examples, the immersion tanks 104, 108 of FIG. 1 may be omitted. Further, the example data centers 102, 106, 116 and/or building(s) 110 of FIG. 1 can correspond to, be implemented by, and/or be adaptations of the example data center 200 described in further detail below in connection with FIGS. 2-16.

Although a certain number of cooling tank(s) and other component(s) are shown in the figures, any number of such components may be present. Also, the example cooling data centers and/or other structures or environments disclosed herein are not limited to arrangements of the size that are depicted in FIG. 1. For instance, the structures containing example cooling systems and/or components thereof disclosed herein can be of a size that includes an opening to accommodate service personnel, such as the example data center(s) 106 of FIG. 1, but can also be smaller (e.g., a “doghouse” enclosure). For instance, the structures containing example cooling systems and/or components thereof disclosed herein can be sized such that access (e.g., the only access) to an interior of the structure is a port for service personnel to reach into the structure. In some examples, the structures containing example cooling systems and/or components thereof disclosed herein are be sized such that only a tool can reach into the enclosure because the structure may be supported by, for a utility pole or radio tower, or a larger structure.

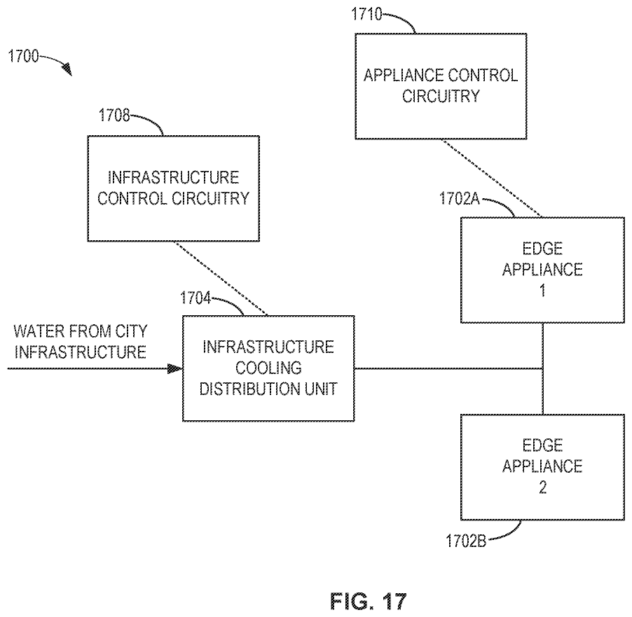

In addition to or as an alternative to the immersion tanks 104, 108, any of the example environments of FIG. 1 can utilize one or more liquid cooling systems having a cold plate to control the temperature of the electronic devices/components in the example environments. An example liquid cooling system and example cold plates are disclosed in further detail in connection with FIG. 17.

FIG. 2 illustrates an example data center 200 in which disaggregated resources may cooperatively execute one or more workloads (e.g., applications on behalf of customers). The illustrated data center 200 includes multiple platforms 210, 220, 230, 240 (referred to herein as pods), each of which includes one or more rows of racks. Although the data center 200 is shown with multiple pods, in some examples, the data center 200 may be implemented as a single pod. As described in more detail herein, a rack may house multiple sleds. A sled may be primarily equipped with a particular type of resource (e.g., memory devices, data storage devices, accelerator devices, general purpose processors), i.e., resources that can be logically coupled to form a composed node. Some such nodes may act as, for example, a server. In the illustrative example, the sleds in the pods 210, 220, 230, 240 are connected to multiple pod switches (e.g., switches that route data communications to and from sleds within the pod). The pod switches, in turn, connect with spine switches 250 that switch communications among pods (e.g., the pods 210, 220, 230, 240) in the data center 200. In some examples, the sleds may be connected with a fabric using Intel Omni-Path™ technology. In other examples, the sleds may be connected with other fabrics, such as InfiniBand or Ethernet. As described in more detail herein, resources within the sleds in the data center 200 may be allocated to a group (referred to herein as a “managed node”) containing resources from one or more sleds to be collectively utilized in the execution of a workload. The workload can execute as if the resources belonging to the managed node were located on the same sled. The resources in a managed node may belong to sleds belonging to different racks, and even to different pods 210, 220, 230, 240. As such, some resources of a single sled may be allocated to one managed node while other resources of the same sled are allocated to a different managed node (e.g., first processor circuitry assigned to one managed node and second processor circuitry of the same sled assigned to a different managed node).

A data center including disaggregated resources, such as the data center 200, can be used in a wide variety of contexts, such as enterprise, government, cloud service provider, and communications service provider (e.g., Telco's), as well in a wide variety of sizes, from cloud service provider mega-data centers that consume over 200,000 sq. ft. to single- or multi-rack installations for use in base stations.

In some examples, the disaggregation of resources is accomplished by using individual sleds that include predominantly a single type of resource (e.g., compute sleds including primarily compute resources, memory sleds including primarily memory resources). The disaggregation of resources in this manner, and the selective allocation and deallocation of the disaggregated resources to form a managed node assigned to execute a workload, improves the operation and resource usage of the data center 200 relative to typical data centers. Such typical data centers include hyperconverged servers containing compute, memory, storage and perhaps additional resources in a single chassis. For example, because a given sled will contain mostly resources of a same particular type, resources of that type can be upgraded independently of other resources. Additionally, because different resource types (processors, storage, accelerators, etc.) typically have different refresh rates, greater resource utilization and reduced total cost of ownership may be achieved. For example, a data center operator can upgrade the processor circuitry throughout a facility by only swapping out the compute sleds. In such a case, accelerator and storage resources may not be contemporaneously upgraded and, rather, may be allowed to continue operating until those resources are scheduled for their own refresh. Resource utilization may also increase. For example, if managed nodes are composed based on requirements of the workloads that will be running on them, resources within a node are more likely to be fully utilized. Such utilization may allow for more managed nodes to run in a data center with a given set of resources, or for a data center expected to run a given set of workloads, to be built using fewer resources.

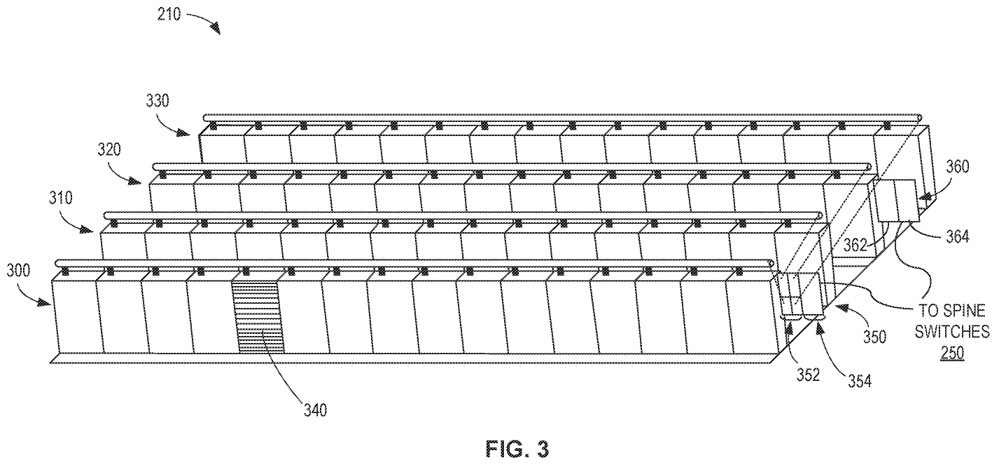

Referring now to FIG. 3, the pod 210, in the illustrative example, includes a set of rows 300, 310, 320, 330 of racks 340. Individual ones of the racks 340 may house multiple sleds (e.g., sixteen sleds) and provide power and data connections to the housed sleds, as described in more detail herein. In the illustrative example, the racks are connected to multiple pod switches 350, 360. The pod switch 350 includes a set of ports 352 to which the sleds of the racks of the pod 210 are connected and another set of ports 354 that connect the pod 210 to the spine switches 250 to provide connectivity to other pods in the data center 200. Similarly, the pod switch 360 includes a set of ports 362 to which the sleds of the racks of the pod 210 are connected and a set of ports 364 that connect the pod 210 to the spine switches 250. As such, the use of the pair of switches 350, 360 provides an amount of redundancy to the pod 210. For example, if either of the switches 350, 360 fails, the sleds in the pod 210 may still maintain data communication with the remainder of the data center 200 (e.g., sleds of other pods) through the other switch 350, 360. Furthermore, in the illustrative example, the switches 250, 350, 360 may be implemented as dual-mode optical switches, capable of routing both Ethernet protocol communications carrying Internet Protocol (IP) packets and communications according to a second, high-performance link-layer protocol (e.g., PCI Express) via optical signaling media of an optical fabric.

It should be appreciated that any one of the other pods 220, 230, 240 (as well as any additional pods of the data center 200) may be similarly structured as, and have components similar to, the pod 210 shown in and disclosed in regard to FIG. 3 (e.g., a given pod may have rows of racks housing multiple sleds as described above). Additionally, while two pod switches 350, 360 are shown, it should be understood that in other examples, a different number of pod switches may be present, providing even more failover capacity. In other examples, pods may be arranged differently than the rows-of-racks configuration shown in FIGS. 2 and 3. For example, a pod may include multiple sets of racks arranged radially, i.e., the racks are equidistant from a center switch.

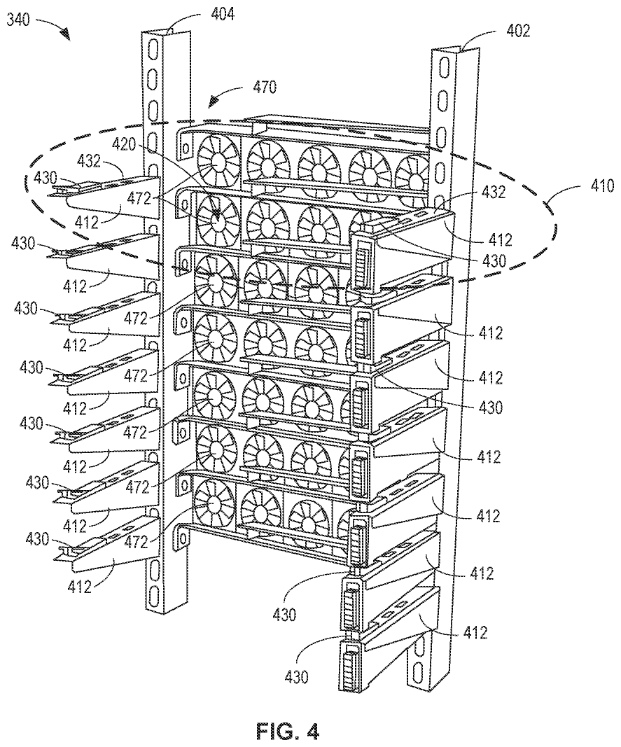

FIGS. 4-6 illustrate an example rack 340 of the data center 200. As shown in the illustrated example, the rack 340 includes two elongated support posts 402, 404, which are arranged vertically. For example, the elongated support posts 402, 404 may extend upwardly from a floor of the data center 200 when deployed. The rack 340 also includes one or more horizontal pairs 410 of elongated support arms 412 (identified in FIG. 4 via a dashed ellipse) configured to support a sled of the data center 200 as discussed below. One elongated support arm 412 of the pair of elongated support arms 412 extends outwardly from the elongated support post 402 and the other elongated support arm 412 extends outwardly from the elongated support post 404.

In the illustrative examples, at least some of the sleds of the data center 200 are chassis-less sleds. That is, such sleds have a chassis-less circuit board substrate on which physical resources (e.g., processors, memory, accelerators, storage, etc.) are mounted as discussed in more detail below. As such, the rack 340 is configured to receive the chassis-less sleds. For example, a given pair 410 of the elongated support arms 412 defines a sled slot 420 of the rack 340, which is configured to receive a corresponding chassis-less sled. To do so, the elongated support arms 412 include corresponding circuit board guides 430 configured to receive the chassis-less circuit board substrate of the sled. The circuit board guides 430 are secured to, or otherwise mounted to, a top side 432 of the corresponding elongated support arms 412. For example, in the illustrative example, the circuit board guides 430 are mounted at a distal end of the corresponding elongated support arm 412 relative to the corresponding elongated support post 402, 404. For clarity of FIGS. 4-6, not every circuit board guide 430 may be referenced in each figure. In some examples, at least some of the sleds include a chassis and the racks 340 are suitably adapted to receive the chassis.

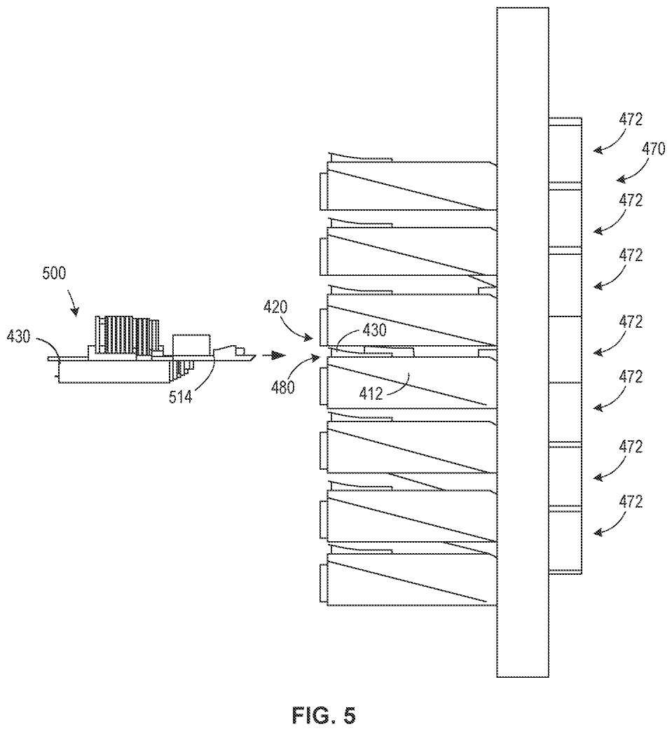

The circuit board guides 430 include an inner wall that defines a circuit board slot 480 configured to receive the chassis-less circuit board substrate of a sled 500 when the sled 500 is received in the corresponding sled slot 420 of the rack 340. To do so, as shown in FIG. 5, a user (or robot) aligns the chassis-less circuit board substrate of an illustrative chassis-less sled 500 to a sled slot 420. The user, or robot, may then slide the chassis-less circuit board substrate forward into the sled slot 420 such that each side edge 514 of the chassis-less circuit board substrate is received in a corresponding circuit board slot 480 of the circuit board guides 430 of the pair 410 of elongated support arms 412 that define the corresponding sled slot 420 as shown in FIG. 5. By having robotically accessible and robotically manipulable sleds including disaggregated resources, the different types of resource can be upgraded independently of one other and at their own optimized refresh rate. Furthermore, the sleds are configured to blindly mate with power and data communication cables in the rack 340, enhancing their ability to be quickly removed, upgraded, reinstalled, and/or replaced. As such, in some examples, the data center 200 may operate (e.g., execute workloads, undergo maintenance and/or upgrades, etc.) without human involvement on the data center floor. In other examples, a human may facilitate one or more maintenance or upgrade operations in the data center 200.

It should be appreciated that the circuit board guides 430 are dual sided. That is, a circuit board guide 430 includes an inner wall that defines a circuit board slot 480 on each side of the circuit board guide 430. In this way, the circuit board guide 430 can support a chassis-less circuit board substrate on either side. As such, a single additional elongated support post may be added to the rack 340 to turn the rack 340 into a two-rack solution that can hold twice as many sled slots 420 as shown in FIG. 4. The illustrative rack 340 includes seven pairs 410 of elongated support arms 412 that define seven corresponding sled slots 420. The sled slots 420 are configured to receive and support a corresponding sled 500 as discussed above. In other examples, the rack 340 may include additional or fewer pairs 410 of elongated support arms 412 (i.e., additional or fewer sled slots 420). It should be appreciated that because the sled 500 is chassis-less, the sled 500 may have an overall height that is different than typical servers. As such, in some examples, the height of a given sled slot 420 may be shorter than the height of a typical server (e.g., shorter than a single rank unit, referred to as “1U”). That is, the vertical distance between pairs 410 of elongated support arms 412 may be less than a standard rack unit “1U.” Additionally, due to the relative decrease in height of the sled slots 420, the overall height of the rack 340 in some examples may be shorter than the height of traditional rack enclosures. For example, in some examples, the elongated support posts 402, 404 may have a length of six feet or less. Again, in other examples, the rack 340 may have different dimensions. For example, in some examples, the vertical distance between pairs 410 of elongated support arms 412 may be greater than a standard rack unit “1U”. In such examples, the increased vertical distance between the sleds allows for larger heatsinks to be attached to the physical resources and for larger fans to be used (e.g., in the fan array 470 described below) for cooling the sleds, which in turn can allow the physical resources to operate at increased power levels. Further, it should be appreciated that the rack 340 does not include any walls, enclosures, or the like. Rather, the rack 340 is an enclosure-less rack that is opened to the local environment. In some cases, an end plate may be attached to one of the elongated support posts 402, 404 in those situations in which the rack 340 forms an end-of-row rack in the data center 200.

In some examples, various interconnects may be routed upwardly or downwardly through the elongated support posts 402, 404. To facilitate such routing, the elongated support posts 402, 404 include an inner wall that defines an inner chamber in which interconnects may be located. The interconnects routed through the elongated support posts 402, 404 may be implemented as any type of interconnects including, but not limited to, data or communication interconnects to provide communication connections to the sled slots 420, power interconnects to provide power to the sled slots 420, and/or other types of interconnects.

The rack 340, in the illustrative example, includes a support platform on which a corresponding optical data connector (not shown) is mounted. Such optical data connectors are associated with corresponding sled slots 420 and are configured to mate with optical data connectors of corresponding sleds 500 when the sleds 500 are received in the corresponding sled slots 420. In some examples, optical connections between components (e.g., sleds, racks, and switches) in the data center 200 are made with a blind mate optical connection. For example, a door on a given cable may prevent dust from contaminating the fiber inside the cable. In the process of connecting to a blind mate optical connector mechanism, the door is pushed open when the end of the cable approaches or enters the connector mechanism. Subsequently, the optical fiber inside the cable may enter a gel within the connector mechanism and the optical fiber of one cable comes into contact with the optical fiber of another cable within the gel inside the connector mechanism.

The illustrative rack 340 also includes a fan array 470 coupled to the cross-support arms of the rack 340. The fan array 470 includes one or more rows of cooling fans 472, which are aligned in a horizontal line between the elongated support posts 402, 404. In the illustrative example, the fan array 470 includes a row of cooling fans 472 for the different sled slots 420 of the rack 340. As discussed above, the sleds 500 do not include any on-board cooling system in the illustrative example and, as such, the fan array 470 provides cooling for such sleds 500 received in the rack 340. In other examples, some or all of the sleds 500 can include on-board cooling systems. Further, in some examples, the sleds 500 and/or the racks 340 may include and/or incorporate a liquid and/or immersion cooling system to facilitate cooling of electronic component(s) on the sleds 500. The rack 340, in the illustrative example, also includes different power supplies associated with different ones of the sled slots 420. A given power supply is secured to one of the elongated support arms 412 of the pair 410 of elongated support arms 412 that define the corresponding sled slot 420. For example, the rack 340 may include a power supply coupled or secured to individual ones of the elongated support arms 412 extending from the elongated support post 402. A given power supply includes a power connector configured to mate with a power connector of a sled 500 when the sled 500 is received in the corresponding sled slot 420. In the illustrative example, the sled 500 does not include any on-board power supply and, as such, the power supplies provided in the rack 340 supply power to corresponding sleds 500 when mounted to the rack 340. A given power supply is configured to satisfy the power requirements for its associated sled, which can differ from sled to sled. Additionally, the power supplies provided in the rack 340 can operate independent of each other. That is, within a single rack, a first power supply providing power to a compute sled can provide power levels that are different than power levels supplied by a second power supply providing power to an accelerator sled. The power supplies may be controllable at the sled level or rack level, and may be controlled locally by components on the associated sled or remotely, such as by another sled or an orchestrator.

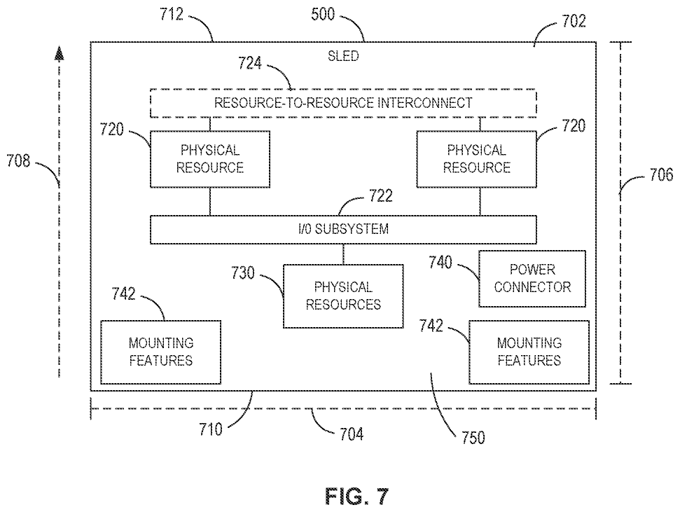

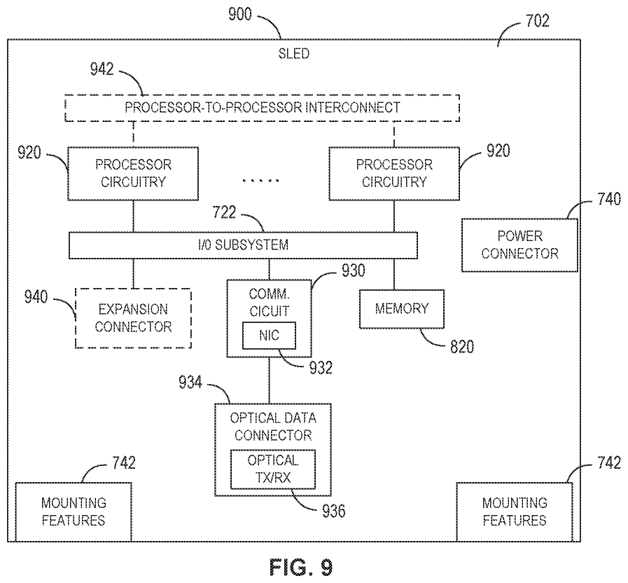

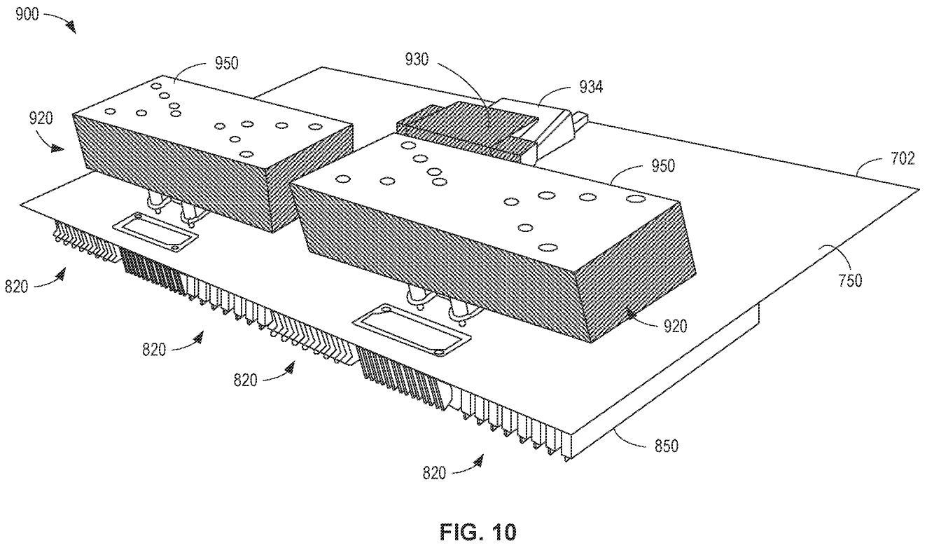

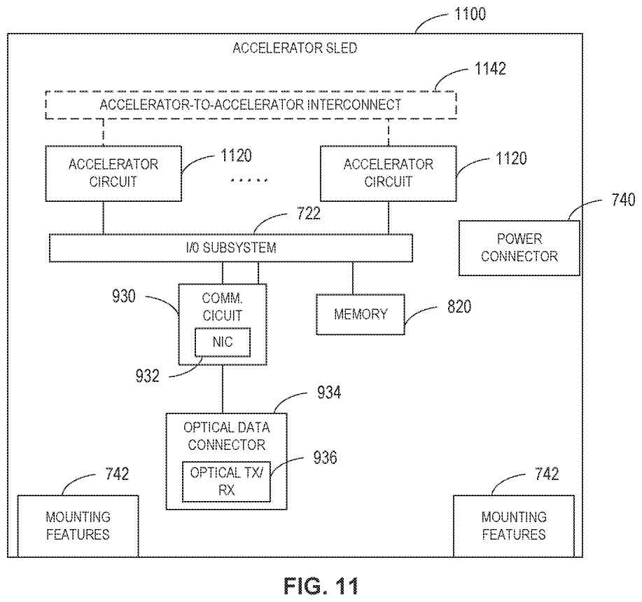

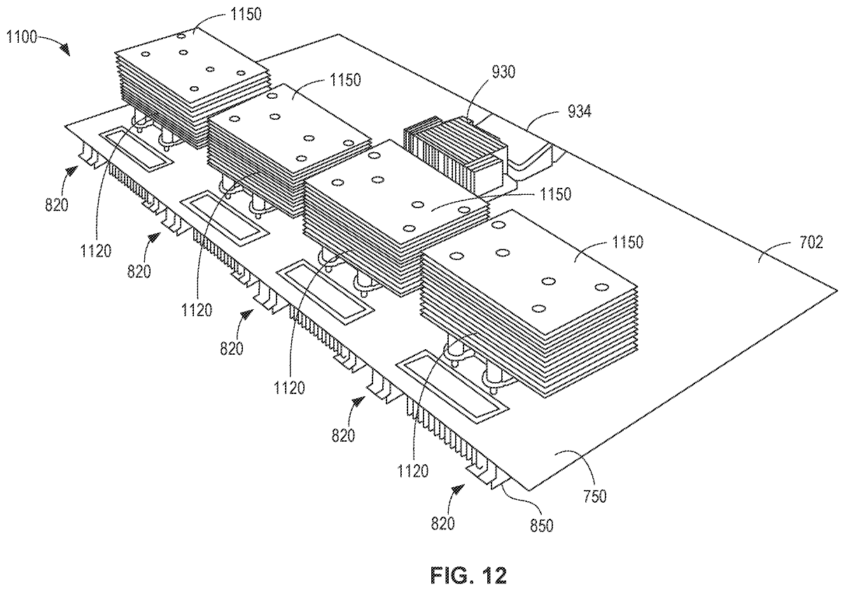

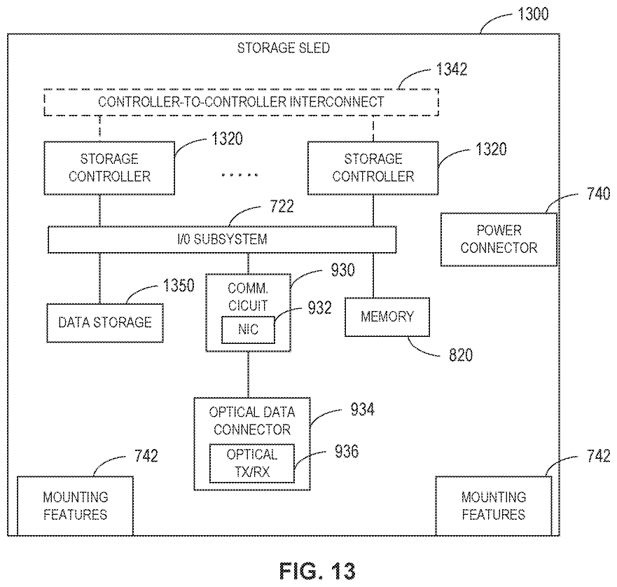

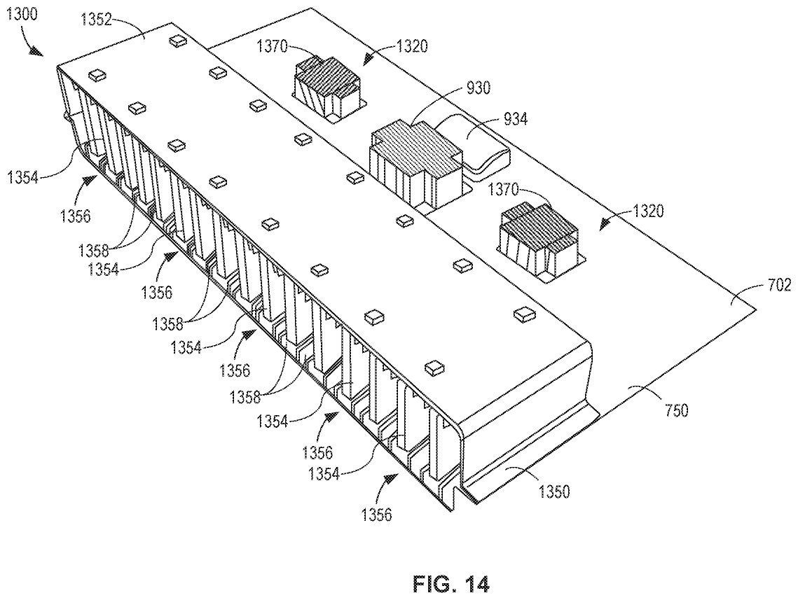

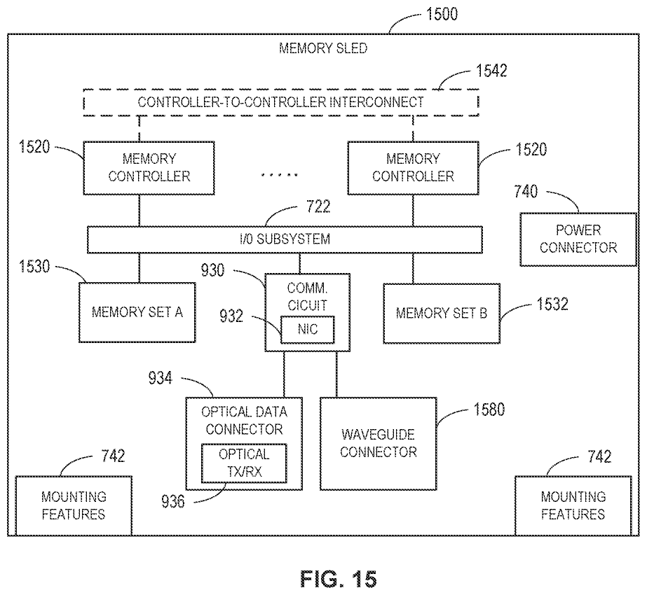

Referring now to FIG. 7, the sled 500, in the illustrative example, is configured to be mounted in a corresponding rack 340 of the data center 200 as discussed above. In some examples, a given sled 500 may be optimized or otherwise configured for performing particular tasks, such as compute tasks, acceleration tasks, data storage tasks, etc. For example, the sled 500 may be implemented as a compute sled 900 as discussed below in regard to FIGS. 9 and 10, an accelerator sled 1100 as discussed below in regard to FIGS. 11 and 12, a storage sled 1300 as discussed below in regard to FIGS. 13 and 14, or as a sled optimized or otherwise configured to perform other specialized tasks, such as a memory sled 1500, discussed below in regard to FIG. 15.

As discussed above, the illustrative sled 500 includes a chassis-less circuit board substrate 702, which supports various physical resources (e.g., electrical components) mounted thereon. It should be appreciated that the circuit board substrate 702 is “chassis-less” in that the sled 500 does not include a housing or enclosure. Rather, the chassis-less circuit board substrate 702 is open to the local environment. The chassis-less circuit board substrate 702 may be formed from any material capable of supporting the various electrical components mounted thereon. For example, in an illustrative example, the chassis-less circuit board substrate 702 is formed from an FR-4 glass-reinforced epoxy laminate material. Other materials may be used to form the chassis-less circuit board substrate 702 in other examples.

As discussed in more detail below, the chassis-less circuit board substrate 702 includes multiple features that improve the thermal cooling characteristics of the various electrical components mounted on the chassis-less circuit board substrate 702. As discussed, the chassis-less circuit board substrate 702 does not include a housing or enclosure, which may improve the airflow over the electrical components of the sled 500 by reducing those structures that may inhibit air flow. For example, because the chassis-less circuit board substrate 702 is not positioned in an individual housing or enclosure, there is no vertically-arranged backplane (e.g., a back plate of the chassis) attached to the chassis-less circuit board substrate 702, which could inhibit air flow across the electrical components. Additionally, the chassis-less circuit board substrate 702 has a geometric shape configured to reduce the length of the airflow path across the electrical components mounted to the chassis-less circuit board substrate 702. For example, the illustrative chassis-less circuit board substrate 702 has a width 704 that is greater than a depth 706 of the chassis-less circuit board substrate 702. In one particular example, the chassis-less circuit board substrate 702 has a width of about 21 inches and a depth of about 9 inches, compared to a typical server that has a width of about 17 inches and a depth of about 39 inches. As such, an airflow path 708 that extends from a front edge 710 of the chassis-less circuit board substrate 702 toward a rear edge 712 has a shorter distance relative to typical servers, which may improve the thermal cooling characteristics of the sled 500. Furthermore, although not illustrated in FIG. 7, the various physical resources mounted to the chassis-less circuit board substrate 702 in this example are mounted in corresponding locations such that no two substantively heat-producing electrical components shadow each other as discussed in more detail below. That is, no two electrical components, which produce appreciable heat during operation (i.e., greater than a nominal heat sufficient enough to adversely impact the cooling of another electrical component), are mounted to the chassis-less circuit board substrate 702 linearly in-line with each other along the direction of the airflow path 708 (i.e., along a direction extending from the front edge 710 toward the rear edge 712 of the chassis-less circuit board substrate 702). The placement and/or structure of the features may be suitable adapted when the electrical component(s) are being cooled via liquid (e.g., one phase or two phase cooling).

As discussed above, the illustrative sled 500 includes one or more physical resources 720 mounted to a top side 750 of the chassis-less circuit board substrate 702. Although two physical resources 720 are shown in FIG. 7, it should be appreciated that the sled 500 may include one, two, or more physical resources 720 in other examples. The physical resources 720 may be implemented as any type of processor, controller, or other compute circuit capable of performing various tasks such as compute functions and/or controlling the functions of the sled 500 depending on, for example, the type or intended functionality of the sled 500. For example, as discussed in more detail below, the physical resources 720 may be implemented as high-performance processors in examples in which the sled 500 is implemented as a compute sled, as accelerator co-processors or circuits in examples in which the sled 500 is implemented as an accelerator sled, storage controllers in examples in which the sled 500 is implemented as a storage sled, or a set of memory devices in examples in which the sled 500 is implemented as a memory sled.

The sled 500 also includes one or more additional physical resources 730 mounted to the top side 750 of the chassis-less circuit board substrate 702. In the illustrative example, the additional physical resources include a network interface controller (NIC) as discussed in more detail below. Depending on the type and functionality of the sled 500, the physical resources 730 may include additional or other electrical components, circuits, and/or devices in other examples.

The physical resources 720 are communicatively coupled to the physical resources 730 via an input/output (I/O) subsystem 722. The I/O subsystem 722 may be implemented as circuitry and/or components to facilitate input/output operations with the physical resources 720, the physical resources 730, and/or other components of the sled 500. For example, the I/O subsystem 722 may be implemented as, or otherwise include, memory controller hubs, input/output control hubs, integrated sensor hubs, firmware devices, communication links (e.g., point-to-point links, bus links, wires, cables, waveguides, light guides, printed circuit board traces, etc.), and/or other components and subsystems to facilitate the input/output operations. In the illustrative example, the I/O subsystem 722 is implemented as, or otherwise includes, a double data rate 4 (DDR4) data bus or a DDR5 data bus.

In some examples, the sled 500 may also include a resource-to-resource interconnect 724. The resource-to-resource interconnect 724 may be implemented as any type of communication interconnect capable of facilitating resource-to-resource communications. In the illustrative example, the resource-to-resource interconnect 724 is implemented as a high-speed point-to-point interconnect (e.g., faster than the I/O subsystem 722). For example, the resource-to-resource interconnect 724 may be implemented as a QuickPath Interconnect (QPI), an UltraPath Interconnect (UPI), or other high-speed point-to-point interconnect dedicated to resource-to-resource communications.

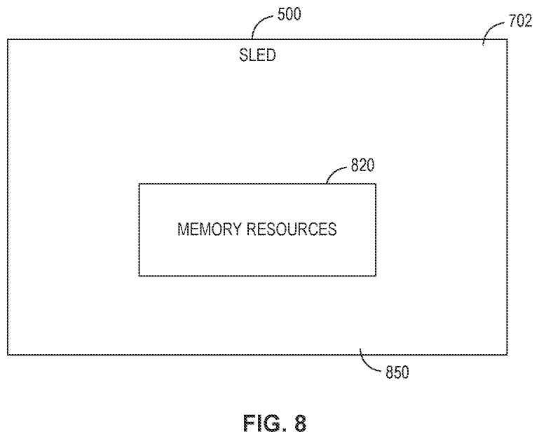

The sled 500 also includes a power connector 740 configured to mate with a corresponding power connector of the rack 340 when the sled 500 is mounted in the corresponding rack 340. The sled 500 receives power from a power supply of the rack 340 via the power connector 740 to supply power to the various electrical components of the sled 500. That is, the sled 500 does not include any local power supply (i.e., an on-board power supply) to provide power to the electrical components of the sled 500. The exclusion of a local or on-board power supply facilitates the reduction in the overall footprint of the chassis-less circuit board substrate 702, which may increase the thermal cooling characteristics of the various electrical components mounted on the chassis-less circuit board substrate 702 as discussed above. In some examples, voltage regulators are placed on a bottom side 850 (see FIG. 8) of the chassis-less circuit board substrate 702 directly opposite of processor circuitry 920 (see FIG. 9), and power is routed from the voltage regulators to the processor circuitry 920 by vias extending through the circuit board substrate 702. Such a configuration provides an increased thermal budget, additional current and/or voltage, and better voltage control relative to typical printed circuit boards in which processor power is delivered from a voltage regulator, in part, by printed circuit traces.

In some examples, the sled 500 may also include mounting features 742 configured to mate with a mounting arm, or other structure, of a robot to facilitate the placement of the sled 500 in a rack 340 by the robot. The mounting features 742 may be implemented as any type of physical structures that allow the robot to grasp the sled 500 without damaging the chassis-less circuit board substrate 702 or the electrical components mounted thereto. For example, in some examples, the mounting features 742 may be implemented as non-conductive pads attached to the chassis-less circuit board substrate 702. In other examples, the mounting features may be implemented as brackets, braces, or other similar structures attached to the chassis-less circuit board substrate 702. The particular number, shape, size, and/or make-up of the mounting feature 742 may depend on the design of the robot configured to manage the sled 500.

Referring now to FIG. 8, in addition to the physical resources 730 mounted on the top side 750 of the chassis-less circuit board substrate 702, the sled 500 also includes one or more memory devices 820 mounted to a bottom side 850 of the chassis-less circuit board substrate 702. That is, the chassis-less circuit board substrate 702 is implemented as a double-sided circuit board. The physical resources 720 are communicatively coupled to the memory devices 820 via the I/O subsystem 722. For example, the physical resources 720 and the memory devices 820 may be communicatively coupled by one or more vias extending through the chassis-less circuit board substrate 702. Different ones of the physical resources 720 may be communicatively coupled to different sets of one or more memory devices 820 in some examples. Alternatively, in other examples, different ones of the physical resources 720 may be communicatively coupled to the same ones of the memory devices 820.

The memory devices 820 may be implemented as any type of memory device capable of storing data for the physical resources 720 during operation of the sled 500, such as any type of volatile (e.g., dynamic random access memory (DRAM), etc.) or non-volatile memory. Volatile memory may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular examples, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

In one example, the memory device is a block addressable memory device, such as those based on NAND or NOR technologies. A memory device may also include next-generation nonvolatile devices, such as Intel 3D XPoint™ memory or other byte addressable write-in-place nonvolatile memory devices. In one example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In some examples, the memory device may include a transistor-less stackable cross point architecture in which memory cells sit at the intersection of word lines and bit lines and are individually addressable and in which bit storage is based on a change in bulk resistance.

Referring now to FIG. 9, in some examples, the sled 500 may be implemented as a compute sled 900. The compute sled 900 is optimized, or otherwise configured, to perform compute tasks. As discussed above, the compute sled 900 may rely on other sleds, such as acceleration sleds and/or storage sleds, to perform such compute tasks. The compute sled 900 includes various physical resources (e.g., electrical components) similar to the physical resources of the sled 500, which have been identified in FIG. 9 using the same reference numbers. The description of such components provided above in regard to FIGS. 7 and 8 applies to the corresponding components of the compute sled 900 and is not repeated herein for clarity of the description of the compute sled 900.

In the illustrative compute sled 900, the physical resources 720 include processor circuitry 920. Although only two blocks of processor circuitry 920 are shown in FIG. 9, it should be appreciated that the compute sled 900 may include additional processor circuits 920 in other examples. Illustratively, the processor circuitry 920 corresponds to high-performance processors 920 and may be configured to operate at a relatively high power rating. Although the high-performance processor circuitry 920 generates additional heat operating at power ratings greater than typical processors (which operate at around 155-230 W), the enhanced thermal cooling characteristics of the chassis-less circuit board substrate 702 discussed above facilitate the higher power operation. For example, in the illustrative example, the processor circuitry 920 is configured to operate at a power rating of at least 250 W. In some examples, the processor circuitry 920 may be configured to operate at a power rating of at least 350 W.

In some examples, the compute sled 900 may also include a processor-to-processor interconnect 942. Similar to the resource-to-resource interconnect 724 of the sled 500 discussed above, the processor-to-processor interconnect 942 may be implemented as any type of communication interconnect capable of facilitating processor-to-processor interconnect 942 communications. In the illustrative example, the processor-to-processor interconnect 942 is implemented as a high-speed point-to-point interconnect (e.g., faster than the I/O subsystem 722). For example, the processor-to-processor interconnect 942 may be implemented as a QuickPath Interconnect (QPI), an UltraPath Interconnect (UPI), or other high-speed point-to-point interconnect dedicated to processor-to-processor communications.

The compute sled 900 also includes a communication circuit 930. The illustrative communication circuit 930 includes a network interface controller (NIC) 932, which may also be referred to as a host fabric interface (HFI). The NIC 932 may be implemented as, or otherwise include, any type of integrated circuit, discrete circuits, controller chips, chipsets, add-in-boards, daughtercards, network interface cards, or other devices that may be used by the compute sled 900 to connect with another compute device (e.g., with other sleds 500). In some examples, the NIC 932 may be implemented as part of a system-on-a-chip (SoC) that includes one or more processors, or included on a multichip package that also contains one or more processors. In some examples, the NIC 932 may include a local processor (not shown) and/or a local memory (not shown) that are both local to the NIC 932. In such examples, the local processor of the NIC 932 may be capable of performing one or more of the functions of the processor circuitry 920. Additionally or alternatively, in such examples, the local memory of the NIC 932 may be integrated into one or more components of the compute sled at the board level, socket level, chip level, and/or other levels.

The communication circuit 930 is communicatively coupled to an optical data connector 934. The optical data connector 934 is configured to mate with a corresponding optical data connector of the rack 340 when the compute sled 900 is mounted in the rack 340. Illustratively, the optical data connector 934 includes a plurality of optical fibers which lead from a mating surface of the optical data connector 934 to an optical transceiver 936. The optical transceiver 936 is configured to convert incoming optical signals from the rack-side optical data connector to electrical signals and to convert electrical signals to outgoing optical signals to the rack-side optical data connector. Although shown as forming part of the optical data connector 934 in the illustrative example, the optical transceiver 936 may form a portion of the communication circuit 930 in other examples.

In some examples, the compute sled 900 may also include an expansion connector 940. In such examples, the expansion connector 940 is configured to mate with a corresponding connector of an expansion chassis-less circuit board substrate to provide additional physical resources to the compute sled 900. The additional physical resources may be used, for example, by the processor circuitry 920 during operation of the compute sled 900. The expansion chassis-less circuit board substrate may be substantially similar to the chassis-less circuit board substrate 702 discussed above and may include various electrical components mounted thereto. The particular electrical components mounted to the expansion chassis-less circuit board substrate may depend on the intended functionality of the expansion chassis-less circuit board substrate. For example, the expansion chassis-less circuit board substrate may provide additional compute resources, memory resources, and/or storage resources. As such, the additional physical resources of the expansion chassis-less circuit board substrate may include, but is not limited to, processors, memory devices, storage devices, and/or accelerator circuits including, for example, field programmable gate arrays (FPGA), application-specific integrated circuits (ASICs), security co-processors, graphics processing units (GPUs), machine learning circuits, or other specialized processors, controllers, devices, and/or circuits.

Referring now to FIG. 10, an illustrative example of the compute sled 900 is shown. As shown, the processor circuitry 920, communication circuit 930, and optical data connector 934 are mounted to the top side 750 of the chassis-less circuit board substrate 702. Any suitable attachment or mounting technology may be used to mount the physical resources of the compute sled 900 to the chassis-less circuit board substrate 702. For example, the various physical resources may be mounted in corresponding sockets (e.g., a processor socket), holders, or brackets. In some cases, some of the electrical components may be directly mounted to the chassis-less circuit board substrate 702 via soldering or similar techniques.

As discussed above, the separate processor circuitry 920 and the communication circuit 930 are mounted to the top side 750 of the chassis-less circuit board substrate 702 such that no two heat-producing, electrical components shadow each other. In the illustrative example, the processor circuitry 920 and the communication circuit 930 are mounted in corresponding locations on the top side 750 of the chassis-less circuit board substrate 702 such that no two of those physical resources are linearly in-line with others along the direction of the airflow path 708. It should be appreciated that, although the optical data connector 934 is in-line with the communication circuit 930, the optical data connector 934 produces no or nominal heat during operation.

The memory devices 820 of the compute sled 900 are mounted to the bottom side 850 of the of the chassis-less circuit board substrate 702 as discussed above in regard to the sled 500. Although mounted to the bottom side 850, the memory devices 820 are communicatively coupled to the processor circuitry 920 located on the top side 750 via the I/O subsystem 722. Because the chassis-less circuit board substrate 702 is implemented as a double-sided circuit board, the memory devices 820 and the processor circuitry 920 may be communicatively coupled by one or more vias, connectors, or other mechanisms extending through the chassis-less circuit board substrate 702. Different processor circuitry 920 (e.g., different processors) may be communicatively coupled to a different set of one or more memory devices 820 in some examples. Alternatively, in other examples, different processor circuitry 920 (e.g., different processors) may be communicatively coupled to the same ones of the memory devices 820. In some examples, the memory devices 820 may be mounted to one or more memory mezzanines on the bottom side of the chassis-less circuit board substrate 702 and may interconnect with a corresponding processor circuitry 920 through a ball-grid array.

Different processor circuitry 920 (e.g., different processors) include and/or is associated with corresponding heatsinks 950 secured thereto. Due to the mounting of the memory devices 820 to the bottom side 850 of the chassis-less circuit board substrate 702 (as well as the vertical spacing of the sleds 500 in the corresponding rack 340), the top side 750 of the chassis-less circuit board substrate 702 includes additional “free” area or space that facilitates the use of heatsinks 950 having a larger size relative to traditional heatsinks used in typical servers. Additionally, due to the improved thermal cooling characteristics of the chassis-less circuit board substrate 702, none of the processor heatsinks 950 include cooling fans attached thereto. That is, the heatsinks 950 may be fan-less heatsinks. In some examples, the heatsinks 950 mounted atop the processor circuitry 920 may overlap with the heatsink attached to the communication circuit 930 in the direction of the airflow path 708 due to their increased size, as illustratively suggested by FIG. 10.

Referring now to FIG. 11, in some examples, the sled 500 may be implemented as an accelerator sled 1100. The accelerator sled 1100 is configured, to perform specialized compute tasks, such as machine learning, encryption, hashing, or other computational-intensive task. In some examples, for example, a compute sled 900 may offload tasks to the accelerator sled 1100 during operation. The accelerator sled 1100 includes various components similar to components of the sled 500 and/or the compute sled 900, which have been identified in FIG. 11 using the same reference numbers. The description of such components provided above in regard to FIGS. 7, 8, and 9 apply to the corresponding components of the accelerator sled 1100 and is not repeated herein for clarity of the description of the accelerator sled 1100.

In the illustrative accelerator sled 1100, the physical resources 720 include accelerator circuits 1120. Although only two accelerator circuits 1120 are shown in FIG. 11, it should be appreciated that the accelerator sled 1100 may include additional accelerator circuits 1120 in other examples. For example, as shown in FIG. 12, the accelerator sled 1100 may include four accelerator circuits 1120. The accelerator circuits 1120 may be implemented as any type of processor, co-processor, compute circuit, or other device capable of performing compute or processing operations. For example, the accelerator circuits 1120 may be implemented as, for example, field programmable gate arrays (FPGA), application-specific integrated circuits (ASICs), security co-processors, graphics processing units (GPUs), neuromorphic processor units, quantum computers, machine learning circuits, or other specialized processors, controllers, devices, and/or circuits.

In some examples, the accelerator sled 1100 may also include an accelerator-to-accelerator interconnect 1142. Similar to the resource-to-resource interconnect 724 of the sled 500 discussed above, the accelerator-to-accelerator interconnect 1142 may be implemented as any type of communication interconnect capable of facilitating accelerator-to-accelerator communications. In the illustrative example, the accelerator-to-accelerator interconnect 1142 is implemented as a high-speed point-to-point interconnect (e.g., faster than the I/O subsystem 722). For example, the accelerator-to-accelerator interconnect 1142 may be implemented as a QuickPath Interconnect (QPI), an UltraPath Interconnect (UPI), or other high-speed point-to-point interconnect dedicated to processor-to-processor communications. In some examples, the accelerator circuits 1120 may be daisy-chained with a primary accelerator circuit 1120 connected to the NIC 932 and memory 820 through the I/O subsystem 722 and a secondary accelerator circuit 1120 connected to the NIC 932 and memory 820 through a primary accelerator circuit 1120.

Referring now to FIG. 12, an illustrative example of the accelerator sled 1100 is shown. As discussed above, the accelerator circuits 1120, the communication circuit 930, and the optical data connector 934 are mounted to the top side 750 of the chassis-less circuit board substrate 702. Again, the individual accelerator circuits 1120 and communication circuit 930 are mounted to the top side 750 of the chassis-less circuit board substrate 702 such that no two heat-producing, electrical components shadow each other as discussed above. The memory devices 820 of the accelerator sled 1100 are mounted to the bottom side 850 of the of the chassis-less circuit board substrate 702 as discussed above in regard to the sled 500. Although mounted to the bottom side 850, the memory devices 820 are communicatively coupled to the accelerator circuits 1120 located on the top side 750 via the I/O subsystem 722 (e.g., through vias). Further, the accelerator circuits 1120 may include and/or be associated with a heatsink 1150 that is larger than a traditional heatsink used in a server. As discussed above with reference to the heatsinks 950 of FIG. 9, the heatsinks 1150 may be larger than traditional heatsinks because of the “free” area provided by the memory resources 820 being located on the bottom side 850 of the chassis-less circuit board substrate 702 rather than on the top side 750.

Referring now to FIG. 13, in some examples, the sled 500 may be implemented as a storage sled 1300. The storage sled 1300 is configured, to store data in a data storage 1350 local to the storage sled 1300. For example, during operation, a compute sled 900 or an accelerator sled 1100 may store and retrieve data from the data storage 1350 of the storage sled 1300. The storage sled 1300 includes various components similar to components of the sled 500 and/or the compute sled 900, which have been identified in FIG. 13 using the same reference numbers. The description of such components provided above in regard to FIGS. 7, 8, and 9 apply to the corresponding components of the storage sled 1300 and is not repeated herein for clarity of the description of the storage sled 1300.

In the illustrative storage sled 1300, the physical resources 720 includes storage controllers 1320. Although only two storage controllers 1320 are shown in FIG. 13, it should be appreciated that the storage sled 1300 may include additional storage controllers 1320 in other examples. The storage controllers 1320 may be implemented as any type of processor, controller, or control circuit capable of controlling the storage and retrieval of data into the data storage 1350 based on requests received via the communication circuit 930. In the illustrative example, the storage controllers 1320 are implemented as relatively low-power processors or controllers. For example, in some examples, the storage controllers 1320 may be configured to operate at a power rating of about 75 watts.

In some examples, the storage sled 1300 may also include a controller-to-controller interconnect 1342. Similar to the resource-to-resource interconnect 724 of the sled 500 discussed above, the controller-to-controller interconnect 1342 may be implemented as any type of communication interconnect capable of facilitating controller-to-controller communications. In the illustrative example, the controller-to-controller interconnect 1342 is implemented as a high-speed point-to-point interconnect (e.g., faster than the I/O subsystem 722). For example, the controller-to-controller interconnect 1342 may be implemented as a QuickPath Interconnect (QPI), an UltraPath Interconnect (UPI), or other high-speed point-to-point interconnect dedicated to processor-to-processor communications.

Referring now to FIG. 14, an illustrative example of the storage sled 1300 is shown. In the illustrative example, the data storage 1350 is implemented as, or otherwise includes, a storage cage 1352 configured to house one or more solid state drives (SSDs) 1354. To do so, the storage cage 1352 includes a number of mounting slots 1356, which are configured to receive corresponding solid state drives 1354. The mounting slots 1356 include a number of drive guides 1358 that cooperate to define an access opening 1360 of the corresponding mounting slot 1356. The storage cage 1352 is secured to the chassis-less circuit board substrate 702 such that the access openings face away from (i.e., toward the front of) the chassis-less circuit board substrate 702. As such, solid state drives 1354 are accessible while the storage sled 1300 is mounted in a corresponding rack 340. For example, a solid state drive 1354 may be swapped out of a rack 340 (e.g., via a robot) while the storage sled 1300 remains mounted in the corresponding rack 340.

The storage cage 1352 illustratively includes sixteen mounting slots 1356 and is capable of mounting and storing sixteen solid state drives 1354. The storage cage 1352 may be configured to store additional or fewer solid state drives 1354 in other examples. Additionally, in the illustrative example, the solid state drives are mounted vertically in the storage cage 1352, but may be mounted in the storage cage 1352 in a different orientation in other examples. A given solid state drive 1354 may be implemented as any type of data storage device capable of storing long term data. To do so, the solid state drives 1354 may include volatile and non-volatile memory devices discussed above.

As shown in FIG. 14, the storage controllers 1320, the communication circuit 930, and the optical data connector 934 are illustratively mounted to the top side 750 of the chassis-less circuit board substrate 702. Again, as discussed above, any suitable attachment or mounting technology may be used to mount the electrical components of the storage sled 1300 to the chassis-less circuit board substrate 702 including, for example, sockets (e.g., a processor socket), holders, brackets, soldered connections, and/or other mounting or securing techniques.

As discussed above, the individual storage controllers 1320 and the communication circuit 930 are mounted to the top side 750 of the chassis-less circuit board substrate 702 such that no two heat-producing, electrical components shadow each other. For example, the storage controllers 1320 and the communication circuit 930 are mounted in corresponding locations on the top side 750 of the chassis-less circuit board substrate 702 such that no two of those electrical components are linearly in-line with each other along the direction of the airflow path 708.

The memory devices 820 (not shown in FIG. 14) of the storage sled 1300 are mounted to the bottom side 850 (not shown in FIG. 14) of the chassis-less circuit board substrate 702 as discussed above in regard to the sled 500. Although mounted to the bottom side 850, the memory devices 820 are communicatively coupled to the storage controllers 1320 located on the top side 750 via the I/O subsystem 722. Again, because the chassis-less circuit board substrate 702 is implemented as a double-sided circuit board, the memory devices 820 and the storage controllers 1320 may be communicatively coupled by one or more vias, connectors, or other mechanisms extending through the chassis-less circuit board substrate 702. The storage controllers 1320 include and/or are associated with a heatsink 1370 secured thereto. As discussed above, due to the improved thermal cooling characteristics of the chassis-less circuit board substrate 702 of the storage sled 1300, none of the heatsinks 1370 include cooling fans attached thereto. That is, the heatsinks 1370 may be fan-less heatsinks.

Referring now to FIG. 15, in some examples, the sled 500 may be implemented as a memory sled 1500. The storage sled 1500 is optimized, or otherwise configured, to provide other sleds 500 (e.g., compute sleds 900, accelerator sleds 1100, etc.) with access to a pool of memory (e.g., in two or more sets 1530, 1532 of memory devices 820) local to the memory sled 1300. For example, during operation, a compute sled 900 or an accelerator sled 1100 may remotely write to and/or read from one or more of the memory sets 1530, 1532 of the memory sled 1300 using a logical address space that maps to physical addresses in the memory sets 1530, 1532. The memory sled 1500 includes various components similar to components of the sled 500 and/or the compute sled 900, which have been identified in FIG. 15 using the same reference numbers. The description of such components provided above in regard to FIGS. 7, 8, and 9 apply to the corresponding components of the memory sled 1500 and is not repeated herein for clarity of the description of the memory sled 1500.

In the illustrative memory sled 1500, the physical resources 720 include memory controllers 1520. Although only two memory controllers 1520 are shown in FIG. 15, it should be appreciated that the memory sled 1500 may include additional memory controllers 1520 in other examples. The memory controllers 1520 may be implemented as any type of processor, controller, or control circuit capable of controlling the writing and reading of data into the memory sets 1530, 1532 based on requests received via the communication circuit 930. In the illustrative example, the memory controllers 1520 are connected to corresponding memory sets 1530, 1532 to write to and read from memory devices 820 (not shown) within the corresponding memory set 1530, 1532 and enforce any permissions (e.g., read, write, etc.) associated with sled 500 that has sent a request to the memory sled 1500 to perform a memory access operation (e.g., read or write).

In some examples, the memory sled 1500 may also include a controller-to-controller interconnect 1542. Similar to the resource-to-resource interconnect 724 of the sled 500 discussed above, the controller-to-controller interconnect 1542 may be implemented as any type of communication interconnect capable of facilitating controller-to-controller communications. In the illustrative example, the controller-to-controller interconnect 1542 is implemented as a high-speed point-to-point interconnect (e.g., faster than the I/O subsystem 722). For example, the controller-to-controller interconnect 1542 may be implemented as a QuickPath Interconnect (QPI), an UltraPath Interconnect (UPI), or other high-speed point-to-point interconnect dedicated to processor-to-processor communications. As such, in some examples, a memory controller 1520 may access, through the controller-to-controller interconnect 1542, memory that is within the memory set 1532 associated with another memory controller 1520. In some examples, a scalable memory controller is made of multiple smaller memory controllers, referred to herein as “chiplets”, on a memory sled (e.g., the memory sled 1500). The chiplets may be interconnected (e.g., using EMIB (Embedded Multi-Die Interconnect Bridge) technology). The combined chiplet memory controller may scale up to a relatively large number of memory controllers and I/O ports, (e.g., up to 16 memory channels). In some examples, the memory controllers 1520 may implement a memory interleave (e.g., one memory address is mapped to the memory set 1530, the next memory address is mapped to the memory set 1532, and the third address is mapped to the memory set 1530, etc.). The interleaving may be managed within the memory controllers 1520, or from CPU sockets (e.g., of the compute sled 900) across network links to the memory sets 1530, 1532, and may improve the latency associated with performing memory access operations as compared to accessing contiguous memory addresses from the same memory device.

Further, in some examples, the memory sled 1500 may be connected to one or more other sleds 500 (e.g., in the same rack 340 or an adjacent rack 340) through a waveguide, using the waveguide connector 1580. In the illustrative example, the waveguides are 74 millimeter waveguides that provide 16 Rx (i.e., receive) lanes and 16 Tx (i.e., transmit) lanes. Different ones of the lanes, in the illustrative example, are either 16 GHz or 32 GHz. In other examples, the frequencies may be different. Using a waveguide may provide high throughput access to the memory pool (e.g., the memory sets 1530, 1532) to another sled (e.g., a sled 500 in the same rack 340 or an adjacent rack 340 as the memory sled 1500) without adding to the load on the optical data connector 934.

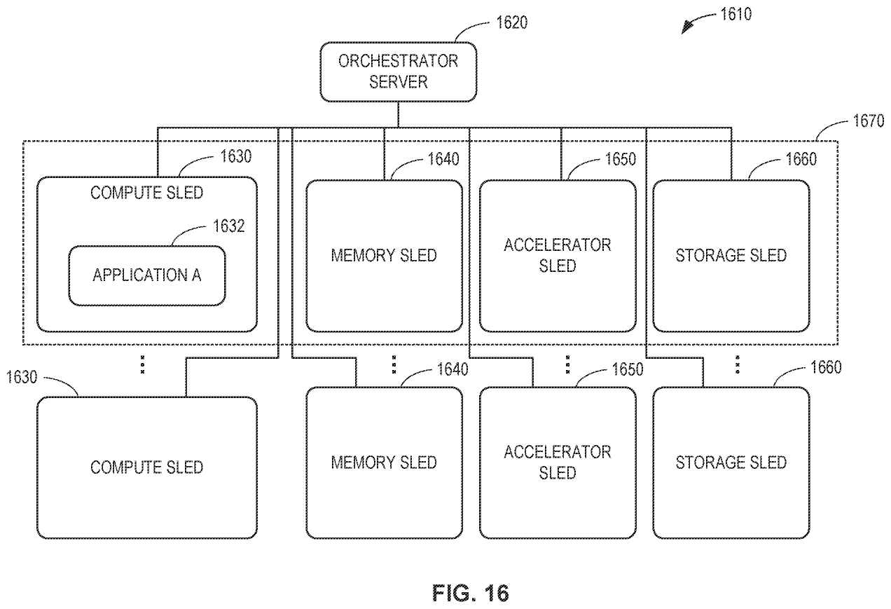

Referring now to FIG. 16, a system for executing one or more workloads (e.g., applications) may be implemented in accordance with the data center 200. In the illustrative example, the system 1610 includes an orchestrator server 1620, which may be implemented as a managed node including a compute device (e.g., processor circuitry 920 on a compute sled 900) executing management software (e.g., a cloud operating environment, such as OpenStack) that is communicatively coupled to multiple sleds 500 including a large number of compute sleds 1630 (e.g., similar to the compute sled 900), memory sleds 1640 (e.g., similar to the memory sled 1500), accelerator sleds 1650 (e.g., similar to the memory sled 1500), and storage sleds 1660 (e.g., similar to the storage sled 1300). One or more of the sleds 1630, 1640, 1650, 1660 may be grouped into a managed node 1670, such as by the orchestrator server 1620, to collectively perform a workload (e.g., an application 1632 executed in a virtual machine or in a container). The managed node 1670 may be implemented as an assembly of physical resources 720, such as processor circuitry 920, memory resources 820, accelerator circuits 1120, or data storage 1350, from the same or different sleds 500. Further, the managed node may be established, defined, or “spun up” by the orchestrator server 1620 at the time a workload is to be assigned to the managed node or at any other time, and may exist regardless of whether any workloads are presently assigned to the managed node. In the illustrative example, the orchestrator server 1620 may selectively allocate and/or deallocate physical resources 720 from the sleds 500 and/or add or remove one or more sleds 500 from the managed node 1670 as a function of quality of service (QoS) targets (e.g., a target throughput, a target latency, a target number of instructions per second, etc.) associated with a service level agreement for the workload (e.g., the application 1632). In doing so, the orchestrator server 1620 may receive telemetry data indicative of performance conditions (e.g., throughput, latency, instructions per second, etc.) in different ones of the sleds 500 of the managed node 1670 and compare the telemetry data to the quality of service targets to determine whether the quality of service targets are being satisfied. The orchestrator server 1620 may additionally determine whether one or more physical resources may be deallocated from the managed node 1670 while still satisfying the QoS targets, thereby freeing up those physical resources for use in another managed node (e.g., to execute a different workload). Alternatively, if the QoS targets are not presently satisfied, the orchestrator server 1620 may determine to dynamically allocate additional physical resources to assist in the execution of the workload (e.g., the application 1632) while the workload is executing. Similarly, the orchestrator server 1620 may determine to dynamically deallocate physical resources from a managed node if the orchestrator server 1620 determines that deallocating the physical resource would result in QoS targets still being met.

Additionally, in some examples, the orchestrator server 1620 may identify trends in the resource utilization of the workload (e.g., the application 1632), such as by identifying phases of execution (e.g., time periods in which different operations, having different resource utilizations characteristics, are performed) of the workload (e.g., the application 1632) and pre-emptively identifying available resources in the data center 200 and allocating them to the managed node 1670 (e.g., within a predefined time period of the associated phase beginning). In some examples, the orchestrator server 1620 may model performance based on various latencies and a distribution scheme to place workloads among compute sleds and other resources (e.g., accelerator sleds, memory sleds, storage sleds) in the data center 200. For example, the orchestrator server 1620 may utilize a model that accounts for the performance of resources on the sleds 500 (e.g., FPGA performance, memory access latency, etc.) and the performance (e.g., congestion, latency, bandwidth) of the path through the network to the resource (e.g., FPGA). As such, the orchestrator server 1620 may determine which resource(s) should be used with which workloads based on the total latency associated with different potential resource(s) available in the data center 200 (e.g., the latency associated with the performance of the resource itself in addition to the latency associated with the path through the network between the compute sled executing the workload and the sled 500 on which the resource is located).

In some examples, the orchestrator server 1620 may generate a map of heat generation in the data center 200 using telemetry data (e.g., temperatures, fan speeds, etc.) reported from the sleds 500 and allocate resources to managed nodes as a function of the map of heat generation and predicted heat generation associated with different workloads, to maintain a target temperature and heat distribution in the data center 200. Additionally or alternatively, in some examples, the orchestrator server 1620 may organize received telemetry data into a hierarchical model that is indicative of a relationship between the managed nodes (e.g., a spatial relationship such as the physical locations of the resources of the managed nodes within the data center 200 and/or a functional relationship, such as groupings of the managed nodes by the customers the managed nodes provide services for, the types of functions typically performed by the managed nodes, managed nodes that typically share or exchange workloads among each other, etc.). Based on differences in the physical locations and resources in the managed nodes, a given workload may exhibit different resource utilizations (e.g., cause a different internal temperature, use a different percentage of processor or memory capacity) across the resources of different managed nodes. The orchestrator server 1620 may determine the differences based on the telemetry data stored in the hierarchical model and factor the differences into a prediction of future resource utilization of a workload if the workload is reassigned from one managed node to another managed node, to accurately balance resource utilization in the data center 200. In some examples, the orchestrator server 1620 may identify patterns in resource utilization phases of the workloads and use the patterns to predict future resource utilization of the workloads.

To reduce the computational load on the orchestrator server 1620 and the data transfer load on the network, in some examples, the orchestrator server 1620 may send self-test information to the sleds 500 to enable a given sled 500 to locally (e.g., on the sled 500) determine whether telemetry data generated by the sled 500 satisfies one or more conditions (e.g., an available capacity that satisfies a predefined threshold, a temperature that satisfies a predefined threshold, etc.). The given sled 500 may then report back a simplified result (e.g., yes or no) to the orchestrator server 1620, which the orchestrator server 1620 may utilize in determining the allocation of resources to managed nodes.

FIG. 17 illustrates an example edge environment 1700 in which examples disclosed herein may be implemented. In the illustrated example of FIG. 17, the edge environment 1700 includes example edge appliances 1702 (e.g., including a first example edge appliance 1702A and a second example edge appliance 1702B) fluidly and/or operatively coupled to an example infrastructure cooling distribution unit (CDU) 1704. In some examples, the edge appliances 1702 can include one or more of the central data centers 102, one or more of the edge data centers 106, one or more of the buildings 110, and/or one or more of the CDN data centers 116 of FIG. 1. While two of the edge appliances 1702 are shown in FIG. 17, one or more additional edge appliances may be included in the edge environment 1700 and/or fluidly coupled to the infrastructure CDU 1706. In some examples, the edge appliances 1702 can include a single server, a server and an accelerator, and/or a server and a GPU. In some examples, the edge appliances 1702 include routers, switches, and/or integrated access devices. In some examples, an edge appliances 1702 include hardware that controls data flow at a boundary between two or more networks. In some examples, the edge appliances 1702 can run services such as 5G networks, content delivery networks (CDNs), virtual cable modem termination systems (vCMTS), a virtual Broadband Network Gateway (vBNG), etc.

In the illustrated example of FIG. 17, the infrastructure CDU 1706 provides cooling fluid (e.g., water, coolant) to the edge appliances 1702. For example, the infrastructure CDU 1706 can receive water from a central source (e.g., from city infrastructure) and distribute the cooling fluid to one(s) of the edge appliances 1702. In some such examples, the edge appliances 1702 utilize the cooling fluid to cool a second cooling fluid circulating in the edge appliances 1702 and/or to directly cool one or more components (e.g., racks, sleds, compute resources such as processor circuitry and/or memory, etc.) of the corresponding edge appliances 1702. In some examples, the edge appliances 1702 provide the cooling fluid to one or more immersion tanks and/or one or more cold plates of the edge appliances 1702 to cool the one or more components.

In the illustrated example of FIG. 17, the infrastructure CDU 1704 implements example infrastructure control circuitry 1708 to control distribution of the cooling fluid to and/or between the edge appliances 1702. In this example, the edge appliances 1702 implement example appliance control circuitry 1710 to further control the distribution of the cooling fluid to and/or between one or more components of the respective edge appliances 1702 and/or one or more tenants operating on the respective edge appliances 1702. In some examples, one or more of the edge appliances 1702 implement a corresponding instance of the appliance control circuitry 1710 to control distribution of cooling fluid at the respective edge appliance 1702. In some examples, the appliance control circuitry 1710 implemented by a first one of the edge appliances 1702 can control distribution of the cooling fluid for the first one of the edge appliances 1702 and/or one or more other ones of the edge appliances 1702.

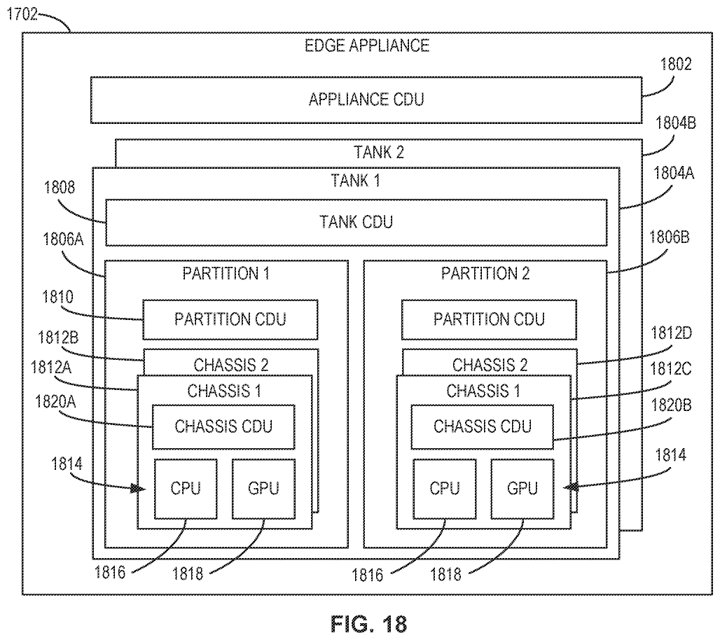

FIG. 18 illustrates one of the example edge appliances 1702 of FIG. 17. In the illustrated example of FIG. 18, the edge appliance 1702 includes an example appliance CDU 1802 fluidly and/or operatively coupled to one or more example tanks (e.g., immersion tanks) 1804 included in the edge appliance 1702. While two of the tanks 1804 (e.g., a first example tank 1804A and a second example tank 1804B) are shown in the illustrated example of FIG. 18, a different number of the tanks 1804 (e.g., one tank, more than two tanks) may be included in the edge appliance 1702. In some examples, one or more of the tanks 1804 of FIG. 18 may be omitted. In some examples, one or more cold plates may be used in addition to or instead of the tank(s) 1804. In some examples, the appliance CDU 1802 receives and/or obtains cooling fluid provided to the edge appliance 1702 via the infrastructure CDU 1704 of FIG. 17. In such examples, the appliance CDU 1802 distributes the cooling fluid to and/or between one(s) of the tanks 1804 based on expected cooling parameters (e.g., expected cooling requirements, properties, or thresholds with respect to the cooling resources such as cooling fluid temperature; tank cooling requirements, properties, or thresholds such as minimum coolant flow rates) associated with the tanks 1804. In some examples, one or more electronic components of the edge appliance 1702 can be submerged and/or stored in the cooling fluid of the tanks 1804 to facilitate cooling thereof.

In this example, ones of the example tanks 1804 include one or more example partitions 1806 (e.g., a first example partition 1806A and a second example partition 1806B) to which the cooling fluid of the corresponding tank 1804 can be provided. In some examples, the tank 1804 includes an example tank CDU 1808 to direct the cooling fluid provided to the tank 1804 to one(s) of the partitions 1806. While two of the partitions 1806 are included in FIG. 1, the tank 1804 can include a different number of the partitions 1806 instead. In some examples, one or more of the partitions 1806 of FIG. 18 may be omitted. In the illustrated example of FIG. 18, the partitions 1806 further include corresponding example partition CDUs 1810 to distribute the cooling fluid to one or more example chassis 1812 included within the corresponding partition(s) 1806. In this example, first and second example chassis 1812A, 1812B are included in the first partition 1806A, and third and fourth example chassis 1812C, 1812D are included in the second partition 1806B. In some examples, a different number of the chassis 1812 can be included in the first partition 1806A and/or the second partition 1806B. In some examples, one or more of the chassis 1812 of FIG. 18 may be omitted.

In some examples, the chassis 1812 contain (e.g., store, house) one or more example electronic components 1814 of the edge appliance 1702. In the illustrated example of FIG. 18, the one or more electronic components 1814 include example central processing units (CPUs) 1816 and example graphics processing units (GPUs) 1818 stored in corresponding one(s) of the chassis 1812. In some examples, the electronic components 1814 can include one or more different devices (e.g., a memory chip). In some examples, a chassis-less sled may be used instead of one or more of the chassis 1812 of FIG. 18. In the illustrated example of FIG. 18, the chassis 1812 include example chassis CDUs 1820 to distribute cooling fluid to one(s) of the electronic components 1814 (e.g., the CPUs 1816 and/or the GPUs 1818) of the corresponding chassis 1812. In some examples, one(s) of the chassis 1812 include one or more cold plates operatively coupled to the one(s) of the electronic component 1814 and/or to one or more portions of the electronic component(s). In such examples, the chassis CDUs 1820 provide the cooling fluid to the cold plate(s) and/or to partitions of the cold plate(s) to cool the one(s) of the electronic components 1814.

In the illustrated example of FIG. 18, each of the chassis 1812 implements a corresponding one of the chassis CDUs 1820, each of the partitions 1806 implements a corresponding one of the partition CDUs 1810, each of the tanks 1804 implements a corresponding one of the tank CDUs 1808, and each of the edge appliances 1702 implements a corresponding one of the appliance CDUs 1802. In some examples, one or more of the chassis CDUs 1820, the partition CDUs 1810, the tank CDUs 1808, and/or the appliance CDUs 1802 may be omitted. For example, one(s) of the chassis CDUs 1820 may operate across multiples ones of the chassis 1812, one(s) of the partition CDUs 1810 may operate across multiple ones of the partitions 1806, one(s) of the tank CDUs 1808 may operate over multiple across of the tanks 1804, and/or one(s) of the appliance CDUs 1802 may operate across multiple ones of the edge appliances 1702. In some examples, one or more of the chassis CDUs 1820, the partition CDUs 1810, the tank CDUs 1808, and/or the appliance CDUs 1802 can serve any combination of the chassis 1812, the partitions 1806, the tanks 1804, and/or the edge appliances 1702. In some examples, at least one CDU (e.g., the appliance CDU 1802) can be implemented on the edge appliance 1702 to control fluid flow to and/or between one(s) of the chassis 1812, one(s) of the partitions 1806, one(s) of the tanks 1804, and/or one(s) of the edge appliances 1702.

In some examples, one or more tenants can operate on the edge appliance 1702. In examples disclosed herein, a “tenant” refers to one or more users having access to one or more edge devices (e.g., one or more of the edge appliances 1702, one or more of the tanks 1804, one or more of the partitions 1806, one or more of the chassis 1812, and/or one or more of the electronic components 1814) of the edge environment 1700 of FIG. 17. Service-level agreements (SLAs) between the provider of the edge appliance 1702 and the respective tenants can be used to define parameters such as workload(s) to be performed by the edge devices for the tenant, available memory for tenant workload(s), speed at which the workload(s) are to be performed, time(s) at which the workload(s) are to be performed, etc. In some examples, the CDUs 1802, 1808, 1810, 1820 of the edge appliance 1702 distribute cooling fluid to the one or more edge devices based on the SLAs corresponding to the one or more tenants. For example, the SLAs can indicate an expected temperature of edge device(s) corresponding to the tenants, an expected temperature of cooling fluid provided to the edge device(s), an expected duration for which the cooling fluid is to be provided to the edge device(s), etc.

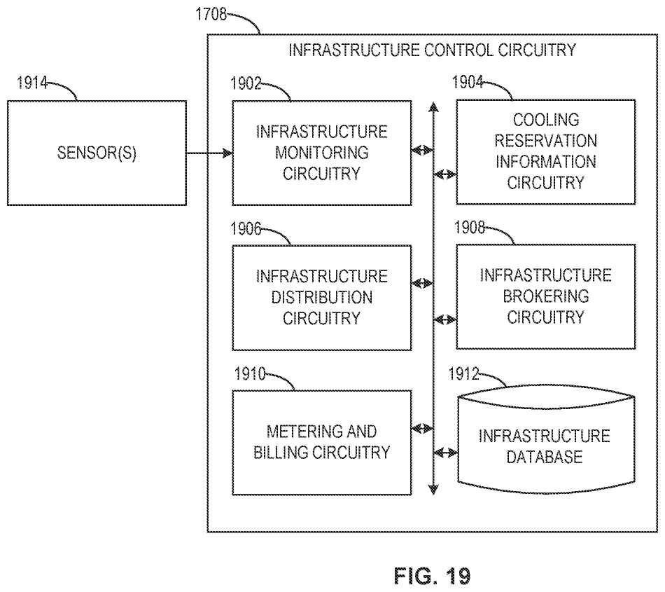

In some examples, the example appliance control circuitry 1710 of FIG. 17 is implemented by the edge appliance 1702 to control the distribution of cooling fluid by the appliance CDUs 1802, the tank CDU(s) 1808, the partition CDU(s) 1810, and/or the chassis CDU(s) 1820. For example, the appliance control circuitry 1710 can be implemented by one or more of the appliance CDU 1802, the tank CDU(s) 1808, the partition CDU(s) 1810, and/or the chassis CDU(s) 1820 to control operation thereof. In some examples, the appliance control circuitry 1710 causes one or more of the CDUs 1802, 1808, 1810, 1820 to provide and/or distribute the cooling fluid based on one or more cooling parameters (e.g., cooling requirements, properties, and/or thresholds) of the edge appliance 1702. For example, the cooling parameters can include a temperature of the one or more edge devices operating on the edge appliance 1702, a volume and/or temperature of cooling fluid provided to the one or more edge devices, etc. In some examples, the appliance control circuitry 1710 determines the cooling parameters based on the SLAs of the tenants operating on the edge appliance 1702 and/or based on measurement data obtained by one or more sensors (FIG. 19) of the edge appliance 1702. As disclosed herein, the sensors of the appliance 1702 can be associated with any or all of the tanks 1804, the partitions 1806, the chassis 1812, the electronic components 1814, etc. of the appliance 1702. In some examples, the appliance control circuitry 1710 facilitates brokering between tenants and/or between the one or more edge devices to redistribute the cooling fluid.

FIG. 19 is a block diagram of the example infrastructure control circuitry 1708 of FIG. 17. The infrastructure control circuitry 1708 of FIG. 19 may be instantiated (e.g., creating an instance of, bring into being for any length of time, materialize, implement, etc.) by programmable circuitry such as a Central Processor Unit (CPU) executing first instructions. Additionally or alternatively, the infrastructure control circuitry 1708 of FIG. 19 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 19 may, thus, be instantiated at the same or different times. Some or all of the circuitry of FIG. 19 may be instantiated, for example, in one or more threads executing concurrently on hardware and/or in series on hardware. Moreover, in some examples, some or all of the circuitry of FIG. 19 may be implemented by microprocessor circuitry executing instructions and/or FPGA circuitry performing operations to implement one or more virtual machines and/or containers.

In the illustrated example of FIG. 19, the infrastructure control circuitry 1708 includes example infrastructure monitoring circuitry 1902, example cooling reservation information circuitry 1904, example infrastructure distribution circuitry 1906, example infrastructure brokering circuitry 1908, example metering and billing circuitry 1910, and an example infrastructure database 1912.

The example infrastructure database 1912 stores data utilized and/or obtained by the infrastructure control circuitry 1708. The example infrastructure database 1912 of FIG. 19 is implemented by any memory, storage device and/or storage disc for storing data such as, for example, flash memory, magnetic media, optical media, solid state memory, hard drive(s), thumb drive(s), etc. Furthermore, the data stored in the example infrastructure database 1912 may be in any data format such as, for example, binary data, comma delimited data, tab delimited data, structured query language (SQL) structures, etc. While, in the illustrated example, the example infrastructure database 1912 is illustrated as a single device, the example infrastructure database 1912 and/or any other data storage devices described herein may be implemented by any number and/or type(s) of memories.

The example infrastructure monitoring circuitry 1902 monitors condition(s) associated with operation of at least one of the infrastructure CDU 1704, the first edge appliance 1702A, or the second edge appliance 1702B of the edge environment 1700 of FIG. 17. For example, the infrastructure monitoring circuitry 1902 is communicatively coupled to one or more example sensors 1914 included in the edge environment 1700, and the infrastructure monitoring circuitry 1902 monitors the condition(s) based on data obtained from the one or more sensors. In some examples, the sensors 1914 include one or more temperature sensors to measure a temperature of cooling fluid provided to the infrastructure CDU 1704 from municipal infrastructure. In some examples, the temperature sensors measure a temperature of cooling fluid provided to the first edge appliance 1702A and/or the second edge appliance 1702B, a temperature of one or more devices implemented on the edge appliances 1702, an ambient temperature of the edge environment 1700, etc. In some examples, the sensors 1914 include at least one flow rate sensor to measure a flow rate of cooling fluid to and/or from at least one of the infrastructure CDU 1704, the first edge appliance 1702A, or the second edge appliance 1702B. In some examples, the infrastructure monitoring circuitry 1902 provides the measurement data from the one or more sensors 1914 to the infrastructure database 1912 for storage therein.

The example cooling reservation information circuitry 1904 obtains and/or monitors cooling reservation information associated with the edge appliances 1702. For example, the cooling reservation information circuitry 1904 generates and/or updates an example cooling reservation table to include cooling reservation information associated with one(s) of the edge appliances 1702. In some examples, the cooling reservation table indicates expected (e.g., future) cooling parameters corresponding to one(s) of the edge appliances 1702. For example, the expected cooling parameters include expected temperatures of one(s) of the edge appliances 1702 (e.g., in view of workload(s) expected to be performed by the component(s) 1814 of the edge appliances 1702 at a given time), expected temperature and/or volume of cooling fluid to be provided to the one(s) of the edge appliances 1702, expected durations for which the cooling fluid is to be provided at a given temperature, etc. In some examples, the cooling reservation information circuitry 1904 generates and/or updates the cooling reservation table based on SLAs associated with one or more tenants accessing the edge appliances 1702. In some examples, the cooling reservation information circuitry 1904 provides the cooling reservation table to the infrastructure database 1912 for storage therein.

The example infrastructure distribution circuitry 1906 controls, via the infrastructure CDU 1704, distribution of cooling fluid to and/or between the edge appliances 1702. For example, the infrastructure distribution circuitry 1906 determines the expected cooling parameters for one(s) of the edge appliances 1702 based on the cooling reservation table generated by the cooling reservation information circuitry 1904. Further, the infrastructure distribution circuitry 1906 determines, based on the measurement data obtained by the infrastructure monitoring circuitry 1902, a temperature of cooling fluid received at the infrastructure CDU 1704 and/or a current temperature of the one(s) of the edge appliances 1702. In some examples, the infrastructure distribution circuitry 1906 determines an amount of cooling fluid to be provided to the corresponding one(s) of the edge appliances 1702 that, based on the temperature of the cooling fluid and/or the current temperature of the edge appliances 1702, is likely to satisfy the expected cooling parameters (e.g., to prevent overheating of the edge devices, to maintain an operating temperature of the edge devices within a particular temperature range). In such examples, the infrastructure distribution circuitry 1906 causes the infrastructure CDU 1704 to provide the corresponding amount of cooling fluid to the one(s) of the edge appliances 1702.

The example infrastructure brokering circuitry 1908 enables brokering between the edge appliances 1702 and/or between one or more tenants operating on the edge appliances 1702 with respect to distribution of infrastructure cooling resources. For example, the infrastructure brokering circuitry 1908 determines whether actual cooling parameters (e.g., actual cooling properties such as current appliance temperature, current coolant flow rate, current coolant temperature) associated with the one(s) of the edge appliances 1702 satisfy (e.g., match) the expected cooling parameters thereof. In some examples, the infrastructure brokering circuitry 1908 determines the actual cooling parameters based on measurement data corresponding to the one(s) of the edge appliances 1702. For example, the infrastructure brokering circuitry 1908 determines, based on the measurement data, an actual temperature of the one(s) of the edge appliances 1702 and/or an actual temperature of cooling fluid provided to the one(s) of the edge appliances 1702.

In some examples, the infrastructure brokering circuitry 1908 determines whether to redistribute cooling fluid between the edge appliances 1702 based on a comparison of the actual cooling parameters and the corresponding expected cooling parameters. For example, the infrastructure brokering circuitry 1908 can compare the actual temperatures of the edge appliances 1702 (e.g., based on temperature(s) of component(s) thereof such as current operating temperature(s) of the CPU(s) 1816, the GPU(s) 1818, etc.) to the corresponding expected temperatures from the expected cooling parameters. In some examples, when the actual temperature is greater than the corresponding expected temperature for one(s) of the edge appliances 1702, the infrastructure brokering circuitry 1908 determines that additional cooling fluid is to be provided to the one(s) of the edge appliances 1702. Conversely, when the actual temperature is less than the corresponding expected temperature for the one(s) of the edge appliances 1702, the infrastructure brokering circuitry 1908 determines that less cooling fluid can be provided to the one(s) of the edge appliances 1702. In some examples, when the actual temperature is substantially the same as the corresponding expected temperature for the one(s) of the edge appliances 1702, the infrastructure brokering circuitry 1908 determines that an amount of cooling fluid to the one(s) of the edge appliances 1702 can be maintained.

In some examples, the infrastructure brokering circuitry 1908 causes the infrastructure CDU 1704 to redistribute the cooling fluid between the edge appliances 1702. For example, the infrastructure brokering circuitry 1908 performs a load balancing calculation for the edge appliances 1702 to determine an amount of cooling fluid to be directed to and/or redirected from one(s) of the edge appliances 1702, where the load balancing calculation is based on availability of cooling fluid at the edge appliances 1702, an amount of additional cooling fluid requested at one(s) of the edge appliances 1702 (e.g., in view of current or expected workload(s), SLA parameters), and/or a cost of the cooling fluid. In some such examples, the infrastructure brokering circuitry 1908 determines the amount of the cooling fluid to be redirected based on a temperature of the cooling fluid and/or a difference between actual and expected temperatures for the one(s) of the edge appliances 1702.

In some examples, the infrastructure brokering circuitry 1908 determines costs of the cooling fluid based on the SLAs of one or more tenants operating on corresponding ones of the edge appliances 1702. For example, the SLAs can indicate prices at which cooling fluid can be bought and/or sold for particular ones of the edge appliances 1702. In some examples, the infrastructure brokering circuitry 1908 estimates the prices based on a number of processor cores implemented at the edge appliances 1702, an expected workload of the processor cores, a cooling efficiency of the processor cores, etc.

The example metering and billing circuitry 1910 generates billing information based on the cooling fluid provided to and/or transferred between the edge appliances 1702. In some examples, the metering and billing circuitry 1910 determines, based on measurement data obtained by the infrastructure monitoring circuitry 1902, the amount (e.g., volume) of cooling fluid provided to corresponding one(s) of the edge appliances 1702 and/or a temperature of the cooling fluid. In some such examples, the metering and billing circuitry 1910 calculates a cost (e.g., a price) associated with the cooling fluid based on the amount and/or the temperature. In some examples, the metering and billing circuitry 1910 provides (e.g., sends) the billing information to corresponding ones of the tenants operating on the edge appliances 1702 and/or causes storage of the billing information in the infrastructure database 1912.

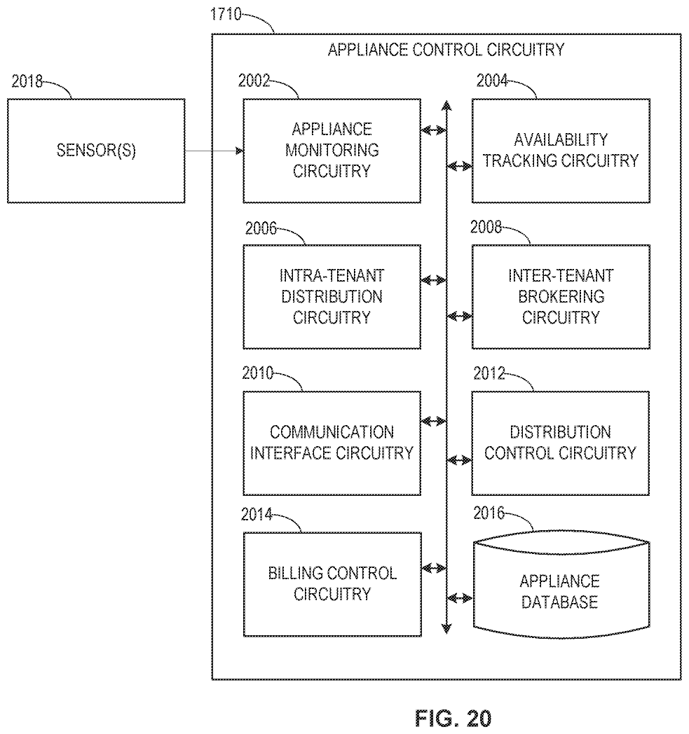

FIG. 20 is a block diagram of the example appliance control circuitry 1710 of FIG. 17. The appliance control circuitry 1710 of FIG. 20 may be instantiated (e.g., creating an instance of, bring into being for any length of time, materialize, implement, etc.) by processor circuitry such as a central processing unit executing instructions. Additionally or alternatively, the appliance control circuitry 1710 of FIG. 20 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 20 may, thus, be instantiated at the same or different times. Some or all of the circuitry may be instantiated, for example, in one or more threads executing concurrently on hardware and/or in series on hardware. Moreover, in some examples, some or all of the circuitry of FIG. 20 may be implemented by microprocessor circuitry executing instructions to implement one or more virtual machines and/or containers.

In the illustrated example of FIG. 20, the appliance control circuitry 1710 includes example appliance monitoring circuitry 2002, example availability tracking circuitry 2004, example intra-tenant distribution circuitry 2006, example inter-tenant brokering circuitry 2008, example communication interface circuitry 2010, example distribution control circuitry 2012, example billing control circuitry 2014, and an example appliance database 2016.

The example appliance database 2016 stores data utilized and/or obtained by the appliance control circuitry 1710. The example appliance database 2016 of FIG. 20 is implemented by any memory, storage device and/or storage disc for storing data such as, for example, flash memory, magnetic media, optical media, solid state memory, hard drive(s), thumb drive(s), etc. Furthermore, the data stored in the example appliance database 2016 may be in any data format such as, for example, binary data, comma delimited data, tab delimited data, structured query language (SQL) structures, etc. While, in the illustrated example, the example appliance database 2016 is illustrated as a single device, the example appliance database 2016 and/or any other data storage devices described herein may be implemented by any number and/or type(s) of memories.

The example intra-tenant distribution circuitry 2006 implements tenant-level cooling distribution policies across one or more components (e.g., one or more of the tanks 1804, one or more of the partitions 1806, one or more of the chassis 1812, and/or one or more of the electronic devices 1814 of FIG. 18) corresponding to a particular tenant of the edge appliance 1702 and/or the edge environment 1700 of FIG. 17. For example, the intra-tenant distribution circuitry 2006 determines, for a particular tenant, a distribution of cooling fluid across the component(s) operated and/or accessed by the particular tenant. In some examples, a tenant can purchase and/or access cooling fluid from the infrastructure CDU 1704 of FIG. 17 for use in cooling the component(s). In some examples, an SLA of the tenant indicates an amount of cooling fluid, a temperature of the cooling fluid, and/or a duration for which the infrastructure CDU 1704 is to provide cooling fluid to the tenant. Additionally or alternatively, the SLA can indicate a price (e.g., a total price and/or a price per volume) at which the tenant agrees to purchase the cooling fluid, and the infrastructure CDU 1704 provides an amount of the cooling fluid at a given temperature and/or for a given duration based on the price.

In some examples, the intra-tenant distribution circuitry 2006 determines actual (e.g., current) cooling resources available to the tenant based on measurement data from one or more example sensors 2018 implemented at the edge appliance 1702. For example, the measurement data can indicate an actual amount and/or an actual temperature of the cooling fluid provided to the tenant at the edge appliance 1702 (e.g., substantially real-time temperature of the cooling fluid). In some examples, the intra-tenant distribution circuitry 2006 determines how the available cooling fluid is to be distributed among the component(s) corresponding to the particular tenant. For example, the intra-tenant distribution circuitry 2006 determines amounts of the available cooling fluid to be provided to corresponding one(s) of the components, and/or determines durations for which the cooling fluid is to be provided to the corresponding one(s) of the components. In some examples, the intra-tenant distribution circuitry 2006 determines the amounts and/or durations based on expected cooling parameters corresponding to each of the component(s), where the expected cooling parameters may be included in the SLA of the tenant. In some examples, the expected cooling parameters include expected temperatures of the component(s), an expected volume and/or temperature of cooling fluid to be provided to the component(s), and/or expected durations for which the cooling fluid is to be provided to the component(s).

In some examples, the intra-tenant distribution circuitry 2006 allocates cooling resources based on priority levels of the component(s), where the priority levels are included in the SLA, for example, and can be based on, for instance, amount heat generated by the component, task assigned to the component, etc. In some examples, when first one(s) of the components (e.g., CPUs) have a higher priority level compared to second one(s) of the components (e.g., memory), the intra-tenant distribution circuitry 2006 allocates a greater amount and/or duration of cooling fluid to the first one(s) of the component(s) compared to the second one(s) of the components. In some examples, the intra-tenant distribution circuitry 2006 allocates the cooling fluid such that first expected cooling parameters of the first one(s) of the components are satisfied prior to satisfaction of second expected cooling parameters of the second one(s) of the components. In some examples, the priority levels are based on a number of processor cores implemented at the component(s), cooling efficiency of the component(s), ambient temperature of the component(s), expected workloads of the component(s), etc.

The example distribution control circuitry 2012 generates instructions to control distribution of cooling fluid to and/or between component(s) of the edge appliance 1702. For example, the distribution control circuitry 2012 is in communication with at least one CDU (e.g., the appliance CDU 1802, the tank CDU(s) 1808, the partition CDU(s) 1810, and/or the chassis CDU(s) 1820 of the edge appliance 1702) to control distribution of the cooling fluid to and/or between the component(s). For example, the distribution control circuitry 2012 controls distribution of the cooling fluid between components of a same tenant based on intra-tenant distributions determined by the intra-tenant distribution circuitry 2006. Additionally or alternatively, the distribution control circuitry 2012 controls distribution of cooling fluid between components of different tenants based on inter-tenant distributions determined by the inter-tenant brokering circuitry 2008. In some examples, the distribution control circuitry 2012 can cause at least one of the CDUs 1802, 1808, 1810, 1820 to adjust a flow rate and/or a temperature of the cooling fluid prior to and/or during provision of the cooling fluid to the component(s).

The example appliance monitoring circuitry 2002 obtains measurement data associated with one or more components of the edge appliance 1702 of FIG. 18. For example, the appliance monitoring circuitry 2002 is communicatively coupled to the one or more example sensors 2018 included in the edge appliance 1702 to obtain the measurement data therefrom. In some examples, the sensors 2018 include one or more temperature sensors to measure a temperature of the component(s), a temperature of cooling fluid provided to the component(s), and/or an ambient temperature of the edge appliance 1702. In some examples, the sensors 2018 include at least one flow rate sensor to measure a flow rate of cooling fluid to and/or from the component(s). In some examples, the appliance monitoring circuitry 2002 provides the measurement data to the intra-tenant distribution circuitry 2006 and/or the inter-tenant brokering circuitry 2008 for use in selecting a distribution of the cooling fluid between the components. In some examples, the appliance monitoring circuitry 2002 provides the measurement data from the one or more sensors 2018 to the appliance database 2016 for storage therein.

In some examples, a change in conditions (e.g., a change in ambient temperature, a change in temperature of the cooling fluid received at the infrastructure CDU 1704, a change in workload performed by the one or more components, etc.) may cause the actual (e.g., current, substantially real-time) cooling parameters of the component(s) to vary from the expected cooling parameters of the component(s). For example, when the ambient temperature of the edge environment 1700 of FIG. 17 increases, a current amount and/or temperature of cooling fluid provided to the component(s) may be insufficient to satisfy the expected cooling parameters thereof, such that additional cooling resources may be needed to cool or would facilitate cooling of the component(s). Conversely, when the ambient temperature decreases, fewer cooling resources are utilized to satisfy the expected cooling parameters, such that excess cooling resources are available and/or may be redirected to other components.

In some examples, the example availability tracking circuitry 2004 determines cooling availability information corresponding to the edge appliance 1702 and/or to one or more components of the edge appliance 1702. In particular, the cooling availability information indicates, for corresponding one(s) of the components, whether excess cooling resources are available and/or whether additional cooling resources are expected and/or should be provided. In some examples, the cooling availability information indicates, for corresponding one(s) of the components, an amount (e.g., a volume) of available cooling fluid that can be redirected to other components, a temperature of the available cooling fluid, and/or a duration for which the cooling fluid can be redirected. Additionally or alternatively, the cooling availability information indicates, for the corresponding one(s) of the components, an amount (e.g., a volume) of additional cooling to be provided to the component(s), a temperature of the additional cooling fluid to be provided, and/or a duration for which the additional cooling fluid is to be provided to satisfy the expected cooling parameters. In some examples, the availability tracking circuitry 2004 provides the cooling availability information to the appliance database 2016 for storage therein.

In some examples, the availability tracking circuitry 2004 determines the cooling availability information based on a comparison of the actual cooling parameters to the expected cooling parameters of the one or more components. For example, to determine the expected cooling parameters, the availability tracking circuitry 2004 identifies the one or more tenants operating on the edge appliance 1702 and/or the component(s). Further, the availability tracking circuitry 2004 obtains the SLAs corresponding to the one or more tenants, where the SLAs can be stored in the appliance database 2016, for example. In some examples, the availability tracking circuitry 2004 determines the expected cooling parameters for corresponding one(s) the components based on the SLAs of the tenant(s) associated with the component(s). For example, the expected cooling parameters can include expected temperatures of the component(s), expected volume and/or expected temperature of cooling fluid provided to the component(s), and/or expected durations for which the cooling fluid is provided to the component(s).

In some examples, the availability tracking circuitry 2004 determines the actual cooling parameters for the one or more components based on the measurement data obtained by the appliance monitoring circuitry 2002. For example, the availability tracking circuitry 2004 determines the actual (e.g., substantially real-time) cooling parameters including actual temperatures of the component(s), actual volume and/or actual temperature of cooling fluid provided to the component(s), and/or actual durations for which the cooling fluid is provided to the component(s).

In some examples, the availability tracking circuitry 2004 compares the expected cooling parameters to the actual cooling parameters to determine the cooling availability information for the component(s). For example, the availability tracking circuitry 2004 determines whether excess cooling capability is available and/or whether additional cooling capability is expected and/or should be provided for the component(s) based on the comparison. In some examples, the availability tracking circuitry 2004 calculates a difference between the actual and expected temperatures of the component(s), a difference between the actual and expected temperatures of cooling fluid to the component(s), and/or a difference between the actual and expected durations of cooling for the component(s). In some examples, the availability tracking circuitry 2004 determines whether the expected cooling parameters are satisfied by comparing the difference(s) to one or more thresholds (e.g., user-defined thresholds). For example, when the difference(s) satisfy (e.g., are less than or equal to) the corresponding threshold(s), the availability tracking circuitry 2004 determines that an amount and/or a temperature of cooling fluid to the component(s) is to be maintained.

Conversely, when the difference(s) do not satisfy (e.g., are greater than) the corresponding threshold(s), the availability tracking circuitry 2004 determines that excess cooling resources are available and/or additional cooling resources are expected and/or should be provided for the component(s). For example, when the actual temperature of the component(s) is greater (e.g., by a threshold amount) than the expected temperature of the component(s), the availability tracking circuitry 2004 determines that additional cooling resources are expected, needed, or otherwise would facilitate cooling of the component(s). Additionally or alternatively, the availability tracking circuitry 2004 determines that additional cooling resources are expected, needed, or otherwise would facilitate cooling when the actual temperature of cooling fluid to the component(s) is greater (e.g., by a threshold amount) than the expected temperature of the cooling fluid, an actual amount (e.g., volume, flow rate) of the cooling fluid is less than the expected amount of cooling fluid, and/or an actual duration of cooling is less than the expected duration of cooling for the component(s).

In some examples, when the actual temperature is less than the expected temperature (e.g., by a threshold amount), the availability tracking circuitry 2004 determines that excess cooling resources are available for the component(s). Additionally or alternatively, the availability tracking circuitry 2004 determines that excess cooling resources are available when, for example, the actual temperature of cooling fluid to the component(s) is less than (e.g., by a threshold amount) the expected temperature of the cooling fluid, an actual amount (e.g., volume, flow rate) of the cooling fluid is greater than the expected amount of cooling fluid, and/or an actual duration of cooling is greater than the expected duration of cooling for the component(s).

The example communication interface circuitry 2010 generates, provides, accesses, and/or otherwise facilitates communications (e.g., network communications) between components and/or tenants of the edge appliance 1702 and/or the edge environment 1700 of FIG. 17. For example, the communication interface circuitry 2010 identifies, based on the cooling availability information, one(s) of the components for which additional cooling capability is expected, needed, or otherwise would facilitate performance and/or cooling, and generates cooling requests corresponding to the one(s) of the components. In some examples, the cooling requests indicate an amount of additional cooling fluid, a temperature of the additional cooling fluid, and/or a duration for which the additional cooling fluid is expected and/or should be provided for the one(s) of the components (e.g., to cool the components within a threshold range). In some such examples, the communication interface circuitry 2010 determines, based on SLAs of the tenant(s) associated with the component(s), a cooling budget corresponding to one(s) of the tenants and/or the component(s). For example, the cooling budget indicates threshold price(s) (e.g., a maximum price and/or a range of prices) for which the tenant(s) are willing to pay for additional cooling fluid. In some examples, the threshold price(s) correspond to a total (e.g., aggregate) price of the additional cooling fluid, a price per volume of the cooling fluid, a price per duration for which the cooling fluid is provided, etc. In some examples, the communication interface circuitry 2010 updates the cooling request(s) to include the cooling budget(s) for the associated tenant(s) and/or component(s).

In some examples, the communication interface circuitry 2010 generates, provides, and/or accesses availability notifications for one(s) of the components. For example, the communication interface circuitry 2010 identifies, based on the cooling availability information, one(s) of the components for which excess cooling capability is available, and generates the availability notifications corresponding to the one(s) of the components. In some examples, the availability notifications indicate an amount of available cooling fluid at the component(s), a temperature of the available cooling fluid, and/or a duration for which the cooling fluid is available for redistribution to the other components. In some such examples, the communication interface circuitry 2010 determines, based on the SLAs of the tenant(s) associated with the component(s), threshold price(s) (e.g., a minimum price and/or a range of prices) for which the tenant(s) are willing to sell the available cooling fluid. In some examples, the communication interface circuitry 2010 updates the availability notification(s) to include the threshold price(s) for the associated tenant(s) and/or component(s).

In some examples, the communication interface circuitry 2010 provides (e.g., sends, transmits) the cooling request(s) and/or the availability notification(s) to one(s) of the tenants and/or the associated component(s). In some examples, the communication interface circuitry 2010 provides the cooling request(s) and/or the availability notification(s) periodically and/or in response to an event. For example, the communication interface circuitry 2010 can send the availability notification(s) in response to receiving one or more cooling requests from the tenant(s) and/or the component(s). Conversely, in some examples, the communication interface circuitry 2010 sends the cooling request(s) in response to receiving one or more of the availability notifications from the tenant(s) and/or the component(s). In some examples, the communication interface circuitry 2010 sends the cooling request(s) and/or the availability notification(s) between components of one of the edge appliances 1702 and/or between different ones of the edge appliances 1702 of FIG. 17.

The example inter-tenant brokering circuitry 2008 performs brokering of cooling fluid between tenants operating on the edge appliance 1702 and/or in the edge environment 1700 of FIG. 17. For example, the inter-tenant brokering circuitry 2008 determines whether and/or how cooling fluid is to be re-distributed between components of different tenants to satisfy the expected cooling parameters thereof. In some examples, the intra-tenant distribution circuitry 2006 performs the brokering based on a balancing of the cooling request(s) and/or availability notification(s) generated and/or obtained by the communication interface circuitry 2010.

In one example, the inter-tenant brokering circuitry 2008 determines, based on receipt and/or generation of a cooling request by the communication interface circuitry 2010, that a first component corresponding to a first tenant of the edge appliance 1702 expects and/or needs additional cooling resources (e.g., to cool the first component within a particular temperature range, to meet an SLA parameter). In some examples, based on the cooling request, the inter-tenant brokering circuitry 2008 determines an amount of additional cooling fluid, a temperature of the additional cooling fluid, and/or a duration for which the additional cooling fluid is expected for the first component. Additionally or alternatively, the inter-tenant brokering circuitry 2008 determines, based on the cooling request, a price at which the first tenant is willing to purchase cooling fluid for the first component.

In some examples, the inter-tenant brokering circuitry 2008 obtains, from the communication interface circuitry 2010, one or more cooling availability notifications corresponding to one or more second components of the edge environment 1700, where the one or more second components correspond to one or more second tenants. In some examples, the second tenants can be considered partner tenants (e.g., tenants who have agreed to negotiate or share cooling resources with the first tenant). In some examples, the inter-tenant brokering circuitry 2008 determines availability of cooling resources (e.g., an amount of available cooling fluid, a temperature and/or duration of the available cooling fluid, etc.) from the second component(s). Further, the inter-tenant brokering circuitry 2008 determines, based on the cooling availability notification(s), a cost at which the second tenant(s) are willing to sell the available cooling fluid.

In some examples, the inter-tenant brokering circuitry 2008 selects one or more of the second component(s) from which the first component is to request and/or obtain additional cooling fluid. For example, the inter-tenant brokering circuitry 2008 selects the one(s) of the second components based on a balancing of the additional cooling resources to be provided to (e.g., expected, needed by, would be beneficial for) the first component, the cost of the cooling fluid from the second components, and/or availability of the cooling fluid from the second components. In some examples, the inter-tenant brokering circuitry 2008 causes the communication interface circuitry 2010 to generate and/or send cooling request(s) to the second tenant(s) associated with the selected second component(s) to request the cooling fluid therefrom. In such examples, the cooling request(s) indicate an amount of cooling fluid requested from the corresponding one(s) of the second components, a temperature of the requested cooling fluid, and/or a duration for which the cooling fluid is requested. In some examples, the inter-tenant brokering circuitry 2008 directs the distribution control circuitry 2012 to redistribute the requested cooling fluid from the one(s) of the second components to the first component.

In another example, the inter-tenant brokering circuitry 2008 determines, based on receipt and/or generation of a cooling availability notification by the communication interface circuitry 2010, that excess cooling resources are available at the first component. In some examples, based on the cooling availability notification, the inter-tenant brokering circuitry 2008 determines an amount of available cooling fluid, a temperature of the available cooling fluid, a duration for which the cooling fluid is available, and/or a price at which the first tenant is willing to sell the cooling fluid.

In some examples, when the communication interface circuitry 2010 receives one or more cooling requests corresponding to one or more of the second components, the inter-tenant brokering circuitry 2008 determines whether the available cooling fluid from the first component is to be redirected to the one(s) of the second components. In some such examples, the inter-tenant brokering circuitry 2008 selects an amount of cooling fluid to be redirected from the first component to the corresponding one(s) of the second components and/or a duration for which the cooling fluid is to be redirected based on the cooling request(s), the availability of cooling fluid for the first component, and/or the price associated with the available cooling fluid. In some examples, the inter-tenant brokering circuitry 2008 directs the distribution control circuitry 2012 to redistribute the available cooling fluid from the first component to the one(s) of the second components.

The example billing control circuitry 2014 generates billing information for one or more tenants operating on the edge appliance 1702. In some examples, the billing control circuitry 2014 generates, for corresponding one(s) of the tenants, the billing information based on an amount of cooling fluid provided to one or more components of the corresponding tenant(s), a temperature of the cooling fluid, a duration for which the cooling fluid is provided, and/or a price (e.g., price per volume, price per duration, etc.) associated with the cooling fluid. In some examples, the billing control circuitry 2014 provides the billing information to the corresponding tenant(s) and/or causes storage of the billing information in the appliance database 2016.

As disclosed in connection with FIG. 18, the appliance control circuitry 1710 can be implemented at one or more of the appliance CDU 1802, tank CDUs 1808, one or more of the partition CDUs 1810, and/or one or more of the chassis CDUs 1820 of FIG. 18 to control the distribution of cooling fluid to and/or between the components of the edge appliance 1702. In some examples, different instances of the appliance control circuitry 1710 can be implemented at ones of the edge appliances 1702A, 1702B of the edge environment 1700 of FIG. 17 to control the distribution of cooling fluid within and/or between the edge appliances 1702A, 1702B. In some examples, the different instances of the appliance control circuitry 1710 can be communicatively coupled to allow sending of information (e.g., measurement data, cooling requests, cooling availability notifications, billing information, etc.) therebetween.

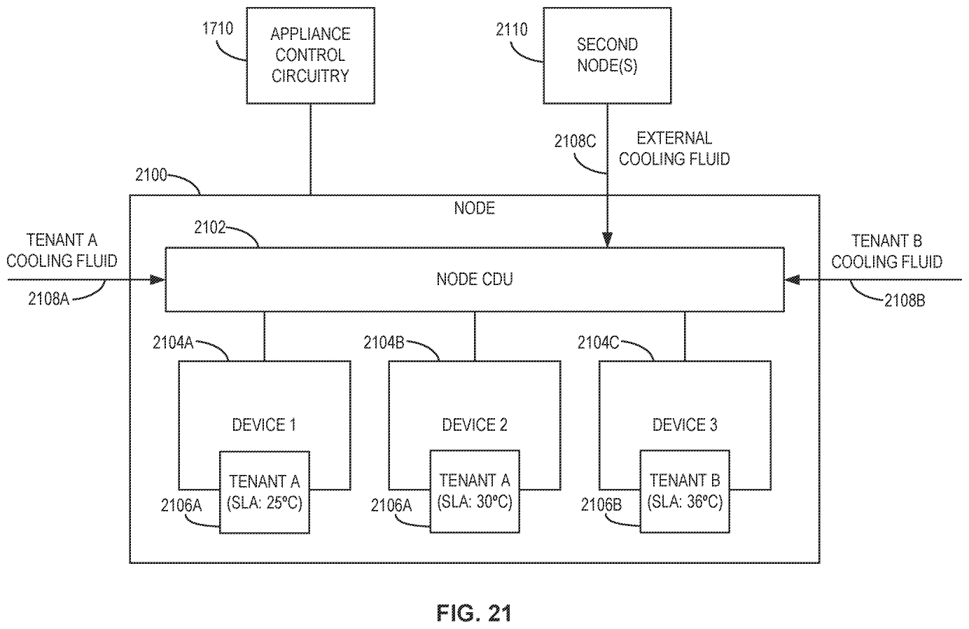

FIG. 21 illustrates an example node (e.g., an edge node, and edge location) 2100 for which intra-tenant and/or inter-tenant brokering of cooling fluid can be performed. In the illustrated example of FIG. 21, the node 2100 includes an example node CDU 2102 fluidly and/or operatively coupled to example devices 2104 (e.g., including a first example device 2104A, a second example device 2104B, and a third example device 2104C) to distribute cooling fluid therebetween. In this example, a first example tenant 2106A operates and/or accesses the first and second devices 2104A, 2104B, and a second example tenant 2106B operates and/or accesses the third device 2104C. In some examples, a different number of the tenants 2106 and/or devices 2104 may be implemented at the node 2100 instead. In the illustrated example of FIG. 21, the node 2100 corresponds to the edge appliance 1702, the node CDU 2102 corresponds to the appliance CDU 1802, and the devices 2104 correspond to one or more of the tanks 1804, the partitions 1806, the chassis 1812, and/or the electronic devices 1814 (e.g., the CPU 1816, the GPU 1818, etc.) of FIG. 18. In some examples, the node 2100 can correspond to any of the edge appliances 1702 of FIG. 17 and/or any of the tanks 1804, the partitions 1806, and/or the chassis 1812 of FIG. 18, and the node CDU 2102 can correspond to any of the appliance CDU 1802, the tank CDU(s) 1808, the partition CDU(s) 1810, and/or the chassis CDU(s) 1820 of FIG. 18.

In the illustrated example of FIG. 21, the node CDU 2102 implements the example appliance control circuitry 1710 of FIG. 20 to control the distribution of cooling fluid between ones of the devices 2104. In some examples, the intra-tenant distribution circuitry 2006 of FIG. 20 determines expected cooling parameters for the corresponding devices 2104 based on SLAs of the tenants 2106. In this example, the intra-tenant distribution circuitry 2006 determines, based on a first SLA of the first tenant 2106A, that the first device 2104A is to be cooled to and/or maintained at a first expected temperature (e.g., 25° C.) and the second device 2104B is to be cooled to and/or maintained at a second expected temperature (e.g., 30° C.). Further, the intra-tenant distribution circuitry 2006 determines, based on a second SLA of the second tenant 2106B, that the third device 2104C is to be cooled to and/or maintained at a third expected temperature (e.g., 36° C.).

In some examples, the node CDU 2102 receives and/or obtains cooling fluid purchased by the first and second tenants 2106A, 2106B from the edge environment 1700 of FIG. 17. In this example, the node CDU 2102 receives first example cooling fluid 2108A corresponding to the first tenant 2106A, and receives second example cooling fluid 2108B corresponding to the second tenant 2106B. In some examples, the first cooling fluid 2108A has a first temperature and a first total volume, and the second cooling fluid 2108B has a second temperature and a second total volume. In some examples, the intra-tenant distribution circuitry 2006 determines, based on the expected temperatures of the first and second devices 2104A, 2104B, whether and/or how the first cooling fluid 2108A is to be distributed between the first and second devices 2104A, 2104B. For example, the intra-tenant distribution circuitry 2006 determines that a first amount of the first cooling fluid 2108A is to be provided to the first device 2104A for a first duration, and a second amount of the first cooling fluid 2108A is to be provided to the first device 2104 for a second duration. Further, the intra-tenant distribution circuitry 2006 determines, based on the expected temperature of the third device 2104C, whether and/or how the second cooling fluid 2108B is to be distributed to the third device 2104C. For example, the intra-tenant distribution circuitry 2006 determines that a third amount of the second cooling fluid 2108B is to be provided to the third device 2104C for a third duration. In some examples, the example distribution control circuitry 2012 directs the node CDU 2102 to distribute the respective amounts of the first and second cooling fluid 2108A, 2108B to the devices 2104.

In some examples, the example appliance monitoring circuitry 2002 determines whether the expected cooling parameters of the devices 2104 are satisfied. For example, the appliance monitoring circuitry 2002 measures actual temperatures of the devices 2104. In some examples, the example availability tracking circuitry 2004 of FIG. 20 determines, based on a comparison of the actual and expected temperatures, cooling availability information for corresponding ones of the devices 2104. For example, when the availability tracking circuitry 2004 of FIG. 20 determines that a first actual temperature of the first device 2104A is greater than the first expected temperature of the first device 2104A (e.g., 30° C. compared to 25° C.), the availability tracking circuitry 2004 determines that additional cooling fluid is expected, needed, and/or would otherwise facilitate cooling of the first device 2104A. In some examples, when the availability tracking circuitry 2004 determines that a second actual temperature of the second device 2104B is at or below the second expected temperature (e.g., 28° C. compared to 30° C.), the availability tracking circuitry 2004 determines that some of the first cooling fluid 2108A allocated to the second device 2104B can be redirected to the first device 2104A. In some examples, the intra-tenant distribution circuitry 2006 determines the amount of the first cooling fluid 2108A to be redirected based on a first difference between the actual and expected temperatures of the first device 2104A and a second difference between the actual and expected temperatures of the second device 2104B.

Alternatively, in some examples, the availability tracking circuitry 2004 determines that the second actual temperature of the second device 2104B is greater than the second expected temperature (e.g., 32° C. compared to 30° C.). In such examples, the availability tracking circuitry 2004 determines that a first amount of additional cooling fluid is to be provided to cool the first device 2104A and/or a second amount of additional cooling fluid is to be provided to cool the second device 2104B. In some examples, when the first cooling fluid 2108A of the first tenant 2106A does not satisfy the expected cooling parameters of the first and second devices 2104A, 2104B, the example inter-tenant brokering circuitry 2008 of FIG. 20 allows brokering of cooling fluid between the first and second tenants 2106A, 2106B.

For example, the availability tracking circuitry 2004 may determine that some of the second cooling fluid 2108B of the second tenant 2106B is available for redistribution and/or brokering when a third actual temperature of the third device 2104C is at or below the third expected temperature of the third device 2104C. In some examples, the communication interface circuitry 2010 generates and/or obtains a cooling availability notification corresponding to the third device 2104C and/or the second tenant 2106B, where the cooling availability notification indicates an amount of the second cooling fluid 2108B available for redistribution, a temperature of the available second cooling fluid 2108B, a cost of the available second cooling fluid 2108B, and/or duration for which the second cooling fluid 2108B is available. In some examples, the communication interface circuitry 2010 generates and/or obtains cooling requests corresponding to the first and second devices 2104A, 2104B indicating the amount of additional cooling fluid requested for the first and second devices 2104A, 2104B. In some examples, based on the cooling availability notification and the cooling requests, the inter-tenant brokering circuitry 2008 selects an amount of the available second cooling fluid 2108B to be purchased by the first tenant 2106A and provided to the corresponding first and second devices 2104A, 2104B. In such examples, the example distribution control circuitry 2012 causes the node CDU 2102 to redistribute respective amounts of the available second cooling fluid 2108B to the first and second devices 2104A, 2104B.

In some examples, the actual temperatures of the devices 2104 can vary as a result of changing conditions (e.g., an increase in ambient temperature, an increase in workload at one(s) of the devices 2104) at the node 2100. In some such examples, the first and second cooling fluid 2108A, 2108B may not satisfy the expected cooling parameters of one or more of the devices 2104. In such examples, the inter-tenant brokering circuitry 2008 can perform brokering of cooling fluid with one or more example second nodes 2110 to obtain example external cooling fluid 2108C therefrom. For example, the second node(s) 2110 can include the second edge appliance 1702B of the edge environment 1700 of FIG. 17. In some examples, the communication interface circuitry 2010 sends and/or provides one or more cooling requests to the second node(s) 2110, and receives and/or obtains one or more cooling availability notifications from the second node(s) 2110. In some such examples, the inter-tenant brokering circuitry 2008 determines, based on the cooling availability notification(s) and/or the cooling request(s), an amount of the external cooling fluid 2108C to be purchased by the first tenant 2106A and/or the second tenant 2106B to satisfy the expected cooling parameters of the corresponding device(s) 2104. In some examples, the example billing control circuitry 2014 of FIG. 20 generates billing information based on the purchase and/or exchange of cooling fluid between the tenants 2106 and/or between nodes (e.g., the node 2100 and the second node(s) 2110), and provides the billing information to respective ones of the tenants 2106.

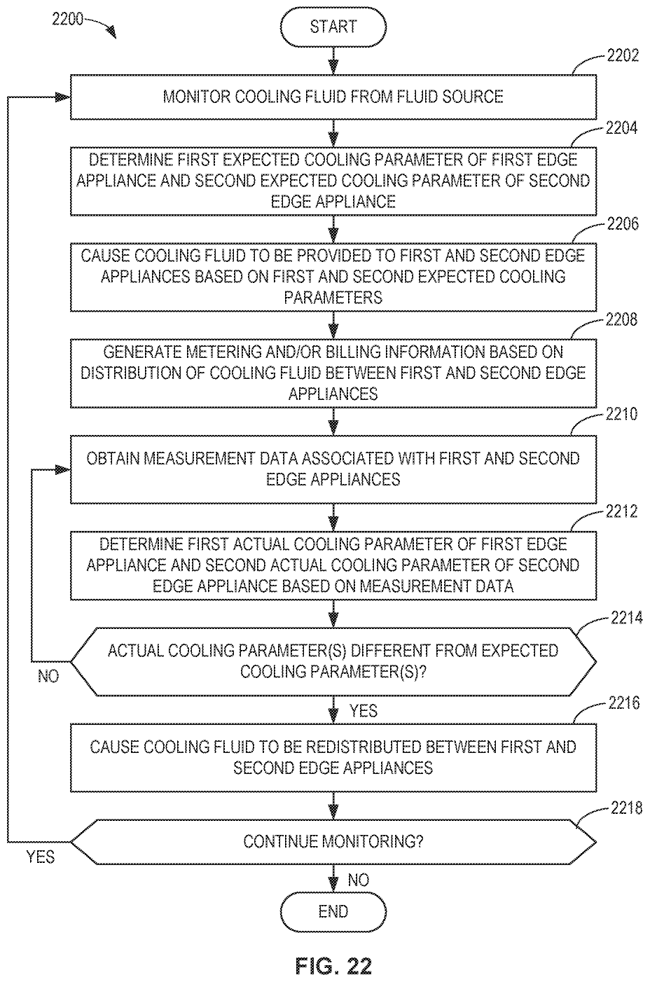

In some examples, the infrastructure monitoring circuitry 1902 is instantiated by programmable circuitry executing infrastructure monitoring circuitry instructions and/or configured to perform operations such as those represented by the flowchart of FIG. 22. In some examples, the cooling reservation information circuitry 1904 is instantiated by programmable circuitry executing cooling reservation information circuitry instructions and/or configured to perform operations such as those represented by the flowchart of FIG. 22. In some examples, the infrastructure distribution circuitry 1906 is instantiated by programmable circuitry executing infrastructure distribution circuitry instructions and/or configured to perform operations such as those represented by the flowchart of FIG. 22. In some examples, the infrastructure brokering circuitry 1908 is instantiated by programmable circuitry executing infrastructure brokering circuitry instructions and/or configured to perform operations such as those represented by the flowchart of FIG. 22. In some examples, the metering and billing circuitry 1910 is instantiated by programmable circuitry executing metering and billing circuitry instructions and/or configured to perform operations such as those represented by the flowchart of FIG. 22.

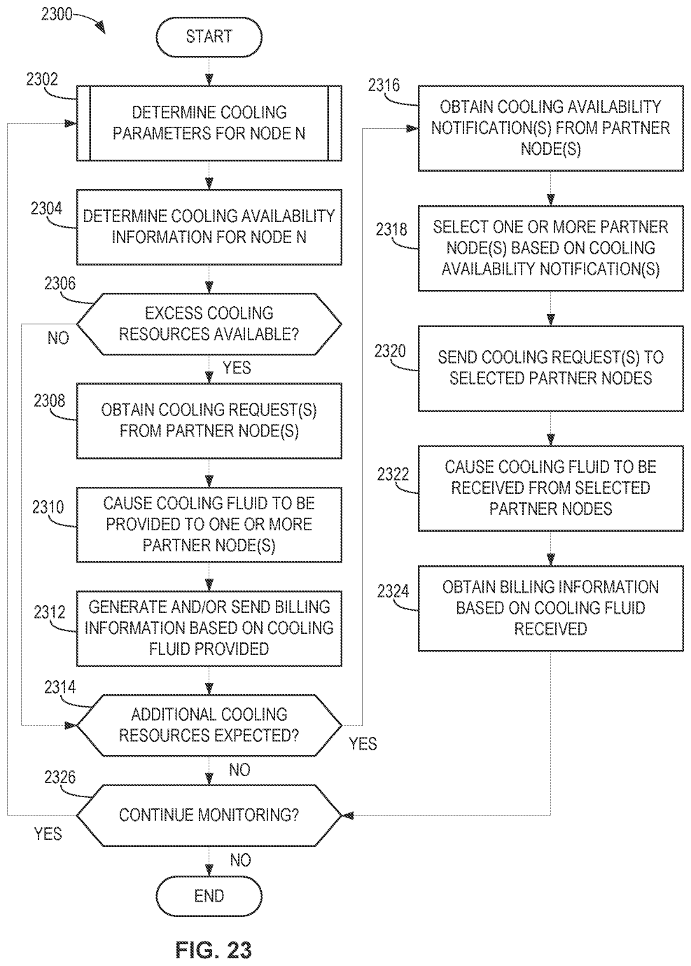

In some examples, the appliance monitoring circuitry 2002 is instantiated by programmable circuitry executing appliance monitoring circuitry instructions and/or configured to perform operations such as those represented by the flowcharts of FIGS. 23 and/or 24. In some examples, the availability tracking circuitry 2004 is instantiated by programmable circuitry executing availability tracking circuitry instructions and/or configured to perform operations such as those represented by the flowcharts of FIGS. 23 and/or 24. In some examples, the intra-tenant distribution circuitry 2006 is instantiated by programmable circuitry executing intra-tenant distribution circuitry instructions and/or configured to perform operations such as those represented by the flowcharts of FIGS. 23 and/or 24. In some examples, the inter-tenant brokering circuitry 2008 is instantiated by programmable circuitry executing inter-tenant brokering circuitry instructions and/or configured to perform operations such as those represented by the flowcharts of FIGS. 23 and/or 24. In some examples, the communication interface circuitry 2010 is instantiated by programmable circuitry executing communication interface circuitry instructions and/or configured to perform operations such as those represented by the flowcharts of FIGS. 23 and/or 24. In some examples, the distribution control circuitry 2012 is instantiated by programmable circuitry executing distribution control circuitry instructions and/or configured to perform operations such as those represented by the flowcharts of FIGS. 23 and/or 24. In some examples, the billing control circuitry 2014 is instantiated by programmable circuitry executing billing control circuitry instructions and/or configured to perform operations such as those represented by the flowcharts of FIGS. 23 and/or 24.

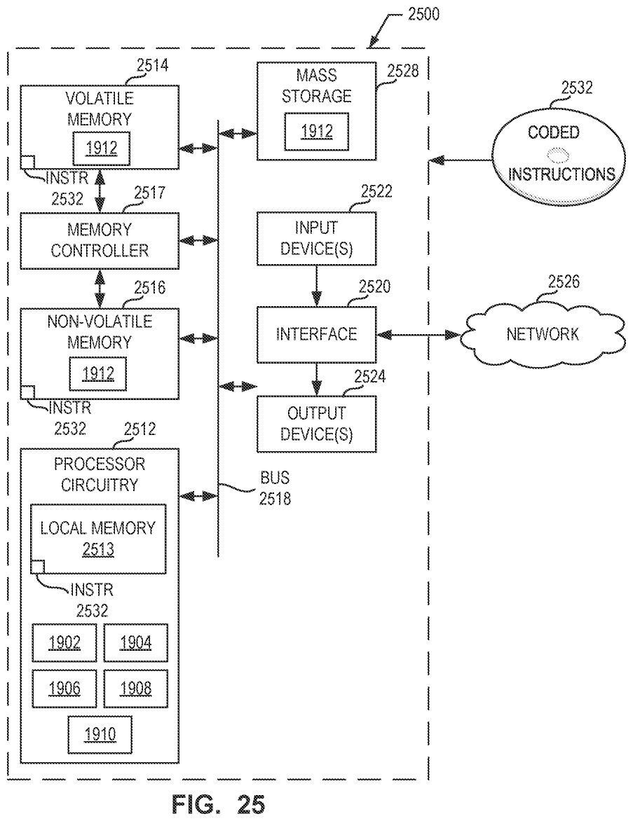

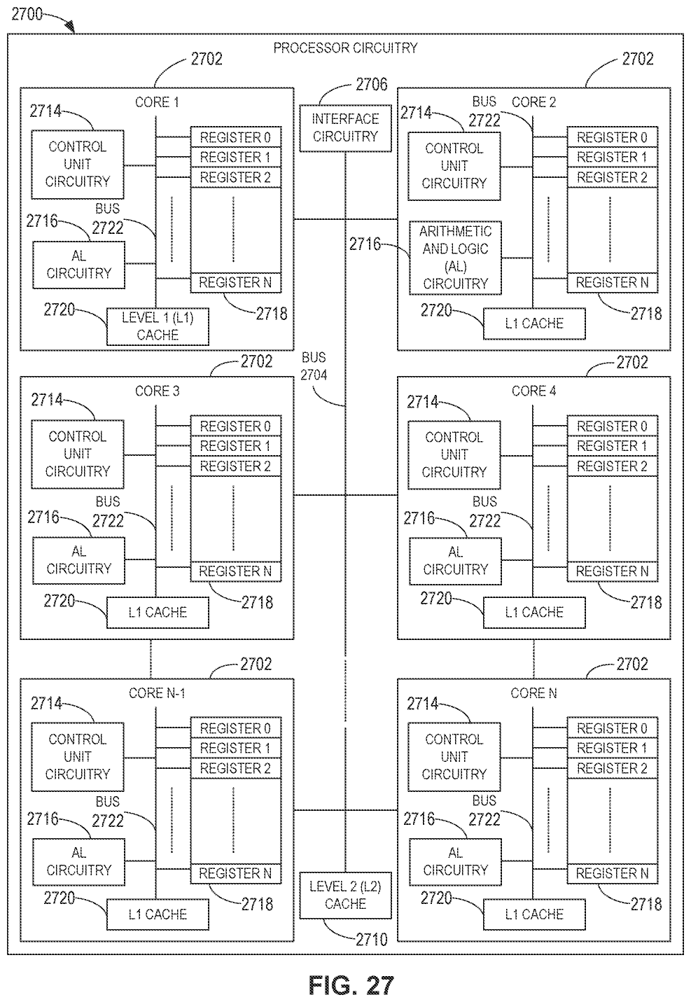

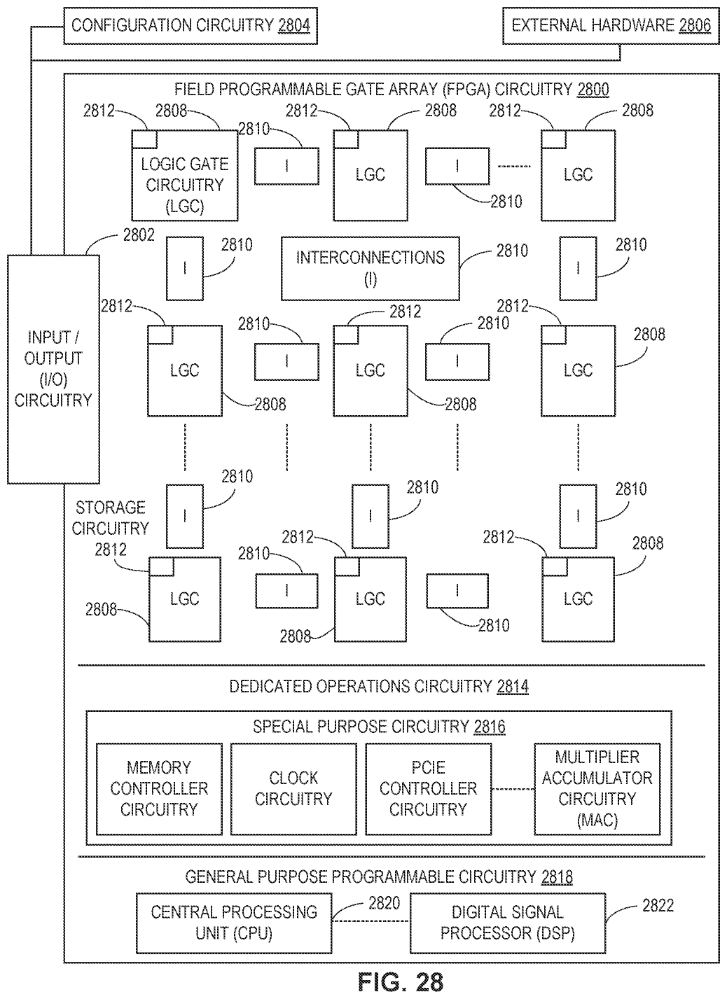

In some examples, the infrastructure control circuitry 1708 includes means for monitoring. For example, the means for monitoring may be implemented by the infrastructure monitoring circuitry 1902. In some examples, the infrastructure monitoring circuitry 1902 may be instantiated by programmable circuitry such as the example programmable circuitry 2512 of FIG. 25. For instance, the infrastructure monitoring circuitry 1902 may be instantiated by the example microprocessor 2700 of FIG. 27 executing machine executable instructions such as those implemented by at least blocks 2202, 2210, 2218 of FIG. 22. In some examples, the infrastructure monitoring circuitry 1902 may be instantiated by hardware logic circuitry, which may be implemented by an ASIC, XPU, or the FPGA circuitry 2800 of FIG. 28 structured to perform operations corresponding to the machine readable instructions. Additionally or alternatively, the infrastructure monitoring circuitry 1902 may be instantiated by any other combination of hardware, software, and/or firmware. For example, the infrastructure monitoring circuitry 1902 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the infrastructure control circuitry 1708 includes means for determining cooling reservation information. For example, the means for determining cooling reservation information may be implemented by the cooling reservation information circuitry 1904. In some examples, the cooling reservation information circuitry 1904 may be instantiated by programmable circuitry such as the example programmable circuitry 2512 of FIG. 25. For instance, the cooling reservation information circuitry 1904 may be instantiated by the example microprocessor 2700 of FIG. 27 executing machine executable instructions such as those implemented by at least block 2204 of FIG. 22. In some examples, the cooling reservation information circuitry 1904 may be instantiated by hardware logic circuitry, which may be implemented by an ASIC, XPU, or the FPGA circuitry 2800 of FIG. 28 structured to perform operations corresponding to the machine readable instructions. Additionally or alternatively, the cooling reservation information circuitry 1904 may be instantiated by any other combination of hardware, software, and/or firmware. For example, the cooling reservation information circuitry 1904 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the infrastructure control circuitry 1708 includes means for distributing cooling fluid. For example, the means for distributing cooling fluid may be implemented by the infrastructure distribution circuitry 1906. In some examples, the infrastructure distribution circuitry 1906 may be instantiated by programmable circuitry such as the example programmable circuitry 2512 of FIG. 25. For instance, infrastructure distribution circuitry 1906 may be instantiated by the example microprocessor 2700 of FIG. 27 executing machine executable instructions such as those implemented by at least block 2206 of FIG. 22. In some examples, the infrastructure distribution circuitry 1906 may be instantiated by hardware logic circuitry, which may be implemented by an ASIC, XPU, or the FPGA circuitry 2800 of FIG. 28 structured to perform operations corresponding to the machine readable instructions. Additionally or alternatively, the infrastructure distribution circuitry 1906 may be instantiated by any other combination of hardware, software, and/or firmware. For example, the infrastructure distribution circuitry 1906 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the infrastructure control circuitry 1708 includes means for brokering. For example, the means for brokering may be implemented by the infrastructure brokering circuitry 1908. In some examples, the infrastructure brokering circuitry 1908 may be instantiated by programmable circuitry such as the example programmable circuitry 2512 of FIG. 25. For instance, the infrastructure brokering circuitry 1908 may be instantiated by the example microprocessor 2700 of FIG. 27 executing machine executable instructions such as those implemented by at least blocks 2212, 2214, 2216 of FIG. 22. In some examples, the infrastructure brokering circuitry 1908 may be instantiated by hardware logic circuitry, which may be implemented by an ASIC, XPU, or the FPGA circuitry 2800 of FIG. 28 structured to perform operations corresponding to the machine readable instructions. Additionally or alternatively, the infrastructure brokering circuitry 1908 may be instantiated by any other combination of hardware, software, and/or firmware. For example, the infrastructure brokering circuitry 1908 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the infrastructure control circuitry 1708 includes means for metering. For example, the means for metering may be implemented by the metering and billing circuitry 1910. In some examples, the metering and billing circuitry 1910 may be instantiated by programmable circuitry such as the example programmable circuitry 2512 of FIG. 25. For instance, the metering and billing circuitry 1910 may be instantiated by the example microprocessor 2700 of FIG. 27 executing machine executable instructions such as those implemented by at least block 2208 of FIG. 22. In some examples, the metering and billing circuitry 1910 may be instantiated by hardware logic circuitry, which may be implemented by an ASIC, XPU, or the FPGA circuitry 2800 of FIG. 28 structured to perform operations corresponding to the machine readable instructions. Additionally or alternatively, the metering and billing circuitry 1910 may be instantiated by any other combination of hardware, software, and/or firmware. For example, the metering and billing circuitry 1910 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

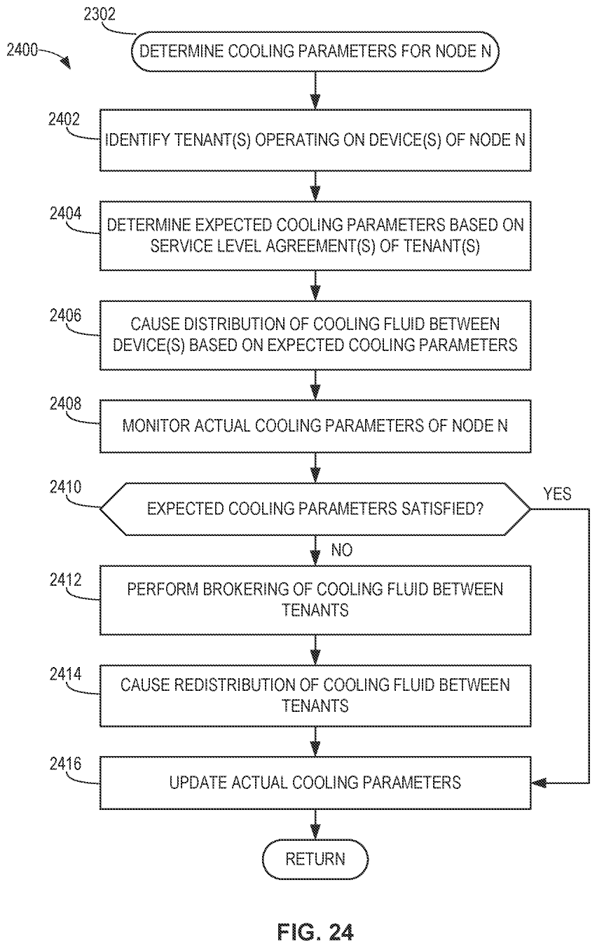

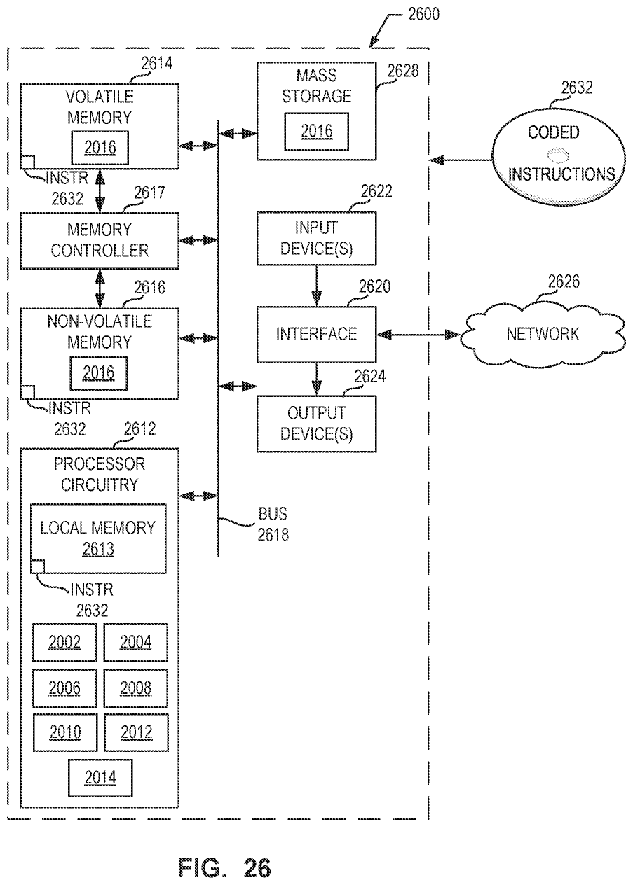

In some examples, the appliance control circuitry 1710 includes means for obtaining measurement data. For example, the means for obtaining measurement data may be implemented by the appliance monitoring circuitry 2002. In some examples, the appliance monitoring circuitry 2002 may be instantiated by programmable circuitry such as the example programmable circuitry 2612 of FIG. 26. For instance, the appliance monitoring circuitry 2002 may be instantiated by the example microprocessor 2700 of FIG. 27 executing machine executable instructions such as those implemented by at least blocks 2302, 2326 of FIG. 23 and/or block 2408 of FIG. 24. In some examples, the appliance monitoring circuitry 2002 may be instantiated by hardware logic circuitry, which may be implemented by an ASIC, XPU, or the FPGA circuitry 2800 of FIG. 28 structured to perform operations corresponding to the machine readable instructions. Additionally or alternatively, the appliance monitoring circuitry 2002 may be instantiated by any other combination of hardware, software, and/or firmware. For example, the appliance monitoring circuitry 2002 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the appliance control circuitry 1710 includes means for tracking availability. For example, the means for tracking availability may be implemented by the availability tracking circuitry 2004. In some examples, the availability tracking circuitry 2004 may be instantiated by programmable circuitry such as the example programmable circuitry 2612 of FIG. 26. For instance, the availability tracking circuitry 2004 may be instantiated by the example microprocessor 2700 of FIG. 27 executing machine executable instructions such as those implemented by at least blocks 2302, 2304, 2306, 2314 of FIG. 23 and/or blocks 2410, 2416 of FIG. 24. In some examples, the availability tracking circuitry 2004 may be instantiated by hardware logic circuitry, which may be implemented by an ASIC, XPU, or the FPGA circuitry 2800 of FIG. 28 structured to perform operations corresponding to the machine readable instructions. Additionally or alternatively, the availability tracking circuitry 2004 may be instantiated by any other combination of hardware, software, and/or firmware. For example, the availability tracking circuitry 2004 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the appliance control circuitry 1710 includes means for distributing cooling fluid of a tenant. For example, the means for distributing cooling fluid of a tenant may be implemented by the intra-tenant distribution circuitry 2006. In some examples, the intra-tenant distribution circuitry 2006 may be instantiated by programmable circuitry such as the example programmable circuitry 2612 of FIG. 26. For instance, the intra-tenant distribution circuitry 2006 may be instantiated by the example microprocessor 2700 of FIG. 27 executing machine executable instructions such as those implemented by at least block 2302 of FIG. 23 and/or blocks 2402, 2404, 2406 of FIG. 24. In some examples, the intra-tenant distribution circuitry 2006 may be instantiated by hardware logic circuitry, which may be implemented by an ASIC, XPU, or the FPGA circuitry 2800 of FIG. 28 structured to perform operations corresponding to the machine readable instructions. Additionally or alternatively, the intra-tenant distribution circuitry 2006 may be instantiated by any other combination of hardware, software, and/or firmware. For example, the intra-tenant distribution circuitry 2006 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the appliance control circuitry 1710 includes means for brokering between tenants. For example, the means for brokering between tenants may be implemented by the inter-tenant brokering circuitry 2008. In some examples, the inter-tenant brokering circuitry 2008 may be instantiated by programmable circuitry such as the example programmable circuitry 2612 of FIG. 26. For instance, the inter-tenant brokering circuitry 2008 may be instantiated by the example microprocessor 2700 of FIG. 27 executing machine executable instructions such as those implemented by at least blocks 2302, 2310, 2318 of FIG. 23 and/or block 2412 of FIG. 24. In some examples, the inter-tenant brokering circuitry 2008 may be instantiated by hardware logic circuitry, which may be implemented by an ASIC, XPU, or the FPGA circuitry 2800 of FIG. 28 structured to perform operations corresponding to the machine readable instructions. Additionally or alternatively, the inter-tenant brokering circuitry 2008 may be instantiated by any other combination of hardware, software, and/or firmware. For example, the inter-tenant brokering circuitry 2008 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the appliance control circuitry 1710 includes means for communicating. For example, the means for communicating may be implemented by the communication interface circuitry 2010. In some examples, the communication interface circuitry 2010 may be instantiated by programmable circuitry such as the example programmable circuitry 2612 of FIG. 26. For instance, the communication interface circuitry 2010 may be instantiated by the example microprocessor 2700 of FIG. 27 executing machine executable instructions such as those implemented by at least blocks 2308, 2316, 2320 of FIG. 23. In some examples, the communication interface circuitry 2010 may be instantiated by hardware logic circuitry, which may be implemented by an ASIC, XPU, or the FPGA circuitry 2800 of FIG. 28 structured to perform operations corresponding to the machine readable instructions. Additionally or alternatively, the communication interface circuitry 2010 may be instantiated by any other combination of hardware, software, and/or firmware. For example, the communication interface circuitry 2010 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the appliance control circuitry 1710 includes means for controlling distribution. For example, the means for controlling distribution may be implemented by the distribution control circuitry 2012. In some examples, the distribution control circuitry 2012 may be instantiated by programmable circuitry such as the example programmable circuitry 2612 of FIG. 26. For instance, the distribution control circuitry 2012 may be instantiated by the example microprocessor 2700 of FIG. 27 executing machine executable instructions such as those implemented by at least blocks 2302, 2322 of FIG. 23 and/or block 2414 of FIG. 24. In some examples, the distribution control circuitry 2012 may be instantiated by hardware logic circuitry, which may be implemented by an ASIC, XPU, or the FPGA circuitry 2800 of FIG. 28 structured to perform operations corresponding to the machine readable instructions. Additionally or alternatively, the distribution control circuitry 2012 may be instantiated by any other combination of hardware, software, and/or firmware. For example, the distribution control circuitry 2012 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the appliance control circuitry 1710 includes means for billing. For example, the means for billing may be implemented by the billing control circuitry 2014. In some examples, the billing control circuitry 2014 may be instantiated by programmable circuitry such as the example programmable circuitry 2612 of FIG. 26. For instance, the billing control circuitry 2014 may be instantiated by the example microprocessor 2700 of FIG. 27 executing machine executable instructions such as those implemented by at least blocks 2312, 2324 of FIG. 23. In some examples, the billing control circuitry 2014 may be instantiated by hardware logic circuitry, which may be implemented by an ASIC, XPU, or the FPGA circuitry 2800 of FIG. 28 structured to perform operations corresponding to the machine readable instructions. Additionally or alternatively, the billing control circuitry 2014 may be instantiated by any other combination of hardware, software, and/or firmware. For example, the billing control circuitry 2014 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the infrastructure control circuitry 1708 of FIG. 17 is illustrated in FIG. 19, one or more of the elements, processes, and/or devices illustrated in FIG. 19 may be combined, divided, re-arranged, omitted, eliminated, and/or implemented in any other way. Further, the example infrastructure monitoring circuitry 1902, the example cooling reservation information circuitry 1904, the example infrastructure distribution circuitry 1906, the example infrastructure brokering circuitry 1908, the example metering and billing circuitry 1910, the example infrastructure database 1912, and/or, more generally, the example infrastructure control circuitry 1708 of FIG. 19, may be implemented by hardware alone or by hardware in combination with software and/or firmware. Thus, for example, any of the example infrastructure monitoring circuitry 1902, the example cooling reservation information circuitry 1904, the example infrastructure distribution circuitry 1906, the example infrastructure brokering circuitry 1908, the example metering and billing circuitry 1910, the example infrastructure database 1912, and/or, more generally, the example infrastructure control circuitry 1708, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example infrastructure control circuitry 1708 of FIG. 19 may include one or more elements, processes, and/or devices in addition to, or instead of, those illustrated in FIG. 19, and/or may include more than one of any or all of the illustrated elements, processes and devices.

A flowchart representative of example machine readable instructions, which may be executed by programmable circuitry to implement and/or instantiate the infrastructure control circuitry 1708 of FIG. 19 and/or representative of example operations which may be performed by programmable circuitry to implement and/or instantiate the infrastructure control circuitry 1708 of FIG. 19, is shown in FIG. 22. The machine readable instructions may be one or more executable programs or portion(s) of one or more executable programs for execution by programmable circuitry such as the processor circuitry 2512 shown in the example processor platform 2500 discussed below in connection with FIG. 25 and/or may be one or more function(s) or portion(s) of functions to be performed by the example programmable circuitry (e.g., an FPGA) discussed below in connection with FIGS. 27 and/or 28. In some examples, the machine readable instructions cause an operation, a task, etc., to be carried out and/or performed in an automated manner in the real world. As used herein, “automated” means without human involvement.

While an example manner of implementing the appliance control circuitry 1710 of FIG. 17 is illustrated in FIG. 20, one or more of the elements, processes, and/or devices illustrated in FIG. 20 may be combined, divided, re-arranged, omitted, eliminated, and/or implemented in any other way. Further, the example appliance monitoring circuitry 2002, the example availability tracking circuitry 2004, the example intra-tenant distribution circuitry 2006, the example inter-tenant brokering circuitry 2008, the example communication interface circuitry 2010, the example distribution control circuitry 2012, the example billing control circuitry 2014, the example appliance database 2016, and/or, more generally, the example infrastructure control circuitry 1708 of FIG. 20, may be implemented by hardware alone or by hardware in combination with software and/or firmware. Thus, for example, any of the example appliance monitoring circuitry 2002, the example availability tracking circuitry 2004, the example intra-tenant distribution circuitry 2006, the example inter-tenant brokering circuitry 2008, the example communication interface circuitry 2010, the example distribution control circuitry 2012, the example billing control circuitry 2014, the example appliance database 2016, and/or, more generally, the example appliance control circuitry 1710, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example appliance control circuitry 1710 of FIG. 20 may include one or more elements, processes, and/or devices in addition to, or instead of, those illustrated in FIG. 20, and/or may include more than one of any or all of the illustrated elements, processes and devices.

Flowcharts representative of example machine readable instructions, which may be executed by programmable circuitry to implement and/or instantiate the appliance control circuitry 1710 of FIG. 20 and/or representative of example operations which may be performed by programmable circuitry to implement and/or instantiate the appliance control circuitry 1710 of FIG. 20, are shown in FIGS. 23 and/or 24. The machine readable instructions may be one or more executable programs or portion(s) of one or more executable programs for execution by programmable circuitry such as the processor circuitry 2612 shown in the example processor platform 2600 discussed below in connection with FIG. 26 and/or may be one or more function(s) or portion(s) of functions to be performed by the example programmable circuitry (e.g., an FPGA) discussed below in connection with FIGS. 27 and/or 28.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 22, 23, and/or 24, many other methods of implementing the example infrastructure control circuitry 1708 and/or the example appliance control circuitry 1710 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 22, 23, and/or 24 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 22 is a flowchart representative of example machine readable instructions and/or example operations 2200 that may be executed and/or instantiated by the example infrastructure control circuitry 1708 of FIGS. 17 and/or 19 to control distribution of cooling fluid between the example edge appliances 1702 of the example edge environment 1700 of FIG. 17. The machine readable instructions and/or the operations 2200 of FIG. 22 begin at block 2202, at which the example infrastructure control circuitry 1708 monitors cooling fluid from an example fluid source. For example, the infrastructure monitoring circuitry 1902 monitors the cooling fluid received by the example infrastructure CDU 1704 of FIG. 17 from city infrastructure (e.g., a municipal water supply). In some examples, the infrastructure monitoring circuitry 1902 monitors, based on cooling fluid measurement data from one or more sensors implemented in the edge environment 1700, an amount (e.g., a volume, a flow rate) of the cooling fluid provided to the infrastructure CDU 1704, a temperature of the cooling fluid, and/or an ambient temperature of the edge environment 1700.

At block 2204, the example cooling reservation information circuitry 1904 of FIG. 19 determines one or more first expected cooling parameters corresponding to the first edge appliance 1702A and one or more second expected cooling parameters corresponding to the second edge appliance 1702B of FIG. 17. For example, the cooling reservation information circuitry 1904 determines the first and second expected cooling parameters of the edge appliances 1702 based on SLAs of one or more tenants accessing the edge appliances 1702. The example cooling reservation information circuitry 1904 generates and/or updates an example cooling reservation table to indicate the first and second expected cooling parameters. In some examples, the expected cooling parameters include expected temperatures of one(s) of the edge appliances 1702, expected temperature and/or volume of cooling fluid to be provided to the one(s) of the edge appliances 1702, expected durations for which the cooling fluid is to be provided at a given temperature, etc.

At block 2206, the example infrastructure distribution circuitry 1906 of FIG. 19 causing cooling fluid to be provided to the first and second edge appliances 1702A, 1702B based on the first and second cooling parameters. For example, the infrastructure distribution circuitry 1906 determines the first and second expected cooling parameters based on the cooling reservation table generated by the cooling reservation information circuitry 1904. The infrastructure distribution circuitry 1906 determines a temperature of cooling fluid received at the infrastructure CDU 1704 and/or a current temperature of the one(s) of the edge appliances 1702 based on the measurement data obtained by the infrastructure monitoring circuitry 1902. In some examples, the infrastructure distribution circuitry 1906 causes the infrastructure CDU 1704 to provide an amount of cooling fluid to the corresponding one(s) of the edge appliances 1702 that, based on the temperature of the cooling fluid and/or the current temperature of the edge appliances 1702, is likely to (e.g. expected to) satisfy the expected cooling parameters.

At block 2208, the example metering and billing circuitry 1910 of FIG. 19 generates metering and/or billing information based on the distribution of cooling fluid between the first and second edge appliances 1702A, 1702B. For example, the metering and billing circuitry 1910 generates the metering and/or billing information based on an amount and/or temperature of cooling fluid provided to corresponding ones of the edge appliances 1702. In some examples, the metering and billing circuitry 1910 provides the metering and/or billing information to one or more tenants operating on and/or accessing the corresponding one(s) of the edge appliances 1702.

At block 2210, the example infrastructure monitoring circuitry 1902 of FIG. 19 obtains (e.g., accesses) measurement data associated with the first and second edge appliances 1702A, 1702B. For example, the infrastructure monitoring circuitry 1902 obtains appliance measurement data associated with the edge appliances 1702 from one or more sensors implemented in the edge environment 1700 of FIG. 17. In some examples, the one or more sensors can include temperature sensors to measure a temperature of the edge appliance(s) 1702 and/or a temperature of the cooling fluid at the edge appliance(s) 1702.

At block 2212, the example infrastructure brokering circuitry 1908 of FIG. 19 determines first actual (e.g., current, substantially real-time) cooling parameters of the first edge appliance 1702A and second actual cooling parameters of the second edge appliance 1702B based on the measurement data. For example, the infrastructure brokering circuitry 1908 determines, based on the appliance measurement data obtained by the infrastructure monitoring circuitry 1902, the first and second actual cooling parameters including an actual temperature of the one(s) of the edge appliances 1702 and/or an actual temperature of cooling fluid provided to the one(s) of the edge appliances 1702.

At block 2214, the example infrastructure brokering circuitry 1908 of FIG. 19 determines whether one or more of the actual cooling parameters are different from the corresponding expected cooling parameters. For example, the infrastructure brokering circuitry 1908 compares the first actual cooling parameters to the first expected cooling parameters of the first edge appliance 1702A, and/or compares the second actual cooling parameters to the second expected cooling parameters of the second edge appliance 1702B. In response to the infrastructure brokering circuitry 1908 determining that the first actual cooling parameters correspond to the first expected cooling parameters and the second actual cooling parameters correspond to the second expected cooling parameters (e.g., block 2214 returns a result of NO), control returns to block 2210. Alternatively, in response to the infrastructure brokering circuitry 1908 determining that at least one of the first actual cooling parameters is different from the corresponding first expected cooling parameters and/or at least one of the second actual cooling parameters is different from the corresponding second expected cooling parameters (e.g., block 2214 returns a result of YES), control proceeds to block 2216.

At block 2216, the infrastructure brokering circuitry 1908 causes the cooling fluid to be redistributed between the first and second edge appliances 1702A, 1702B. For example, the infrastructure brokering circuitry 1908 determines an amount of the cooling fluid to be redistributed based on a temperature of the cooling fluid, a difference between the first actual and expected temperatures of the first edge appliance 1702A, and/or a difference between the second actual and expected temperatures for the second edge appliance 1702B. In some examples, the infrastructure brokering circuitry 1908 determines the amount of cooling fluid to be redirected based on costs associated with the cooling fluid. In some examples, the example infrastructure brokering circuitry 1908 causes the infrastructure CDU 1704 to redistribute the cooling fluid between the edge appliances 1702.

At block 2218, the infrastructure monitoring circuitry 1902 determines whether to continue monitoring. For example, the infrastructure monitoring circuitry 1902 determines whether to continue monitoring based on whether additional measurement data is obtained by the one or more sensors of the edge environment 1700. In response to the infrastructure monitoring circuitry 1902 determining to continue monitoring (e.g., block 2218 returns a result of YES), control returns to block 2202. Alternatively, in response to the infrastructure monitoring circuitry 1902 determining not to continue monitoring because, for instance, the edge application is no longer operating (e.g., block 2218 returns a result of NO), control ends.

FIG. 23 is a flowchart representative of example machine readable instructions and/or example operations 2300 that may be executed and/or instantiated by the example appliance control circuitry 1710 of FIGS. 17 and/or 20 to control distribution of cooling fluid to and/or between one or more components of the example edge appliance 1702 of FIGS. 17 and/or 18. The machine readable instructions and/or the operations 2300 of FIG. 23 begin at block 2302, at which the example appliance control circuitry 1710 determines cooling parameters for a node N of the edge appliance 1702, where the node N can be a first node, a second node, etc. of the edge appliance 1702. For example, the example appliance control circuitry 1710 determines, for the node N, actual and expected cooling parameters for the node and/or for one or more devices corresponding to the node. In some examples, the node N corresponds to one of the example edge appliances 1702 of FIG. 17, one of the example tanks 1804, one of the example partitions 1806, and/or one of the example chassis 1812 of FIG. 18. In some examples, the determining of the cooling parameters at block 2302 is described further below in connection with FIG. 24.

At block 2304, the example availability tracking circuitry 2004 of FIG. 20 determines cooling availability information for the node N. For example, the availability tracking circuitry 2004 determines the cooling availability information for the node N based on a comparison of the actual (e.g., current, substantially real-time) cooling parameters and the expected cooling parameters of the node N. In some examples, the availability tracking circuitry 2004 determines whether excess cooling resources are available and/or whether additional cooling resources are expected, needed, or would other facilitate performance and/or cooling of one or more devices and/or tenants corresponding to the node N. In some examples, the availability tracking circuitry 2004 determines an amount of the excess cooling resources and/or the expected cooling resources based on a calculated difference between the actual and expected cooling parameters.

At block 2306, the example availability tracking circuitry 2004 determines whether excess cooling resources are available at the node N. In some examples, the availability tracking circuitry 2004 determines that excess cooling resources are available based on the cooling availability information indicating that the actual temperature of the node N is less than the expected temperature of the node N. In response to the availability tracking circuitry 2004 determining that excess cooling resources are available (e.g., block 2306 returns a result of YES), control proceeds to block 2308. Alternatively, in response to the availability tracking circuitry 2004 determining that no excess cooling resources are available (e.g., block 2306 returns a result of NO), control proceeds to block 2314.

At block 2308, the example communication interface circuitry 2010 of FIG. 20 obtains one or more cooling requests from one or more partner nodes of the edge appliance 1702 and/or the edge environment 1700 of FIG. 17 (e.g., tenants who have agreed to negotiate or share cooling resources with the tenant of the node N). For example, the communication interface circuitry 2010 obtains and/or receives the cooling request(s) corresponding to the partner node(s), where the cooling request(s) indicate an amount, temperature, and/or duration of cooling fluid requested by one or more tenants operating on the partner node(s). In some examples, the partner node(s) correspond to one or more second ones of the edge appliances 1702, second one(s) of the tanks 1804, second one(s) of the partitions 1806, and/or second one(s) of the chassis 1812 of FIG. 18 that are fluidly coupled to the node N.

At block 2310, the example inter-tenant brokering circuitry 2008 of FIG. 20 causes cooling fluid to be provided to one or more of the partner nodes. For example, the example inter-tenant brokering circuitry 2008 of FIG. 20 determines, based on the received cooling request(s), whether and/or how to distribute the excess cooling fluid from the node N to one(s) of the partner nodes. In some examples, the inter-tenant brokering circuitry 2008 selects the one(s) of the partner nodes to which the cooling fluid is to be provided based on an amount of the cooling fluid requested and a price at which partner tenant(s) of the partner node(s) are willing to purchase the cooling fluid. In some examples, the inter-tenant brokering circuitry 2008 directs the example distribution control circuitry 2012 of FIG. 20 to distribute the excess cooling fluid from the node N to the selected one(s) of the partner nodes via one or more of the example appliance CDU 1802, the example tank CDU(s) 1808, the example partition CDU(s) 1810, and/or the example chassis CDU(s) 1820 of FIG. 18.

At block 2312, the example billing control circuitry 2014 of FIG. 20 generates and/or sends billing information based on the cooling fluid provided. For example, the billing control circuitry 2014 generates the billing information corresponding to the selected one(s) of the partner nodes to which the excess cooling fluid was provided. In some examples, the billing control circuitry 2014 generates the billing information based on an amount of the cooling fluid, a temperature of the cooling fluid, a price of the cooling fluid, and a duration for which the cooling fluid is provided to the selected one(s) of the partner nodes. In some examples, the billing control circuitry 2014 provides and/or sends the billing information to the corresponding partner node(s) and/or the partner tenant(s).

At block 2314, the example availability tracking circuitry 2004 determines whether additional cooling resources are expected at the node N. For example, the availability tracking circuitry 2004 determines that additional cooling resources are expected, needed, or would otherwise facilitate cooling based on the cooling availability information indicating that the actual temperature of the node N is greater than the expected temperature of the node N. In response to the availability tracking circuitry 2004 determining that additional cooling resources are expected (e.g., block 2314 returns a result of YES), control proceeds to block 2316. Alternatively, in response to the availability tracking circuitry 2004 determining that no additional cooling resources are expected (e.g., block 2314 returns a result of NO), control proceeds to block 2326.

At block 2316, the example communication interface circuitry 2010 obtains one or more cooling availability notifications from the one or more partner nodes. For example, the communication interface circuitry 2010 obtains and/or receives the cooling availability notification(s) indicating an amount, temperature, and/or duration of cooling fluid available for purchase from the partner tenant(s) operating on the partner node(s). In some examples, cooling availability notification(s) indicate a price of the cooling fluid available from one(s) of the partner nodes.

At block 2318, the example inter-tenant brokering circuitry 2008 of FIG. 20 selects one or more of the partner nodes based on the cooling availability notification(s). For example, the example inter-tenant brokering circuitry 2008 selects the one(s) of the partner nodes from which the cooling fluid is to be purchased and/or received based on an amount, temperature, and/or duration of the additional cooling fluid expected at the node N and prices at which the partner tenant(s) agree to sell the available cooling fluid. In some examples, the inter-tenant brokering circuitry 2008 selects the one(s) of the partner nodes and/or amounts of cooling fluid to be requested from the selected partner node(s).

At block 2320, the example communication interface circuitry 2010 sends one or more cooling requests to the selected partner node(s). For example, the example communication interface circuitry 2010 generates the cooling request(s) to be sent to the corresponding selected partner node(s), where the cooling request(s) indicate the amount of cooling fluid requested from the corresponding partner node(s). In some examples, the communication interface circuitry 2010 sends and/or provides the cooling request(s) to the selected partner node(s) and/or to the partner tenant(s) associated therewith.

At block 2322, the example distribution control circuitry 2012 causes cooling fluid to be received from the selected partner node(s). For example, the example distribution control circuitry 2012 receives and/or obtains cooling fluid from the selected partner node(s) based on the amount(s) of cooling fluid indicated in the cooling request(s) for the node N. In some examples, the distribution control circuitry 2012 directs the received cooling fluid to the node N to provide cooling thereof.

At block 2324, the example billing control circuitry 2014 obtains billing information based on the cooling fluid received from the selected partner node(s). For example, the example billing control circuitry 2014 obtains and/or receives the billing information from the selected partner node(s) and/or from the partner tenant(s) corresponding to the selected partner node(s), where the billing information includes a temperature, amount, duration, and/or price associated with the cooling fluid provided to the node N.

At block 2326, the example appliance monitoring circuitry 2002 determines whether to continue monitoring. For example, the appliance monitoring circuitry 2002 determines whether to continue monitoring the node N and/or one or more other nodes of the edge environment 1700 of FIG. 17. In response to the appliance monitoring circuitry 2002 determining to continue monitoring (e.g., block 2326 returns a result of YES), control returns to block 2302. Alternatively, in response to the appliance monitoring circuitry 2002 determining not to continue monitoring (e.g., block 2326 returns a result of NO), control ends.

FIG. 24 is a flowchart representative of example machine readable instructions and/or example operations 2400 that may be executed and/or instantiated by the example appliance control circuitry 1710 of FIGS. 17 and/or 20 to determine one or more cooling parameters of a node N (e.g., the example edge appliance 1702 of FIGS. 17 and/or 18) in connection with block 2302 of FIG. 23. The machine readable instructions and/or the operations 2400 of FIG. 24 begin at block 2402, at which the example intra-tenant distribution circuitry 2006 of FIG. 20 identifies one or more tenants operating on one or more devices of the node N.

At block 2404, the example intra-tenant distribution circuitry 2006 determines expected cooling parameters for the tenant(s) based on SLAs of the tenant(s). For example, the intra-tenant distribution circuitry 2006 determines the expected cooling parameters for one(s) of the devices corresponding to a particular tenant, where the expected cooling parameters include an expected temperature at the device(s), expected temperature of cooling fluid to the device(s), and/or an expected duration for which the cooling fluid is provided to the device(s). Further, the intra-tenant distribution circuitry 2006 determines cooling resources available to and/or purchased by the corresponding tenant(s) for use in cooling the corresponding device(s).

At block 2406, the example distribution control circuitry 2012 of FIG. 20 causes distribution of cooling fluid to and/or between the device(s) based on the expected cooling parameters. For example, the example intra-tenant distribution circuitry 2006 determines an amount, temperature, and/or duration of cooling fluid to be provided to corresponding device(s) of a particular tenant based on the available cooling resources of the tenant and the expected cooling parameters of the device(s). In some examples, the intra-tenant distribution circuitry 2006 directs the distribution control circuitry 2012 to distribute, via at least one CDU (e.g., the appliance CDU 1802, the tank CDU(s) 1808, the partition CDU(s) 1810, and/or the chassis CDU(s) 1820 of FIG. 18), the cooling fluid across the device(s).

At block 2408, the example appliance monitoring circuitry 2002 of FIG. 20 monitors actual (e.g., substantially real-time) cooling parameters of the devices(s). For example, the appliance monitoring circuitry 2002 monitors the actual cooling parameters based on measurement data obtained from one or more sensors of the edge environment 1700 and/or the edge appliance(s) 1702. In some examples, the actual cooling parameters include actual temperature(s) of the device(s), actual temperature of the cooling fluid provided to the device(s), etc.

At block 2410, the example availability tracking circuitry 2004 of FIG. 20 determines whether the expected cooling parameters of the device(s) are satisfied. For example, the availability tracking circuitry 2004 determines whether the expected cooling parameters are satisfied based on a comparison of the actual cooling parameters and the expected cooling parameters for the device(s). In some examples, the availability tracking circuitry 2004 calculates a difference between the actual and expected cooling parameters, and determines whether the expected cooling parameters are satisfied by comparing the difference(s) to one or more thresholds. In some examples, in response to the availability tracking circuitry 2004 determining that the expected cooling parameters are satisfied (e.g., block 2410 returns a result of YES), control proceeds to block 2416. Alternatively, in response to the availability tracking circuitry 2004 determining that the expected cooling parameters are not satisfied (e.g., block 2410 returns a result of NO), control proceeds to block 2412.

At block 2412, the example inter-tenant brokering circuitry 2008 of FIG. 20 performs brokering of cooling fluid between the tenants. For example, the inter-tenant brokering circuitry 2008 performs the brokering based on one or more cooling requests and/or one or more cooling availability notifications received by the example communication interface circuitry 2010. In some examples, the inter-tenant brokering circuitry 2008 determines whether and/or how cooling fluid is to be redistributed between the devices and/or the tenants by balancing availability of cooling resources of the devices and/or tenants, the additional cooling resources requested by one(s) of the devices and/or the tenants, and/or a cost of the additional cooling resources. In some examples, the inter-tenant brokering circuitry 2008 selects an amount, a temperature, and/or a duration of the cooling fluid to be provided to and/or obtained from corresponding one(s) of the devices and/or the tenants.

At block 2414, the example distribution control circuitry 2012 of FIG. 20 causes redistribution of cooling fluid between the tenants. For example, the distribution control circuitry 2012 causes the at least one CDU to redistribute the cooling fluid between the tenants and/or the devices based on the corresponding amounts, the temperatures, and/or the durations of the cooling fluid selected by the inter-tenant brokering circuitry 2008.

At block 2416, the example availability tracking circuitry 2004 updates the actual cooling parameters. For example, the availability tracking circuitry 2004 updates the actual cooling parameters for the corresponding devices and/or tenants based on measurement data obtained by the appliance monitoring circuitry 2002. In some examples, the availability tracking circuitry 2004 updates the actual cooling parameters in response to a redistribution of cooling fluid by the distribution control circuitry 2012. Control returns to block 2304 of FIG. 23.

FIG. 25 is a block diagram of an example programmable circuitry platform 2500 structured to execute and/or instantiate the example machine-readable instructions and/or the example operations of FIG. 22 to implement the infrastructure control circuitry 1708 of FIG. 19. The programmable circuitry platform 2500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 2500 of the illustrated example includes programmable circuitry 2512. The programmable circuitry 2512 of the illustrated example is hardware. For example, the programmable circuitry 2512 can be implemented by one or more integrated circuits, logic circuits, FPGAs, microprocessors, CPUs, GPUs, DSPs, and/or microcontrollers from any desired family or manufacturer. The programmable circuitry 2512 may be implemented by one or more semiconductor based (e.g., silicon based) devices. In this example, the programmable circuitry 2512 implements the example infrastructure monitoring circuitry 1902, the example cooling reservation information circuitry 1904, the example infrastructure distribution circuitry 1906, the example infrastructure brokering circuitry 1908, and the example metering and billing circuitry 1910.

The programmable circuitry 2512 of the illustrated example includes a local memory 2513 (e.g., a cache, registers, etc.). The programmable circuitry 2512 of the illustrated example is in communication with main memory 2514, 2516, which includes a volatile memory 2514 and a non-volatile memory 2516, by a bus 2518. The volatile memory 2514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2516 may be implemented by flash memory and/or any other desired type of memory device. Access to the main memory 2514, 2516 of the illustrated example is controlled by a memory controller 2517. In some examples, the memory controller 2517 may be implemented by one or more integrated circuits, logic circuits, microcontrollers from any desired family or manufacturer, or any other type of circuitry to manage the flow of data going to and from the main memory 2514, 2516.

The programmable circuitry platform 2500 of the illustrated example also includes interface circuitry 2520. The interface circuitry 2520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 2522 are connected to the interface circuitry 2520. The input device(s) 2522 permit(s) a user (e.g., a human user, a machine user, etc.) to enter data and/or commands into the programmable circuitry 2512. The input device(s) 2522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 2524 are also connected to the interface circuitry 2520 of the illustrated example. The output device(s) 2524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 2520 of the illustrated example, thus, typically includes a graphics driver card, a graphics driver chip, and/or graphics processor circuitry such as a GPU.

The interface circuitry 2520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 2526. The communication can be by, for example, an Ethernet connection, a digital subscriber line (DSL) connection, a telephone line connection, a coaxial cable system, a satellite system, a beyond-line-of-site wireless system, a line-of-site wireless system, a cellular telephone system, an optical connection, etc.

The programmable circuitry platform 2500 of the illustrated example also includes one or more mass storage discs or devices 2528 to store firmware, software, and/or data. Examples of such mass storage discs or devices 2528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 2532, which may be implemented by the machine readable instructions of FIG. 22, may be stored in the mass storage device 2528, in the volatile memory 2514, in the non-volatile memory 2516, and/or on at least one non-transitory computer readable storage medium such as a CD or DVD which may be removable.

FIG. 26 is a block diagram of an example programmable circuitry platform 2600 structured to execute and/or instantiate the example machine-readable instructions and/or the example operations of FIGS. 23 and/or 24 to implement the appliance control circuitry 1710 of FIG. 20. The programmable circuitry platform 2600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 2600 of the illustrated example includes programmable circuitry 2612. The programmable circuitry 2612 of the illustrated example is hardware. For example, the programmable circuitry 2612 can be implemented by one or more integrated circuits, logic circuits, FPGAs, microprocessors, CPUs, GPUs, DSPs, and/or microcontrollers from any desired family or manufacturer. The programmable circuitry 2612 may be implemented by one or more semiconductor based (e.g., silicon based) devices. In this example, the programmable circuitry 2612 implements the example appliance monitoring circuitry 2002, the example availability tracking circuitry 2004, the example intra-tenant distribution circuitry 2006, the example inter-tenant brokering circuitry 2008, the example communication interface circuitry 2010, the example distribution control circuitry 2012, and the example billing control circuitry 2014.

The programmable circuitry 2612 of the illustrated example includes a local memory 2613 (e.g., a cache, registers, etc.). The programmable circuitry 2612 of the illustrated example is in communication with main memory 2614, 2616, which includes a volatile memory 2614 and a non-volatile memory 2616, by a bus 2618. The volatile memory 2614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2616 may be implemented by flash memory and/or any other desired type of memory device. Access to the main memory 2614, 2616 of the illustrated example is controlled by a memory controller 2617. In some examples, the memory controller 2617 may be implemented by one or more integrated circuits, logic circuits, microcontrollers from any desired family or manufacturer, or any other type of circuitry to manage the flow of data going to and from the main memory 2614, 2616.

The programmable circuitry platform 2600 of the illustrated example also includes interface circuitry 2620. The interface circuitry 2620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 2622 are connected to the interface circuitry 2620. The input device(s) 2622 permit(s) a user (e.g., a human user, a machine user, etc.) to enter data and/or commands into the programmable circuitry 2612. The input device(s) 2622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 2624 are also connected to the interface circuitry 2620 of the illustrated example. The output device(s) 2624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 2620 of the illustrated example, thus, typically includes a graphics driver card, a graphics driver chip, and/or graphics processor circuitry such as a GPU.

The interface circuitry 2620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 2626. The communication can be by, for example, an Ethernet connection, a digital subscriber line (DSL) connection, a telephone line connection, a coaxial cable system, a satellite system, a beyond-line-of-site wireless system, a line-of-site wireless system, a cellular telephone system, an optical connection, etc.

The programmable circuitry platform 2600 of the illustrated example also includes one or more mass storage discs or devices 2628 to store firmware, software, and/or data. Examples of such mass storage discs or devices 2628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 2632, which may be implemented by the machine readable instructions of FIGS. 23 and/or 24, may be stored in the mass storage device 2628, in the volatile memory 2614, in the non-volatile memory 2616, and/or on at least one non-transitory computer readable storage medium such as a CD or DVD which may be removable.

FIG. 27 is a block diagram of an example implementation of the programmable circuitry 2512 of FIG. 25 and/or the programmable circuitry 2612 of FIG. 26. In this example, the programmable circuitry 2512 of FIG. 25 and/or the programmable circuitry 2612 of FIG. 26 is implemented by a microprocessor 2700. For example, the microprocessor 2700 may be a general-purpose microprocessor (e.g., general-purpose microprocessor circuitry). The microprocessor 2700 executes some or all of the machine-readable instructions of the flowcharts of FIGS. 22, 23, and/or 24 to effectively instantiate the circuitry of FIGS. 19 and/or 20 as logic circuits to perform operations corresponding to those machine readable instructions. In some such examples, the circuitry of FIGS. 19 and/or 20 is instantiated by the hardware circuits of the microprocessor 2700 in combination with the machine-readable instructions. For example, the microprocessor 2700 may be implemented by multi-core hardware circuitry such as a CPU, a DSP, a GPU, an XPU, etc. Although it may include any number of example cores 2702 (e.g., 1 core), the microprocessor 2700 of this example is a multi-core semiconductor device including N cores. The cores 2702 of the microprocessor 2700 may operate independently or may cooperate to execute machine readable instructions. For example, machine code corresponding to a firmware program, an embedded software program, or a software program may be executed by one of the cores 2702 or may be executed by multiple ones of the cores 2702 at the same or different times. In some examples, the machine code corresponding to the firmware program, the embedded software program, or the software program is split into threads and executed in parallel by two or more of the cores 2702. The software program may correspond to a portion or all of the machine readable instructions and/or operations represented by the flowcharts of FIGS. 22, 23, and/or 24.

The cores 2702 may communicate by a first example bus 2704. In some examples, the first bus 2704 may be implemented by a communication bus to effectuate communication associated with one(s) of the cores 2702. For example, the first bus 2704 may be implemented by at least one of an Inter-Integrated Circuit (I2C) bus, a Serial Peripheral Interface (SPI) bus, a PCI bus, or a PCIe bus. Additionally or alternatively, the first bus 2704 may be implemented by any other type of computing or electrical bus. The cores 2702 may obtain data, instructions, and/or signals from one or more external devices by example interface circuitry 2706. The cores 2702 may output data, instructions, and/or signals to the one or more external devices by the interface circuitry 2706. Although the cores 2702 of this example include example local memory 2720 (e.g., Level 1 (L1) cache that may be split into an L1 data cache and an L1 instruction cache), the microprocessor 2700 also includes example shared memory 2710 that may be shared by the cores (e.g., Level 2 (L2 cache)) for high-speed access to data and/or instructions. Data and/or instructions may be transferred (e.g., shared) by writing to and/or reading from the shared memory 2710. The local memory 2720 of each of the cores 2702 and the shared memory 2710 may be part of a hierarchy of storage devices including multiple levels of cache memory and the main memory (e.g., the main memory 2514, 2516 of FIG. 25 and/or the main memory 2614, 2616 of FIG. 26). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 2702 may be referred to as a CPU, DSP, GPU, etc., or any other type of hardware circuitry. Each core 2702 includes control unit circuitry 2714, arithmetic and logic (AL) circuitry (sometimes referred to as an ALU) 2716, a plurality of registers 2718, the local memory 2720, and a second example bus 2722. Other structures may be present. For example, each core 2702 may include vector unit circuitry, single instruction multiple data (SIMD) unit circuitry, load/store unit (LSU) circuitry, branch/jump unit circuitry, floating-point unit (FPU) circuitry, etc. The control unit circuitry 2714 includes semiconductor-based circuits structured to control (e.g., coordinate) data movement within the corresponding core 2702. The AL circuitry 2716 includes semiconductor-based circuits structured to perform one or more mathematic and/or logic operations on the data within the corresponding core 2702. The AL circuitry 2716 of some examples performs integer based operations. In other examples, the AL circuitry 2716 also performs floating-point operations. In yet other examples, the AL circuitry 2716 may include first AL circuitry that performs integer-based operations and second AL circuitry that performs floating-point operations. In some examples, the AL circuitry 2716 may be referred to as an Arithmetic Logic Unit (ALU).

The registers 2718 are semiconductor-based structures to store data and/or instructions such as results of one or more of the operations performed by the AL circuitry 2716 of the corresponding core 2702. For example, the registers 2718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 2718 may be arranged in a bank as shown in FIG. 27. Alternatively, the registers 2718 may be organized in any other arrangement, format, or structure, such as by being distributed throughout the core 2702 to shorten access time. The second bus 2722 may be implemented by at least one of an I2C bus, a SPI bus, a PCI bus, or a PCIe bus.

Each core 2702 and/or, more generally, the microprocessor 2700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 2700 is a semiconductor device fabricated to include many transistors interconnected to implement the structures described above in one or more integrated circuits (ICs) contained in one or more packages.

The microprocessor 2700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 2700, in the same chip package as the microprocessor 2700 and/or in one or more separate packages from the microprocessor 2700.

FIG. 28 is a block diagram of another example implementation of the programmable circuitry 2512 of FIG. 25 and/or the programmable circuitry 2612 of FIG. 26. In this example, the programmable circuitry 2512 and/or the programmable circuitry 2612 is implemented by FPGA circuitry 2800. For example, the FPGA circuitry 2800 may be implemented by an FPGA. The FPGA circuitry 2800 can be used, for example, to perform operations that could otherwise be performed by the example microprocessor 2700 of FIG. 27 executing corresponding machine readable instructions. However, once configured, the FPGA circuitry 2800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 2700 of FIG. 27 described above (which is a general purpose device that may be programmed to execute some or all of the machine readable instructions represented by the flowchart(s) of FIGS. 22, 23, and/or 24 but whose interconnections and logic circuitry are fixed once fabricated), the FPGA circuitry 2800 of the example of FIG. 28 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 22, 23, and/or 24. In particular, the FPGA circuitry 2800 may be thought of as an array of logic gates, interconnections, and switches. The switches can be programmed to change how the logic gates are interconnected by the interconnections, effectively forming one or more dedicated logic circuits (unless and until the FPGA circuitry 2800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 22, 23, and/or 24. As such, the FPGA circuitry 2800 may be configured and/or structured to effectively instantiate some or all of the operations/functions corresponding to the machine readable instructions of the flowchart(s) of FIGS. 22, 23, and/or 24 as dedicated logic circuits to perform the operations/functions corresponding to those software instructions in a dedicated manner analogous to an ASIC. Therefore, the FPGA circuitry 2800 may perform the operations/functions corresponding to the some or all of the machine readable instructions of FIGS. 22, 23, and/or 24 faster than the general-purpose microprocessor can execute the same.

In the example of FIG. 28, the FPGA circuitry 2800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 2800 of FIG. 28 may access and/or load the binary file to cause the FPGA circuitry 2800 of FIG. 28 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2800 of FIG. 28 to cause configuration and/or structuring of the FPGA circuitry 2800 of FIG. 28, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 2800 of FIG. 28 may access and/or load the binary file to cause the FPGA circuitry 2800 of FIG. 28 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2800 of FIG. 28 to cause configuration and/or structuring of the FPGA circuitry 2800 of FIG. 28, or portion(s) thereof.

The FPGA circuitry 2800 of FIG. 28, includes example input/output (I/O) circuitry 2802 to obtain and/or output data to/from example configuration circuitry 2804 and/or external hardware 2806. For example, the configuration circuitry 2804 may be implemented by interface circuitry that may obtain a binary file, which may be implemented by a bit stream, data, and/or machine-readable instructions, to configure the FPGA circuitry 2800, or portion(s) thereof. In some such examples, the configuration circuitry 2804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 2806 may be implemented by external hardware circuitry. For example, the external hardware 2806 may be implemented by the microprocessor 2700 of FIG. 27.

The FPGA circuitry 2800 also includes an array of example logic gate circuitry 2808, a plurality of example configurable interconnections 2810, and example storage circuitry 2812. The logic gate circuitry 2808 and the configurable interconnections 2810 are configurable to instantiate one or more operations/functions that may correspond to at least some of the machine readable instructions of FIGS. 22, 23, and/or 24 and/or other desired operations. The logic gate circuitry 2808 shown in FIG. 28 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2808 to enable configuration of the electrical structures and/or the logic gates to form circuits to perform desired operations/functions. The logic gate circuitry 2808 may include other electrical structures such as look-up tables (LUTs), registers (e.g., flip-flops or latches), multiplexers, etc.

The configurable interconnections 2810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2808 to program desired logic circuits.

The storage circuitry 2812 of the illustrated example is structured to store result(s) of the one or more of the operations performed by corresponding logic gates. The storage circuitry 2812 may be implemented by registers or the like. In the illustrated example, the storage circuitry 2812 is distributed amongst the logic gate circuitry 2808 to facilitate access and increase execution speed.

The example FPGA circuitry 2800 of FIG. 28 also includes example dedicated operations circuitry 2814. In this example, the dedicated operations circuitry 2814 includes special purpose circuitry 2816 that may be invoked to implement commonly used functions to avoid the need to program those functions in the field. Examples of such special purpose circuitry 2816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2800 may also include example general purpose programmable circuitry 2818 such as an example CPU 2820 and/or an example DSP 2822. Other general purpose programmable circuitry 2818 may additionally or alternatively be present such as a GPU, an XPU, etc., that can be programmed to perform other operations.

Although FIGS. 27 and 28 illustrate two example implementations of the programmable circuitry 2512 of FIG. 25 and/or the programmable circuitry 2612 of FIG. 26, many other approaches are contemplated. For example, FPGA circuitry may include an on-board CPU, such as one or more of the example CPU 2820 of FIG. 27. Therefore, the programmable circuitry 2512 of FIG. 25 and/or the programmable circuitry 2612 of FIG. 26 may additionally be implemented by combining at least the example microprocessor 2700 of FIG. 27 and the example FPGA circuitry 2800 of FIG. 28. In some such hybrid examples, one or more cores 2702 of FIG. 27 may execute a first portion of the machine readable instructions represented by the flowchart(s) of FIGS. 22, 23, and/or 24 to perform first operation(s)/function(s), the FPGA circuitry 2800 of FIG. 28 may be configured and/or structured to perform second operation(s)/function(s) corresponding to a second portion of the machine readable instructions represented by the flowcharts of FIGS. 22, 23, and/or 24, and/or an ASIC may be configured and/or structured to perform third operation(s)/function(s) corresponding to a third portion of the machine readable instructions represented by the flowcharts of FIGS. 22, 23, and/or 24.

It should be understood that some or all of the circuitry of FIGS. 19 and/or 20 may, thus, be instantiated at the same or different times. For example, same and/or different portion(s) of the microprocessor 2700 of FIG. 27 may be programmed to execute portion(s) of machine-readable instructions at the same and/or different times. In some examples, same and/or different portion(s) of the FPGA circuitry 2800 of FIG. 28 may be configured and/or structured to perform operations/functions corresponding to portion(s) of machine-readable instructions at the same and/or different times.

In some examples, some or all of the circuitry of FIGS. 19 and/or 20 may be instantiated, for example, in one or more threads executing concurrently and/or in series. For example, the microprocessor 2700 of FIG. 27 may execute machine readable instructions in one or more threads executing concurrently and/or in series. In some examples, the FPGA circuitry 2800 of FIG. 28 may be configured and/or structured to carry out operations/functions concurrently and/or in series. Moreover, in some examples, some or all of the circuitry of FIGS. 19 and/or 20 may be implemented within one or more virtual machines and/or containers executing on the microprocessor 2700 of FIG. 27.

In some examples, the programmable circuitry 2512 of FIG. 25 and/or the programmable circuitry 2612 of FIG. 26 may be in one or more packages. For example, the microprocessor 2700 of FIG. 27 and/or the FPGA circuitry 2800 of FIG. 28 may be in one or more packages. In some examples, an XPU may be implemented by the programmable circuitry 2512 of FIG. 25 and/or the programmable circuitry 2612 of FIG. 26, which may be in one or more packages. For example, the XPU may include a CPU (e.g., the microprocessor 2700 of FIG. 27, the CPU 2820 of FIG. 28, etc.) in one package, a DSP (e.g., the DSP 2822 of FIG. 28) in another package, a GPU in yet another package, and an FPGA (e.g., the FPGA circuitry 2800 of FIG. 28) in still yet another package.

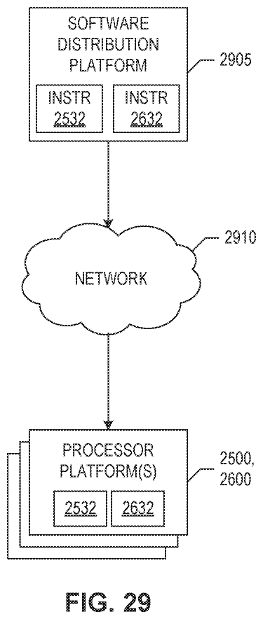

A block diagram illustrating an example software distribution platform 2905 to distribute software such as the example machine readable instructions 2532 of FIG. 25 and/or the example machine readable instructions 2632 of FIG. 26 to other hardware devices (e.g., hardware devices owned and/or operated by third parties from the owner and/or operator of the software distribution platform) is illustrated in FIG. 29. The example software distribution platform 2905 may be implemented by any computer server, data facility, cloud service, etc., capable of storing and transmitting software to other computing devices. The third parties may be customers of the entity owning and/or operating the software distribution platform 2905. For example, the entity that owns and/or operates the software distribution platform 2905 may be a developer, a seller, and/or a licensor of software such as the example machine readable instructions 2532 of FIG. 25 and/or the example machine readable instructions 2632 of FIG. 26. The third parties may be consumers, users, retailers, OEMs, etc., who purchase and/or license the software for use and/or re-sale and/or sub-licensing. In the illustrated example, the software distribution platform 2905 includes one or more servers and one or more storage devices. The storage devices store the machine readable instructions 2532, 2632, which may correspond to the example machine readable instructions of FIGS. 22, 23, and/or 24, as described above. The one or more servers of the example software distribution platform 2905 are in communication with an example network 2910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 2532, 2632 from the software distribution platform 2905. For example, the software, which may correspond to the example machine readable instructions of FIGS. 22, 23, and/or 24, may be downloaded to the example programmable circuitry platform 2500, which is to execute the machine readable instructions 2532, 2632 to implement the infrastructure control circuitry 1708 and/or the appliance control circuitry 1710. In some examples, one or more servers of the software distribution platform 2905 periodically offer, transmit, and/or force updates to the software (e.g., the example machine readable instructions 2532 of FIG. 25 and/or the example machine readable instructions 2632 of FIG. 26) to ensure improvements, patches, updates, etc., are distributed and applied to the software at the end user devices. Although referred to as software above, the distributed “software” could alternatively be firmware.

From the foregoing, it will be appreciated that example systems, methods, apparatus, and articles of manufacture have been disclosed that control distribution of cooling resources in an edge environment. In examples disclosed herein, example processor circuitry monitors actual (e.g., current, substantially real-time) and expected cooling parameters for one or more edge locations (e.g., nodes and/or devices) in the edge environment to determine whether the expected cooling parameters are satisfied. When the expected cooling parameters are not satisfied (e.g., an actual temperature at the edge location(s) is greater than an expected temperature at the edge location(s)), examples disclosed herein facilitate brokering of cooling resources between tenant(s) operating at a same edge location and/or at different edge locations. Accordingly, examples disclosed herein enable cooling fluid in a liquid cooling system to be redistributed between the edge locations to satisfy the expected cooling parameters thereof. Advantageously, by adjusting the amounts of cooling fluid provided to the corresponding edge locations based on the expected cooling parameters and/or the availability of cooling fluid across the edge locations, disclosed systems, methods, apparatus, and articles of manufacture improve the efficiency of using a computing device by improving efficiency of cooling of the computing device and, as a result, preventing overheating of the computing device. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to control cooling in an edge environment are disclosed herein. Further examples and combinations thereof include the following:

Example 1 includes an apparatus comprising memory, machine-readable instructions, and programmable circuitry to execute the machine-readable instructions to determine whether a first cooling parameter for a first edge node is satisfied based on first cooling availability information for the first edge node, when the first cooling parameter is satisfied, cause a first distribution unit to maintain an amount of cooling fluid to the first edge node, and when the first cooling parameter is not satisfied, cause at least one of the first distribution unit or a second distribution unit to adjust the amount of cooling fluid to at least one of the first edge node or a second edge node based on the first cooling availability information and second cooling availability information, the second cooling availability information for the second edge node.

Example 2 includes the apparatus of example 1, wherein the programmable circuitry is to execute the machine-readable instructions to determine a first expected temperature associated with a first edge device and a second expected temperature associated with a second edge device, the first edge device operating at the first edge node, the second edge device operating at the first edge node or the second edge node, cause the at least one of the first distribution unit or the second distribution unit to provide the amount of cooling fluid to at least one of the first edge device or the second edge device based on the first and second expected temperatures, and when an actual temperature of the first edge device is different from the first expected temperature, cause the at least one of the first distribution unit or the second distribution unit to redistribute the amount of cooling fluid between the first and second edge devices.

Example 3 includes the apparatus of examples 1 or 2, wherein the first edge device and the second edge device correspond to a same tenant.

Example 4 includes the apparatus of any of examples 1-3, wherein the first edge device corresponds to a first tenant and the second edge device corresponds to a second tenant, the first tenant different from the second tenant.

Example 5 includes the apparatus of any of examples 1-4, wherein the first edge device includes at least one of a central processing unit, a graphics processing unit, or a memory chip.

Example 6 includes the apparatus of any of examples 1-5, wherein the programmable circuitry is to select the second edge node from a plurality of edge nodes based on an availability of cooling fluid corresponding to ones of the plurality of edge nodes.

Example 7 includes the apparatus of any of examples 1-6, wherein the programmable circuitry is to cause the at least one of the first distribution unit or the second distribution unit to distribute the amount of cooling fluid between partitions of an immersion tank of the at least one of the first edge node or the second edge node.

Example 8 includes the apparatus of any of examples 1-7, wherein the programmable circuitry is to determine the first cooling parameter based on a service-level agreement of a tenant operating at the first edge node.

Example 9 includes the apparatus of any of examples 1-8, wherein the programmable circuitry is to determine the first cooling availability information based on at least one of a workload of the first edge node or an ambient temperature at the first edge node.

Example 10 includes at least one non-transitory computer readable medium comprising instructions that, when executed, cause programmable circuitry to determine, based on cooling reservation information, a first expected temperature associated with a first edge appliance and a second expected temperature associated with a second edge appliance, cause cooling fluid to be provided to the first edge appliance and the second edge appliance based on the first and second expected temperatures, determine (a) a first difference between the first expected temperature and a first actual temperature associated with the first edge appliance and (b) a second difference between the second expected temperature and a second actual temperature associated with the second edge appliance, and select, based on the first and second differences, an amount of the cooling fluid to be redirected from the first edge appliance to the second edge appliance.

Example 11 includes the at least one non-transitory computer readable medium of example 10, wherein the instructions cause the programmable circuitry to select the amount of the cooling fluid to be redirected based on at least one of a cooling request from the second edge appliance to the first edge appliance or a cooling availability notification from the first edge appliance to the second edge appliance.

Example 12 includes the at least one non-transitory computer readable medium of examples 10 or 11, wherein the first edge appliance and the second edge appliance correspond to a same tenant.

Example 13 includes the at least one non-transitory computer readable medium of any of examples 10-12, wherein the cooling fluid is first cooling fluid, the instructions are to cause the programmable circuitry to select a third edge appliance from a plurality of edge appliances based on availability of second cooling fluid for corresponding ones of the plurality of edge appliances, and cause an amount of the second cooling fluid to be redirected from the third edge appliance to at least one of the first edge appliance or the second edge appliance.

Example 14 includes the at least one non-transitory computer readable medium of any of examples 10-13, wherein the instructions cause the programmable circuitry to cause distribution of the amount of cooling fluid between partitions of an immersion tank of the second edge appliance.

Example 15 includes an apparatus comprising availability tracking circuitry to determine a first cooling parameter and first cooling availability information for a first edge device associated with a tenant, and determine a second cooling parameter and second cooling availability information for a second edge device associated with the tenant, and intra-tenant distribution circuitry to determine whether the first and second cooling parameters are satisfied based on the first and second cooling availability information, when the first and second cooling parameters are satisfied, cause a distribution unit to maintain a first amount of cooling fluid to the first edge device and a second amount of cooling fluid to the second edge device, and when at least one of the first cooling parameter or the second cooling parameter is not satisfied, cause the distribution unit to redistribute the first amount of cooling fluid and the second amount of cooling fluid between the first and second edge devices.

Example 16 includes the apparatus of example 15, wherein the intra-tenant distribution circuitry is to redistribute the first amount of cooling fluid and the second amount of cooling fluid based on respective priority levels of the first and second edge devices indicated in a service-level agreement of the tenant.

Example 17 includes the apparatus of examples 15 or 16, wherein the tenant is a first tenant, further including inter-tenant brokering circuitry to access, based on a notification from a second tenant operating on a third edge device, third cooling availability information associated with the third edge device, and select a third amount of cooling fluid to be requested from the third edge device based on the third cooling availability information.

Example 18 includes the apparatus of any of examples 15-17, further including communication interface circuitry to generate a cooling request indicating the third amount of cooling fluid, and transmit the cooling request to the third edge device.

Example 19 includes the apparatus of any of examples 15-18, wherein the inter-tenant brokering circuitry is to select the third edge device from a plurality of edge devices based on an availability of cooling fluid corresponding to ones of the plurality of edge devices.

Example 20 includes the apparatus of any of examples 15-19, wherein the intra-tenant distribution circuitry is to cause the distribution unit to redistribute the first amount of cooling fluid and the second amount of cooling fluid between partitions of an immersion tank of the at least one of the first edge device or the second edge device.

Example 21 includes the apparatus of any of examples 15-20, wherein the availability tracking circuitry is to determine the first cooling availability information based on at least one of a workload of the first edge device or an ambient temperature at the first edge device.

Example 22 includes a method comprising determining whether a first cooling parameter for a first edge node is satisfied based on first cooling availability information for the first edge node, when the first cooling parameter is satisfied, causing a first distribution unit to maintain an amount of cooling fluid to the first edge node, and when the first cooling parameter is not satisfied, cause at least one of the first distribution unit or a second distribution unit to adjust the amount of cooling fluid to at least one of the first edge node or a second edge node based on the first cooling availability information and second cooling availability information, the second cooling availability information for the second edge node.

Example 23 includes the method of example 22, further including determining a first expected temperature associated with a first edge device and a second expected temperature associated with a second edge device, the first edge device operating at the first edge node, the second edge device operating at the first edge node or the second edge node, causing the at least one of the first distribution unit or the second distribution unit to provide the amount of cooling fluid to at least one of the first edge device or the second edge device based on the first and second expected temperatures, and when an actual temperature of the first edge device is different from the first expected temperature, causing the at least one of the first distribution unit or the second distribution unit to redistribute the amount of cooling fluid between the first and second edge devices.

Example 24 includes the method of examples 22 or 23, wherein the first edge device and the second edge device correspond to a same tenant.

Example 25 includes the method of any of examples 22-24, wherein the first edge device corresponds to a first tenant and the second edge device corresponds to a second tenant, the first tenant different from the second tenant.

Example 26 includes the method of any of examples 22-25, wherein the first edge device includes at least one of a central processing unit, a graphics processing unit, or a memory chip.

Example 27 includes the method of any of examples 22-26, further including selecting the second edge node from a plurality of edge nodes based on an availability of cooling fluid corresponding to ones of the plurality of edge nodes.

Example 28 includes the method of any of examples 22-27, further including causing the at least one of the first distribution unit or the second distribution unit to distribute the amount of cooling fluid between partitions of an immersion tank of the at least one of the first edge node or the second edge node.

Example 29 includes the method of any of examples 22-28, further including determining the first cooling parameter based on a service-level agreement of a tenant operating at the first edge node.

Example 30 includes the method of any of examples 22-29, further including determining the first cooling availability information based on at least one of a workload of the first edge node or an ambient temperature at the first edge node.

Example 31 includes an apparatus comprising means for tracking availability to determine a first cooling parameter and first cooling availability information for a first edge node, and means for brokering to determine whether the first cooling parameter is satisfied based on the first cooling availability information, when the first cooling parameter is satisfied, cause a first distribution unit to maintain an amount of cooling fluid to the first edge node, and when the first cooling parameter is not satisfied obtain second cooling availability information for a second edge node, and cause at least one of the first distribution unit or a second distribution unit to adjust the amount of cooling fluid to at least one of the first edge node or the second edge node based on the first and second cooling availability information.

Example 32 includes the apparatus of example 31, further including means for distributing to determine a first expected temperature associated with a first edge device and a second expected temperature associated with a second edge device, the first edge device operating at the first edge node, the second edge device operating at the first edge node or the second edge node, cause the at least one of the first distribution unit or the second distribution unit to provide the amount of cooling fluid to at least one of the first edge device or the second edge device based on the first and second expected temperatures, and when an actual temperature of the first edge device is different from the first expected temperature, cause the at least one of the first distribution unit or the second distribution unit to redistribute the amount of cooling fluid between the first and second edge devices.

Example 33 includes the apparatus of examples 31 or 32, wherein the first edge device and the second edge device correspond to a same tenant.

Example 34 includes the apparatus of any of examples 31-33, wherein the first edge device corresponds to a first tenant and the second edge device corresponds to a second tenant, the first tenant different from the second tenant.

Example 35 includes the apparatus of any of examples 31-34, wherein the first edge device includes at least one of a central processing unit, a graphics processing unit, or a memory chip.

Example 36 includes the apparatus of any of examples 31-35, wherein the means for brokering is to select the second edge node from a plurality of edge nodes based on an availability of cooling fluid corresponding to ones of the plurality of edge nodes.

Example 37 includes the apparatus of any of examples 31-36, wherein the means for brokering is to cause the at least one of the first distribution unit or the second distribution unit to distribute the amount of cooling fluid between partitions of an immersion tank of the at least one of the first edge node or the second edge node.

Example 38 includes the apparatus of any of examples 31-37, wherein the means for tracking availability is to determine the first cooling parameter based on a service-level agreement of a tenant operating at the first edge node.

Example 39 includes the apparatus of any of examples 31-38, wherein the means for tracking availability is to determine the first cooling availability information based on at least one of a workload of the first edge node or an ambient temperature at the first edge node.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
memory;
machine-readable instructions; and
programmable circuitry to execute the machine-readable instructions to:
determine whether a first cooling parameter for a first edge node is satisfied based on first cooling availability information for the first edge node;
when the first cooling parameter is satisfied, cause a first distribution unit to maintain an amount of cooling fluid to the first edge node; and
when the first cooling parameter is not satisfied, cause at least one of the first distribution unit or a second distribution unit to adjust the amount of cooling fluid to at least one of the first edge node or a second edge node based on the first cooling availability information and second cooling availability information, the second cooling availability information for the second edge node.

2. The apparatus of claim 1, wherein the programmable circuitry is to execute the machine-readable instructions to:
determine a first expected temperature associated with a first edge device and a second expected temperature associated with a second edge device, the first edge device operating at the first edge node, the second edge device operating at the first edge node or the second edge node;
cause the at least one of the first distribution unit or the second distribution unit to provide the amount of cooling fluid to at least one of the first edge device or the second edge device based on the first and second expected temperatures; and
when an actual temperature of the first edge device is different from the first expected temperature, cause the at least one of the first distribution unit or the second distribution unit to redistribute the amount of cooling fluid between the first and second edge devices.

3. The apparatus of claim 2, wherein the first edge device and the second edge device correspond to a same tenant.

4. The apparatus of claim 2, wherein the first edge device corresponds to a first tenant and the second edge device corresponds to a second tenant, the first tenant different from the second tenant.

5. The apparatus of claim 2, wherein the first edge device includes at least one of a central processing unit, a graphics processing unit, or a memory chip.

6. The apparatus of claim 1, wherein the programmable circuitry is to select the second edge node from a plurality of edge nodes based on an availability of cooling fluid corresponding to ones of the plurality of edge nodes.

7. The apparatus of claim 1, wherein the programmable circuitry is to cause the at least one of the first distribution unit or the second distribution unit to distribute the amount of cooling fluid between partitions of an immersion tank of the at least one of the first edge node or the second edge node.

8. The apparatus of claim 1, wherein the programmable circuitry is to determine the first cooling parameter based on a service-level agreement of a tenant operating at the first edge node.

9. The apparatus of claim 1, wherein the programmable circuitry is to determine the first cooling availability information based on at least one of a workload of the first edge node or an ambient temperature at the first edge node.

10. At least one non-transitory computer readable medium comprising instructions that, when executed, cause programmable circuitry to:
determine, based on cooling reservation information, a first expected temperature associated with a first edge appliance and a second expected temperature associated with a second edge appliance;
cause cooling fluid to be provided to the first edge appliance and the second edge appliance based on the first and second expected temperatures;
determine (a) a first difference between the first expected temperature and a first actual temperature associated with the first edge appliance and (b) a second difference between the second expected temperature and a second actual temperature associated with the second edge appliance; and
select, based on the first and second differences, an amount of the cooling fluid to be redirected from the first edge appliance to the second edge appliance.

11. The at least one non-transitory computer readable medium of claim 10, wherein the instructions cause the programmable circuitry to select the amount of the cooling fluid to be redirected based on at least one of a cooling request from the second edge appliance to the first edge appliance or a cooling availability notification from the first edge appliance to the second edge appliance.

12. The at least one non-transitory computer readable medium of claim 10, wherein the first edge appliance and the second edge appliance correspond to a same tenant.

13. The at least one non-transitory computer readable medium of claim 10, wherein the cooling fluid is first cooling fluid, the instructions are to cause the programmable circuitry to:
select a third edge appliance from a plurality of edge appliances based on availability of second cooling fluid for corresponding ones of the plurality of edge appliances; and
cause an amount of the second cooling fluid to be redirected from the third edge appliance to at least one of the first edge appliance or the second edge appliance.

14. The at least one non-transitory computer readable medium of claim 10, wherein the instructions cause the programmable circuitry to cause distribution of the amount of cooling fluid between partitions of an immersion tank of the second edge appliance.

15. An apparatus comprising:
availability tracking circuitry to:
determine a first cooling parameter and first cooling availability information for a first edge device associated with a tenant; and
determine a second cooling parameter and second cooling availability information for a second edge device associated with the tenant; and
intra-tenant distribution circuitry to:
determine whether the first and second cooling parameters are satisfied based on the first and second cooling availability information;
when the first and second cooling parameters are satisfied, cause a distribution unit to maintain a first amount of cooling fluid to the first edge device and a second amount of cooling fluid to the second edge device; and
when at least one of the first cooling parameter or the second cooling parameter is not satisfied, cause the distribution unit to redistribute the first amount of cooling fluid and the second amount of cooling fluid between the first and second edge devices.

16. The apparatus of claim 15, wherein the intra-tenant distribution circuitry is to redistribute the first amount of cooling fluid and the second amount of cooling fluid based on respective priority levels of the first and second edge devices indicated in a service-level agreement of the tenant.

17. The apparatus of claim 15, wherein the tenant is a first tenant, further including inter-tenant brokering circuitry to:
access, based on a notification from a second tenant operating on a third edge device, third cooling availability information associated with the third edge device; and
select a third amount of cooling fluid to be requested from the third edge device based on the third cooling availability information.

18. The apparatus of claim 17, further including communication interface circuitry to:
generate a cooling request indicating the third amount of cooling fluid; and
transmit the cooling request to the third edge device.

19. The apparatus of claim 17, wherein the inter-tenant brokering circuitry is to select the third edge device from a plurality of edge devices based on an availability of cooling fluid corresponding to ones of the plurality of edge devices.

20. The apparatus of claim 15, wherein the intra-tenant distribution circuitry is to cause the distribution unit to redistribute the first amount of cooling fluid and the second amount of cooling fluid between partitions of an immersion tank of the at least one of the first edge device or the second edge device.

21-39. (canceled)
